(19) United States
(12) Patent Application Publication
(10) Pub. No.: US 2015/0153549 A1
(43) Pub. Date: Jun. 4, 2015

(54) ZOOM LENS SYSTEM, OPTICAL APPARATUS AND METHOD FOR MANUFACTURING ZOOM LENS SYSTEM

(71) Applicant: NIKON CORPORATION, Tokyo (JP)

(72) Inventor: Mami MURATANI, Tokyo (JP)

(73) Assignee: NIKON CORPORATION

(21) Appl. No.: 14/616,662

(22) Filed: Feb. 7, 2015

Related U.S. Application Data
(63) Continuation of application No. PCT/JP2013/071491, filed on Aug. 8, 2013.

(30) Foreign Application Priority Data
Aug. 8, 2012 (JP) 2012-175835
Aug. 8, 2012 (JP) 2012-175836
Aug. 8, 2012 (JP) 2012-175837
Aug. 8, 2012 (JP) 2012-175838
Aug. 8, 2012 (JP) 2012-175839
Aug. 8, 2012 (JP) 2012-175840

(51) Int. Cl. G02B 15/16; G02B 13/00; G02B 15/177

(52) U.S. Cl. CPC G02B 15/161; G02B 15/177; G02B 13/009

(57) ABSTRACT

A zoom lens system comprises, in order from an object side, a first lens group G1 having negative refractive power and a second lens group G2 having positive refractive power. Upon zooming from a wide-angle end state to a telephoto end state, a distance between the first lens group G1 and the second lens group G2 varies. The first lens group G1 comprises, in order from the object side, a negative meniscus lens L1 having a concave surface facing an image plane side, a negative lens L2 and a positive lens L3 having a convex surface facing the object side. The second lens group G2 comprises, in order from the object side, a positive lens L4, a first cemented lens L56 and a second cemented lens L78. And a predetermined conditional expression is satisfied. This makes it possible to provide a zoom lens system that is compact in size and has a superb imaging performance for correcting various aberrations well, an optical apparatus equipped with the zoom lens system and a manufacturing method for the zoom lens system.

### TECHNICAL FIELD

The present invention relates to a zoom lens system suitable for a compact camera equipped with a solid state imaging device and the like, an optical apparatus equipped with the zoom lens system and a method for manufacturing the zoom lens system.

### BACKGROUND ART

Conventionally, there have been proposed a zoom lens system having a negative lens as a first lens, which is suitable for a compact camera equipped with a solid state imaging sensor and the like (for example, Japan Patent Application Laid Open Publication No. 2001-215407).

### SUMMARY OF THE INVENTION

### Problem Solved by the Invention

A zoom lens system having two lens groups of a negative-positive structure is simple in structure and suitable for making the system compact in size, but in the case where a first lens group having negative refractive power composed of a less number of lenses having only two negative and positive lenses in order to make the system further compact in size, it becomes difficult to correct various aberrations well. In order to correct aberrations, it is required to make a distance between the two lenses larger sufficiently, and as a result a thickness of the first lens group becomes increased as a whole, which causes difficulty of making the system compact in size. Further, depending on the configuration of the second lens group, there are problems that corrections of aberrations are not sufficient, as well as positional sensitivity of each lens becomes higher, causing deteriorating productivity.

With the foregoing in view, it is an object of the present invention to provide a zoom lens system that is compact in size and has a superb imaging performance correcting various aberrations well, an optical apparatus equipped with the zoom lens system and a manufacturing method for the zooming lens system.

### Solution to Problem

To achieve this object, according to a first aspect of the present invention, there is provided a zoom lens system which comprises, in order from an object side, a first lens group having negative refractive power and a second lens group having positive refractive power,

upon zooming from a wide-angle end state to a telephoto end state, a distance between the first lens group and the second lens group varying;

the first lens group comprising, in order from the object side, a negative meniscus lens having a concave surface facing an image plane side, a negative lens and a positive lens having a convex surface facing the object side;

the second lens group comprising, in order from the object side, a positive lens, a first cemented lens and a second cemented lens; and

the following conditional expression being satisfied:

0.00≦(−f1)/|fL56<0.65

where f1 denotes a focal length of the first lens group, and fL56 denotes a focal length of the first cemented lens.

In the zoom lens system according to the first aspect of the present invention, it is preferable that the first cemented lens has negative refractive power.

In the zoom lens system according to the first aspect of the present invention, it is preferable that the second cemented lens has positive refractive power.

In the zoom lens system according to the first aspect of the present invention, it is preferable that the following conditional expression being further satisfied:

0.20<SL56/f2<0.40

where SL56 denotes a distance along the optical axis from a most object side lens surface to a most image side lens surface, of the first cemented lens, and f2 denotes a focal length of the second lens group.

In the zoom lens system according to the first aspect of the present invention, it is preferable that the following conditional expression is further satisfied:

0.08<SB/S2<0.40

where SB denotes a distance along the optical axis from the most image side lens surface of the first cemented lens to a most object side lens surface of the second cemented lens, and S2 denotes a distance along the optical axis from a most object side lens surface to a most image side lens surface, of the second lens group.

In the zoom lens system according to the first aspect of the present invention, it is preferable that the following conditional expression is further satisfied:

0.20<f2/TLw<0.35

where f2 denotes a focal length of the second lens group, and TLw denotes a distance along the optical axis from a most object side lens surface to the image plane upon focusing on infinity at the wide-angle end state.

In the zoom lens system according to the first aspect of the present invention, it is preferable that the second lens group comprises at least one negative lens satisfying the following conditional expression:

1.810<ndLi

where ndLi denotes a refractive index of the negative lens at d line (λ=587.6 nm).

In the zoom lens system according to the first aspect of the present invention, it is preferable that the first cemented lens consists of, in order from the object side, a positive lens and a negative lens.

In the zoom lens system according to the first aspect of the present invention, it is preferable that the second cemented lens consists of, in order from the object side, a negative lens and a positive lens.

In the zoom lens system according to the first aspect of the present invention, it is preferable that the zoom lens system includes an aperture stop and the aperture stop is disposed at a more image side than a most image side lens surface of the first lens group.

In the zoom lens system according to the first aspect of the present invention, it is preferable that the following conditional expression is further satisfied:

−0.30<(r4R+r4F)/(r4R−r4F)<0.50

where r4F denotes a radius of curvature of the object side lens surface of the positive lens of the second lens group, and r4R denotes a radius of curvature of the image side lens surface of the positive lens of the second lens group.

In the zoom lens system according to the first aspect of the present invention, it is preferable that the following conditional expression is further satisfied:

0.05<|fL78/fL56|<0.70

where fL78 denotes a focal length of the second cemented lens, and fL56 denotes a focal length of the first cemented lens.

In the zoom lens system according to the first aspect of the present invention, it is preferable that the following conditional expression is further satisfied:

0.30<f2/S2<1.70

where f2 denotes a focal length of the second lens group, and S2 denotes a distance along the optical axis from a most object side lens surface to a most image side lens surface, of the second lens group.

In the zoom lens system according to the first aspect of the present invention, it is preferable that the following conditional expression is further satisfied:

1.40<f2/fw<1.85

where f2 denotes a focal length of the second lens group, and fw denotes a focal length of the zoom lens system at the wide-angle end state.

In the zoom lens system according to the first aspect of the present invention, it is preferable that the following conditional expression is further satisfied:

0.15<S2/TLt<0.35

where S2 denotes a distance along the optical axis from a most object side lens surface to a most image side lens surface, of the second lens group, and TLt denotes a distance along the optical axis from a most object side lens surface to the image plane upon focusing on infinity at the telephoto-end state.

In the zoom lens system according to the first aspect of the present invention, it is preferable that the following conditional expression is further satisfied:

0.00≦f2/|fL56|<0.70

where f2 denotes a focal length of the second lens group and fL56 denotes a focal length of the first cemented lens.

In the zoom lens system according to the first aspect of the present invention, it is preferable that the following conditional expression is further satisfied:

0.15<S2/TLw<0.28

where S2 denotes a distance along the optical axis from a most object side lens surface to a most image side lens surface, of the second lens group, and TLw denotes a distance along the optical axis from a most object side lens surface to the image plane upon focusing on infinity at the wide-angle end state.

In the zoom lens system according to the first aspect of the present invention, it is preferable that the following conditional expression is further satisfied:

0.85<f2/(fw×ft)^{1/2}<1.10

where f2 denotes a focal length of the second lens group, fw denotes a focal length of the zoom lens system at the wide-angle end state, and ft denotes a focal length of the zoom lens system at the telephoto end state.

In the zoom lens system according to the first aspect of the present invention, it is preferable that the following conditional expression is further satisfied:

0.50<fL1/f1<1.00

where fL1 denotes a focal length of the negative meniscus lens of the first lens group, and f1 denotes a focal length of the first lens group.

In the zoom lens system according to the first aspect of the present invention, it is preferable that the following conditional expression is further satisfied:

0.10<S1/TLw<0.20

where S1 denotes a distance along the optical axis from a most object side lens surface to a most image side lens surface, of the first lens group, and TLw denotes a distance along the optical axis from a most object side lens surface to the image plane upon focusing on infinity at the wide-angle end state.

In the zoom lens system according to the first aspect of the present invention, it is preferable that the following conditional expression is further satisfied:

0.50<S1/fw<0.88

where S1 denotes a distance along the optical axis from a most object side lens surface to a most image side lens surface, of the first lens group, and fw denotes a focal length of the zoom lens system at the wide-angle end state.

In the zoom lens system according to the first aspect of the present invention, it is preferable that the following conditional expression is further satisfied:

0.00<(r2F+r1R)/(r2F−r1R)<2.00

where r1R denotes a radius of curvature of the image side lens surface of the negative meniscus lens of the first lens group, and r2F denotes a radius of curvature of the object side lens surface of the negative lens of the first lens group.

In the zoom lens system according to the first aspect of the present invention, it is preferable that the following conditional expression is further satisfied:

−1.00≦(r1R−r1F)/(r1R+r1F)<−0.30

where r1F denotes a radius of curvature of the object side lens surface of the negative meniscus lens of the first lens group, and r1R denotes a radius of curvature of the image side lens surface of the negative meniscus lens of the first lens group.

In the zoom lens system according to the first aspect of the present invention, it is preferable that the following conditional expression is further satisfied:

0.20<S1/(fw×ft)^{1/2}<0.70

where S1 denotes a distance along the optical axis from a most object side lens surface to a most image side surface, of the first lens group, fw denotes a focal length of the zoom lens system at the wide-angle end state, and ft denotes a focal length of the zoom lens system at the telephoto end state.

In the zoom lens system according to the first aspect of the present invention, it is preferable that the following conditional expression is further satisfied:

0.50<S2/(fw×ft)^{1/2}<1.00

where S2 denotes a distance along the optical axis from a most object side lens surface to a most image side lens surface, of the second lens group, fw denotes a focal length of the zoom lens system at the wide-angle end state, and ft denotes a focal length of the zoom lens system at the telephoto end state.

In the zoom lens system according to the first aspect of the present invention, it is preferable that the following conditional expression is further satisfied:

1.00<(−f1)/S1<3.00

where f1 denotes a focal length of the first lens group, and S1 denotes a distance along the optical axis from a most object side lens surface to a most image side lens surface, of the first lens group.

In the zoom lens system according to the first aspect of the present invention, it is preferable that the following conditional expression is further satisfied:

0.20<fL1/fL2<0.50

where fL1 denotes a focal length of the negative meniscus lens of the first lens group, and fL2 denotes a focal length of the negative lens of the first lens group.

According to the second aspect of the present invention, there is provided an optical apparatus equipped with the zoom lens system according to the first aspect of the present invention.

According to the third aspect of the present invention, there is provided a zoom lens system which has, in order from an object side, a first lens group having negative refractive power and a second lens group having positive refractive power,

upon zooming from a wide-angle end state to a telephoto end state, a distance between the first lens group and the second lens group varying;

the first lens group comprises, in order from the object side, a negative meniscus lens having a concave surface facing an image plane side, a negative lens and a positive lens having a convex surface facing the object side;

the second lens group comprises, in order from the object side, a positive lens, a first cemented lens and a second cemented lens; and

the following conditional expression being satisfied:

−0.30<(r4R+r4F)/(r4R−r4F)<0.50

where r4F denotes a radius of curvature of the object side lens surface of the positive lens of the second lens group and r4R denotes a radius of curvature of the image side lens surface of the positive lens of the second lens group.

In the zoom lens system according to the third aspect of the present invention, it is preferable that the following conditional expression is further satisfied:

0.05<|fL78/fL56|<0.70

where fL78 denotes a focal length of the second cemented lens, and fL56 denotes a focal length of the first cemented lens.

In the zoom lens system according to the third aspect of the present invention, it is preferable that the following conditional expression is further satisfied:

0.30<f2/S2<1.70

where f2 denotes a focal length of the second lens group and S2 denotes a distance along the optical axis from a most object side lens surface to a most image side lens surface, of the second lens group.

In the zoom lens system according to the third aspect of the present invention, it is preferable that the zoom lens further includes a fixed stop, and the fixed stop is disposed at the image plane side of the first cemented lens.

According to the fourth aspect of the present invention, there is provided an optical apparatus equipped with the zoom lens system of the third aspect of the present invention.

According to the fifth aspect of the present invention, there is provided a zoom lens system which comprises, in order from an object side, a first lens group having negative refractive power and a second lens group having positive refractive power,

upon zooming from a wide-angle end state to a telephoto end state, a distance between the first lens group and the second lens group varying;

the first lens group comprising, in order from the object side, a negative meniscus lens having a concave surface facing an image plane side, a negative lens and a positive lens having a convex surface facing the object side;

the second lens group comprising, in order from the object side, a positive lens, a first cemented lens and a second cemented lens; and

the following conditional expression being satisfied:

1.40<f2/fw<1.85

where f2 denotes a focal length of the second lens group and a focal length of the zoom lens system at the wide-angle end state.

In the zoom lens system according to the fifth aspect of the present invention, it is preferable that the following conditional expression is further satisfied:

0.15<S2/TLt<0.35

where S2 denotes a distance along the optical axis from a most object side lens surface to a most image side lens surface, of the second lens group, and TLt denotes a distance along the optical axis from a most object side lens surface to the image plane upon focusing on infinity at the telephoto-end state.

In the zoom lens system according to the fifth aspect of the present invention, it is preferable that the following conditional expression is further satisfied:

0.65<SA/r6R≦1.40

where SA denotes a distance along the optical axis from the aperture stop to a most image side lens surface of the first cemented lens, and r6R denotes a radius of curvature of the image side lens surface of the first cemented lens.

In the zoom lens system according to the fifth aspect of the present invention, it is preferable that the following conditional expression is further satisfied:

0.00≦f2/|fL56|<0.70

where f2 denotes a focal length of the second lens group, and fL56 denotes a focal length of the first cemented lens.

According to the six aspect of the present invention, there is provided an optical apparatus equipped with the zoom lens system according to the fifth aspect of the present invention.

According to the seventh aspect of the present invention, there is provided a zoom lens system which has, in order from an object side, a first lens group having negative refractive power and a second lens group having positive refractive power,

upon zooming from a wide-angle end state to a telephoto end state, a distance between the first lens group and the second lens group varying;

the first lens group comprising, in order from the object side, a negative meniscus lens having a concave surface facing an image plane side, a negative lens and a positive lens having a convex surface facing the object side;

the second lens group comprising, in order from the object side, a positive lens, a first cemented lens and a second cemented lens; and

the following conditional expression being satisfied:

0.15<S2/TLw<0.28

where S2 denotes a distance along the optical axis from a most object side lens surface to a most image side lens surface, of the second lens group, and TLw denotes a distance along the optical axis from a most object side lens surface to the image plane upon focusing on infinity at the wide-angle end state.

In the zoom lens system according to the seventh aspect of the present invention, it is preferable that the following conditional expression is further satisfied:

0.85<f2/(fw×ft)^{1/2}<1.10

Where f2 denotes a focal length of the second lens group, fw denotes a focal length of the zoom lens system at the wide-angle end state, and ft denotes a focal length of the zoom lens system at the telephoto end state.

In the zoom lens system according to the seventh aspect of the present invention, it is preferable that the following conditional expression is further satisfied:

0.50<fL1/f1<1.00

where fL1 denotes a focal length of the negative meniscus lens of the first lens group and f1 denotes a focal length of the first lens group.

In the zoom lens system according to the seventh aspect of the present invention, it is preferable that the following conditional expression is further satisfied:

0.10<S1/TLw<0.20

where S1 denotes a distance along the optical axis from a most object side lens surface to a most image side lens surface, of the first lens group, and TLw denotes a distance along the optical axis from a most object side lens surface to the image plane upon focusing on infinity at the wide-angle end state.

According to the eighth aspect of the present invention, there is provided an optical apparatus equipped with the zoom lens according to the seventh aspect of the present invention.

According to the ninth aspect of the present invention, there is provided a zoom lens system which comprises, in order from an object side, a first lens group having negative refractive power and a second lens group having positive refractive power,

upon zooming from a wide-angle end state to a telephoto end state, a distance between the first lens group and the second lens group varying;

the first lens group comprising, in order from the object side, a negative meniscus lens having a concave surface facing an image plane side, a negative lens and a positive lens having a convex surface facing the object side;

the second lens group comprising, in order from the object side, a positive lens, a first cemented lens and a second cemented lens; and

the following conditional expressions being satisfied:

0.50<S1/fw<0.88

0.00<(r2F+r1R)/(r2F−r1R)<2.00

where S1 denotes a distance along the optical axis from a most object side lens surface to a most image side lens surface, of the first lens group, fw denotes a focal length of the zoom lens at the wide-angle end state, r1R denotes a radius of curvature of the image side lens surface of the negative meniscus lens of the first lens group, and r2F denotes a radius of curvature of the object side lens surface of the negative lens of the first lens group.

In the zoom lens system according to the ninth aspect of the present invention, it is preferable that the following conditional expression is further satisfied:

1.00≦(r1R−r1F)/(r1R+r1F)<−0.30

where r1F denotes a radius of curvature of the object side lens surface of the negative meniscus lens of the first lens group, and r1R denotes a radius of curvature of the image side lens surface of the negative meniscus lens of the first lens group.

In the zoom lens system according to the ninth aspect of the present invention, it is preferable that the following conditional expression is further satisfied:

2.05<ndL1+0.009×νdL1

where ndL1 denotes a refractive index of the negative meniscus lens of the first lens group at d-line (λ=587.6 nm) and νdL1 denotes an abbe number of the negative meniscus lens of the first lens group at d-line (λ=587.6 nm).

According to the tenth aspect of the present invention, there is provided an optical apparatus equipped with the zoom lens system according to ninth aspect of the present invention.

According to the eleventh aspect of the present invention, there is provided a zoom lens system which has, in order from an object side, a first lens group having negative refractive power and a second lens group having positive refractive power,

upon zooming from a wide-angle end state to a telephoto end state, a distance between the first lens group and the second lens group varying;

the first lens group comprising, in order from the object side, a negative meniscus lens having a concave surface facing an image plane side, a negative lens and a positive lens having a convex surface facing the object side;

the second lens group comprising, in order from the object side, a positive lens, a first cemented lens and a second cemented lens; and

the following conditional expressions being satisfied:

0.20<S1/(fw×ft)^{1/2}<0.70

0.50<S2/(fw×ft)^{1/2}<1.00

where S1 denotes a distance along the optical axis from a most object side lens surface to a most image side lens surface, of the first lens group, S2 denotes a distance along the optical axis from a most object side lens surface to a most image side lens surface, of the second lens group, fw denotes a focal length of the zoom lens system at the wide-angle end state, and ft denotes a focal length of the zoom lens system at the telephoto end state.

In the zoom lens system according to the eleventh aspect of the present invention, it is preferable that the following conditional expression is further satisfied:

1.00<(−f1)/S1<3.00

where f1 denotes a focal length of the first lens group, and S1 denotes a distance along the optical axis from a most object side lens surface to a most image side lens surface, of the first lens group.

In the zoom lens system according to the eleventh aspect of the present invention, it is preferable that the following conditional expression is further satisfied:

0.20<fL1/fL2<0.50

where fL1 denotes a focal length of the negative meniscus lens of the first lens group, and fL2 denotes a focal length of the negative lens of the first lens group.

In the zoom lens system according to the eleventh aspect of the present invention, it is preferable that the following conditional expression is further satisfied:

−2.00<(r2R+r2F)/(r2R−r2F)≦0.00

where r2F denotes a radius of curvature of the object side lens surface of the negative lens of the first lens group, and r2R denotes a radius of curvature of the image side lens surface of the negative lens of the first lens group.

In the zoom lens system according to the eleventh aspect of the present invention, it is preferable that the following conditional expressions are further satisfied:

ndL2<1.62

62.00<νdL2

where ndL2 denotes a refractive index of the negative lens of the first lens group at d-line (λ=587.6 nm), and νdL2 denotes an Abbe number of the negative lens of the first lens group at d-line (λ=587.6 nm).

According to the twelfth aspect of the present invention, there is provided an optical apparatus equipped with the zoom lens system according to the eleventh aspect of the present invention.

According to the thirteenth aspect of the present invention, there is provided a method for manufacturing a zoom lens system which has, in order from an object side, a first lens group having negative refractive power and a second lens group having positive refractive power, comprising steps of:

constructing the first lens group to comprise, in order from the object side, a negative meniscus lens having a concave surface facing an image plane side, a negative lens and a positive lens having a convex surface facing the object side;

constructing the second lens group to comprise, in order from the object side, a positive lens, a first cemented lens and a second cemented lens;

constructing such that the following conditional expression may be satisfied:

0.00≦(−f1)/|fL56|<0.65

where f1 denotes a focal length of the first lens group, and fL56 denotes a focal length of the first cemented lens; and

constructing such that, upon zooming from a wide angle end state to a telephoto end state, a distance between the first lens group and the second lens group may be varied.

In the method for manufacturing a zoom lens system according to the thirteenth aspect of the present invention, it is preferable that the following conditional expression is further satisfied:

0.20<SL56/f2<0.40

where SL56 denotes a distance along the optical axis from a most object side lens surface to a most image side lens surface, of the first cemented lens, and f2 denotes a focal length of the second lens group.

In the method for manufacturing a zoom lens system according to the thirteenth aspect of the present invention, it is preferable that the following conditional expression is further satisfied:

0.08<SB/S2<0.40

where SB denotes a distance along the optical axis from a most image side lens surface of the first cemented lens to a most object side lens surface of the second cemented lens, and S2 denotes a distance along the optical axis from a most object side lens surface to a most image side lens surface, of the second lens group.

In the method for manufacturing a zoom lens system according to the thirteenth aspect of the present invention, it is preferable that the following conditional expression is further satisfied:

0.20<f2/TLw<0.35

where f2 denotes a focal length of the second lens group, and TLw denotes a distance along the optical axis from a most object side lens surface to the image plane upon focusing on infinity at the wide-angle end state.

In the method for manufacturing a zoom lens system according to the thirteenth aspect of the present invention, it is preferable that the following conditional expression is further satisfied:

−0.30<(r4R+r4F)/(r4R−r4F)<0.50

where r4F denotes a radius of curvature of the object side lens surface of the positive lens of the second lens group, and r4R denotes a radius of curvature of the image side lens surface of the positive lens of the second lens group.

In the method for manufacturing a zoom lens system according to the thirteenth aspect of the present invention, it is preferable that the following conditional expression is further satisfied:

1.40<f2/fw<1.85

where f2 denotes a focal length of the second lens group, and fw denotes a focal length of the zoom lens system at the wide-angle end state.

In the method for manufacturing a zoom lens system according to the thirteenth aspect of the present invention, it is preferable that the following conditional expression is further satisfied:

0.15<S2/TLw<0.28

where S2 denotes a distance along the optical axis from a most object side lens surface to a most image side lens surface, of the second lens group, and TLw denotes a distance along the optical axis from a most object side lens surface to the image plane upon focusing on infinity at the wide-angle end state.

In the method for manufacturing a zoom lens system according to the thirteenth aspect of the present invention, it is preferable that the following conditional expression is further satisfied:

0.5<S1/fw<0.88

where S1 denotes a distance along the optical axis from a most object side lens surface to a most image side lens surface, of the first lens group, and fw denotes a focal length of the zoom lens system at the wide-angle end state.

In the method for manufacturing a zoom lens system according to the thirteenth aspect of the present invention, it is preferable that the following conditional expression is further satisfied:

0.00<(r2F+r1R)/(r2F−r1R)<2.00

where r1R denotes a radius of curvature of the image side lens surface of the negative meniscus lens of the first lens group, and r2F denotes a radius of curvature of the object side lens surface of the negative lens of the first lens group.

In the method for manufacturing a zoom lens system according to the thirteenth aspect of the present invention, it is preferable that the following conditional expression is further satisfied:

0.20<S1/(fw×ft)^{1/2}<0.70

where S1 denotes a distance along the optical axis from a most object side lens surface to a most image side lens surface, of the first lens group, fw denotes a focal length of the zoom lens system at the wide-angle end state, and ft denotes a focal length of the zoom lens system at the telephoto end state.

In the method for manufacturing a zoom lens system according to the thirteenth aspect of the present invention, it is preferable that the following conditional expression being further satisfied:

0.50<S2/(fw×ft)^{1/2}<1.00

where S2 denotes a distance along the optical axis from a most object side lens surface to a most image side lens surface, of the second lens group, fw denotes a focal length of the zoom lens system at the wide-angle end state, and ft denotes a focal length of the zoom lens system at the telephoto end state.

According to the fourteenth aspect of the present invention, there is provided a method of manufacturing a zoom lens system which has, in order from an object side, a first lens group having negative refractive power and a second lens group having positive refractive power, the method comprising steps of:

constructing such that the first lens group comprises, in order from the object side, a negative meniscus lens having a concave surface facing an image plane side, a negative lens and a positive lens having a convex surface facing the object side;

constructing such that the second lens group comprises, in order from the object side, a positive lens, a first cemented lens and a second cemented lens;

constructing such that the second lens group satisfies the following conditional expression;

−0.30<(r4R+r4F)/(r4R−r4F)<0.50

where r4F denotes a radius of curvature of the object side lens surface of the positive lens of the second lens group, and r4R denotes a radius of curvature of the image side lens surface of the positive lens of the second lens group; and

constructing such that, upon zooming from a wide-angle end state to a telephoto end state, a distance between the first lens group and the second lens group may be varied.

In the method for manufacturing a zoom lens system according to the fourteenth aspect of the present invention, it is preferable that the following conditional expression is further satisfied:

0.05<|fL78/fL56|<0.70

where fL78 denotes a focal length of the second cemented lens and fL56 denotes a focal length of the first cemented lens.

In the method for manufacturing a zoom lens system according to the fourteenth aspect of the present invention, it is preferable that the following conditional expression is further satisfied:

0.30<f2/S2<1.70

where f2 denotes a focal length of the second lens group, and S2 denotes a distance along the optical axis from a most object side lens surface to a most image side lens surface, of the second lens group.

According to the fifteenth aspect of the present invention, there is provided a method for manufacturing a zoom lens system which comprises, in order from an object side, a first lens group having negative refractive power and a second lens group having positive refractive power, the method comprising the steps of:

constructing such that the first lens group comprises, in order from the object side, a negative meniscus lens having a concave surface facing an image plane side, a negative lens and a positive lens having a convex surface facing the object side;

constructing such that the second lens group comprises, in order from the object side, a positive lens, a first cemented lens and a second cemented lens;

constructing such that the following conditional expression is satisfied;

1.40<f2/fw<1.85

where f2 denotes a focal length of the second lens group, and fw denotes a focal length of the zoom lens system at a wide-angle end state; and

constructing such that, upon zooming from the wide-angle end state to a telephoto end state, a distance between the first lens group and the second lens group is varied.

In the method for manufacturing a zoom lens system according to the fifteenth aspect of the present invention, it is preferable that the following conditional expression is further satisfied:

0.15<S2/TLt<0.35

where S2 denotes a distance along the optical axis from a most object side lens surface to a most image side lens surface, of the second lens group, and TLt denotes a distance along the optical axis from a most object side lens surface to the image plane upon focusing on infinity at the telephoto-end state.

In the method for manufacturing a zoom lens system according to the fifteenth aspect of the present invention, it is preferable that the following conditional expression is further satisfied:

0.00≦f2/|fL56|<0.70

where f2 denotes a focal length of the second lens group and fL56 denotes a focal length of the first cemented lens.

According to the sixteenth aspect of the present invention, there is provided a method for manufacturing a zoom lens system which comprises, in order from an object side, a first lens group having negative refractive power and a second lens group having positive refractive power, the method comprising steps of:

constructing such that the first lens group comprises, in order from the object side, a negative meniscus lens having a concave surface facing an image plane side, a negative lens and a positive lens having a convex surface facing the object side;

constructing such that the second lens group comprises, in order from the object side, a positive lens, a first cemented lens and a second cemented lens;

constructing such that the following conditional expression is satisfied;

0.15<S2/TLw<0.28

where S2 denotes a distance along the optical axis from a most object side lens surface to a most image side lens surface, of the second lens group, and TLw denotes a distance along the optical axis from a most object side lens surface to the image plane upon focusing on infinity at a wide-angle end state; and

constructing such that, upon zooming from the wide-angle end state to the telephoto end state, a distance between the first lens group and the second lens group is varied.

In the method for manufacturing a zoom lens system according to the sixteenth aspect of the present invention, it is preferable that the following conditional expression is further satisfied:

0.85<f2/(fw×ft)^{1/2}<1.10

where f2 denotes a focal length of the second lens group, fw denotes a focal length of the zoom lens system at the wide-angle end state, and ft denotes a focal length of the zoom lens system at the telephoto end state.

In the method for manufacturing a zoom lens system according to the sixteenth aspect of the present invention, it is preferable that the following conditional expression is further satisfied:

0.50<fL1/f1<1.00

where fL1 denotes a focal length of the negative meniscus lens of the first lens group, and f1 denotes a focal length of the first lens group.

According to the seventeenth aspect of the present invention, there is provided a method for manufacturing a zoom lens system which comprises, in order from an object side, a first lens group having negative refractive power and a second lens group having positive refractive power, the method comprising the steps of:

constructing such that the first lens group comprises, in order from the object side, a negative meniscus lens having a concave surface facing an image plane side, a negative lens and a positive lens having a convex surface facing the object side;

constructing such that the second lens group comprises, in order from the object side, a positive lens, a first cemented lens and a second cemented lens;

constructing such that the following conditional expressions is satisfied;

0.50<S1/fw<0.88

0.00<(r2F+r1R)/(r2F−r1R)<2.00

where S1 denotes a distance along the optical axis from a most object side lens surface to a most image side lens surface, of the first lens group, fw denotes a focal length of the zoom lens system at a wide-angle end state, r1R denotes a radius of curvature of the image side lens surface of the negative meniscus lens of the first lens group, and r2F denotes a radius of curvature of the object side lens surface of the negative lens of the first lens group; and

constructing such that, upon zooming from a wide-angle end state to a telephoto end state, a distance between the first lens group and the second lens group is varied.

In the method for manufacturing a zoom lens system according to the seventeenth aspect of the present invention, it is preferable that the following conditional expression is further satisfied:

−1.00≦(r1R−r1F)/(r1R+r1F)<−0.30

where r1F denotes a radius of curvature of the object side lens surface of the negative meniscus lens of the first lens group, and r1R denotes a radius of curvature of the image side lens surface of the negative meniscus lens of the first lens group.

Further, according to the eighteenth aspect of the present invention, there is provided a method for manufacturing a zoom lens system which comprises, in order from an object side, a first lens group having negative refractive power and a second lens group having positive refractive power, the method comprising steps of:

constructing such that the first lens group comprises, in order from the object side, a negative meniscus lens having a concave surface facing an image plane side, a negative lens and a positive lens having a convex surface facing the object side; constructing such that the second lens group comprises, in order from the object side, a positive lens, a first cemented lens and a second cemented lens;

constructing such that the following conditional expressions is satisfied;

0.20<S1/(fw×ft)^{1/2}<0.70

0.50<S2/(fw×ft)^{1/2}<1.00

where S1 denotes a distance along the optical axis from a most object side lens surface to a most image side surface, of the first lens group, S2 denotes a distance along the optical axis from a most object side lens surface to a most image side lens surface, of the second lens group, fw denotes a focal length of the zoom lens system at a wide-angle end state, and ft denotes a focal length of the zoom lens system at a telephoto end state; and

constructing such that, upon zooming from the wide-angle end state to the telephoto end state, a distance between the first lens group and the second lens group is varied.

In the method for manufacturing a zoom lens system according to the eighteenth aspect of the present invention, it is preferable that the following conditional expression is further satisfied:

1.00<(−f1)/S1<3.00

where f1 denotes a focal length of the first lens group, and S1 denotes a distance along the optical axis from a most object side lens surface to a most image side lens surface, of the first lens group.

In the method for manufacturing a zoom lens system according to the eighteenth aspect of the present invention, it is preferable that the following conditional expression being further satisfied:

0.20<fL1/fL2<0.50

where fL1 denotes a focal length of the negative meniscus lens of the first lens group, and fL2 denotes a focal length of the negative lens of the first lens group.

### Effect of the Invention

The present invention makes it possible to provide a zoom lens system that is compact in size and has a superb imaging performance for correcting various aberrations well, an optical apparatus equipped with the zoom lens system and a manufacturing method for the zoom lens system.

### BRIEF DESCRIPTION OF THE DRAWINGS

FIGS. 1A, 1B and 1C are sectional views showing lens a configuration of a zoom lens system according to a first example shared by the first to sixth embodiments of the present application, in which FIG. 1A shows in a wide-angle end state, FIG. 1B shows in an intermediate focal length state and

FIG. 1C shows in a telephoto end state.

FIGS. 2A, 2B and 2C are graphs showing various aberrations of the zoom lens system according to the first Example upon focusing on infinity, in which FIG. 2A is in a wide-angle end state, FIG. 2B is in an intermediate focal length state and FIG. 2C is in a telephoto end state.

FIGS. 3A, 3B and 3C are sectional views showing lens configuration of a zoom lens system according to a second example common to the first to sixth embodiments of the present application, in which FIG. 3A is in a wide-angle end state, FIG. 3B is in an intermediate focal length state and FIG. 3C is in a telephoto end state.

FIGS. 4A, 4B and 4C are graphs showing various aberrations of the zoom lens system according to the second example upon focusing on infinity, in which FIG. 4A is in a wide-angle end state, FIG. 4B is in an intermediate focal length state and FIG. 4C is in a telephoto end state.

FIGS. 5A, 5B and 5C are sectional views showing a lens configuration of a zoom lens system according to a third example shared by the first to sixth embodiments of the present application, in which FIG. 5A is in a wide-angle end state, FIG. 5B is in an intermediate focal length state and FIG. 5C is in a telephoto end state.

FIGS. 6A, 6B and 6C are graphs showing various aberrations of the zoom lens system according to the third example upon focusing on infinity, in which FIG. 6A is in a wide-angle end state, FIG. 6B is in an intermediate focal length state and FIG. 6C is in a telephoto end state.

FIGS. 7A, 7B and 7C are sectional views showing lens a configuration of a zoom lens system according to a fourth example shared by the first to sixth embodiments of the present application, in which FIG. 7A is in a wide-angle end state, FIG. 7B is in an intermediate focal length state and FIG. 7C is in a telephoto end state.

FIGS. 8A, 8B and 8C are graphs showing various aberrations of the zoom lens system according to the fourth example upon focusing on infinity, in which FIG. 8A is in a wide-angle end state, FIG. 8B is in an intermediate focal length state and FIG. 8C is in a telephoto end state.

FIGS. 9A, 9B and 9C are sectional views showing a lens configuration of a zoom lens according to a fifth example shared by the first to sixth embodiments of the present application, in which FIG. 9A is in a wide-angle end state, FIG. 9B is in an intermediate focal length state and FIG. 9C is in a telephoto end state.

FIGS. 10A, 10B and 10C are graphs showing various aberrations of the zoom lens system according to the fifth example upon focusing on infinity, in which FIG. 10A is in a wide-angle end state, FIG. 10B is in an intermediate focal length state and FIG. 10C is in a telephoto end state.

FIG. 11 indicates an example of a camera equipped with the zoom lens system according to the first to sixth embodiments of the present application.

FIG. 12 is a flowchart showing a method for manufacturing a zoom lens system according to the first embodiment of the present application.

FIG. 13 is a flowchart showing a method for manufacturing a zoom lens system according to the second embodiment of the present application.

FIG. 14 is a flowchart showing a method for manufacturing a zoom lens system according to the third embodiment of the present application.

FIG. 15 is a flowchart showing a method for manufacturing a zoom lens system according to the fourth embodiment of the present application.

FIG. 16 is a flowchart showing a method for manufacturing a zoom lens system according to the fifth embodiment of the present application.

FIG. 17 is a flowchart showing a method for manufacturing a zoom lens system according to the sixth embodiment of the present application.

### EMBODIMENTS FOR CARRYING OUT THE INVENTION

A zoom lens, an optical apparatus equipped with the zoom lens and a method for manufacturing the zoom lens according to the embodiments of the present application will be explained below. Incidentally, Embodiments explained below are for the purpose of making the understanding of the invention easier and are not intended to exclude adding or replacing matters by a skilled person in the art within the scope which does not deviate from the present invention.

### First Embodiment

A zoom lens according to the first embodiment has a configuration in which, it comprises, in order from an object side, a first lens group having negative refractive power; a second lens group having positive refractive power; upon zooming from a wide-angle end state to a telephoto end state, a distance between the first lens group and the second lens group varying; the first lens group comprising, in order from the object side, a negative meniscus lens having a concave surface facing an image plane side, a negative lens, and a positive lens having a convex surface facing the object side; and the second lens group comprising, in order from the object side, a positive lens, a first cemented lens and a second cemented lens.

In the zoom lens according to the first embodiment, with constructing the first lens group and the second lens group described above, it becomes possible to make the zoom lens compact in size with correcting various aberrations well. Moreover, in the zoom lens according to the first embodiment, it becomes possible to make the number of lenses of the zoom lens less and suppress deteriorating an imaging performance caused by positioning error upon manufacturing the zoom lens system.

A negative lens-leading type optical system can correct various aberrations well with relatively simple structure. For correcting various aberrations well, in the positive lens group disposed at the image side, lens(s) as positive lens element(s) and lense(s) as negative lens element(s) should be disposed in a well balanced manner so that various aberrations are cancelled each other. Therefore, the negative lens-leading type optical system usually includes a triplet type lens of convex-concave-convex in the positive lens group. However, in a case where the triplet type optical system is comprised of a positive single lens, a negative single lens and a positive single lens, it is necessary to, by the three single lenses, correct coma most generated after the positive lens disposed at the most object side in the positive lens group, thereby aberrations generated in each element are increased. This causes a problem that it becomes difficult to assemble the zoom lens system. According to the present invention, the negative lens is separated back and forth to be a modified triplet type lens composed of a positive single lens, a cemented lens constructed by a positive lens and a negative lens and a cemented lens constructed by a negative lens and a positive lens, thereby it becoming possible to disperse sensitivity of each element and correct various aberration well.

In the zoom lens system according to the first embodiment of the present invention, the following conditional expression (1-1) is satisfied:

0.00≦(−f1)/|fL56|<0.65 (1-1)

where f1 denotes a focal length of the first lens group, and fL56 denotes a focal length of the first cemented lens.

The conditional expression (1-1) defines a focal length of the first cemented lens in the second lens group to a focal length of the first lens group. With satisfying the conditional expression (1-1), various aberrations, especially coma and off-axis aberration can be corrected well, thereby superb imaging performance can be achieved.

When the ratio (−f1)/|fL56| is equal to or exceeds the upper limit of the conditional expression (1-1), the sensitivity of a lens disposed at an image side of the negative lens becomes relatively high, so that it becomes difficult to correct coma sufficiently. Accordingly, it is undesirable. On the other hand, when the ratio (−f1)/|fL56| is equal to or exceeds the lower limit of the conditional expression (1-1), variation in coma caused by zooming becomes less, so that off-axis aberration such as curvature of field is corrected well.

Incidentally, in order to secure the effect of the first embodiment, it is preferable to set the upper limit value of the conditional expression (1-1) to 0.50. In order to further secure the effect of the first embodiment, it is more preferable to set the upper limit value of the conditional expression (1-1) to 0.40. In order to further secure the effect of the first embodiment, it is more preferable to set the lower limit value of the conditional expression (1-1) to 0.02. In order to further secure the effect of the present first embodiment, it is more preferable to set the lower limit value to 0.05.

With the configuration described above, according to the present first embodiment, it becomes possible to realize a zoom lens system that is compact in size and has a superb imaging performance correcting various aberrations well.

Further, in the zoom lens according to the present first embodiment, it is preferable that the first cemented lens has negative refractive power. With this configuration that the first cemented lens has negative refractive power, various aberrations such as spherical aberration can be corrected well, so that superb imaging performance can be achieved.

Further, in the zoom lens according to first embodiment, it is preferable that the second cemented lens has positive refractive power. With this configuration that the second cemented lens has positive refractive power, various aberrations such as spherical aberration can be corrected well, so that superb imaging performance can be achieved.

In the zoom lens according to the first embodiment, it is preferable that the following conditional expression (1-2) is satisfied:

0.20<SL56/f2<0.40 (1-2)

where SL56 denotes a distance along the optical axis from a most object side lens surface and a most image side lens surface, of the first cemented lens, and f2 denotes a focal length of the second lens group.

The conditional expression (1-2) defines a condition relating to a total thickness of the first cemented lens in the second lens group (a distance along the optical axis from the most object side lens surface to the most image side lens surface, of the first cemented lens). With satisfying the conditional expression (1-2), it is possible to correct well spherical aberration, coma and Petzval sum, so that it is possible to achieve superb imaging performance.

When the ratio SL56/f2 is equal to or exceeds the upper limit value of the conditional expression (1-2), the focal length of the second lens group becomes small, so that it becomes difficult to correct well spherical aberration and coma. Accordingly, it is undesirable.

When the ratio SL56/f2 is equal to or falls below the lower limit value of the conditional expression (1-2), a thickness of the first cemented lens of the second lens group becomes too small, and it becomes difficult to correct Petzval sum well. Accordingly, it is undesirable. Furthermore, various aberrations tend to be generated, and in particular it becomes difficult to correct field of curvature, so that it is undesirable.

Incidentally, in order to secure the effect of the first embodiment, it is preferable to set the upper limit value of the conditional expression (1-2) to 0.38. In order to further secure the effect of the first embodiment, it is more preferable to set the upper limit value to 0.37. In order to further secure the effect of the first embodiment, it is more preferable to set the lower limit value of the conditional expression (1-2) to 0.23. In order to achieve further effect, it is more preferable to set the lower limit value to set 0.25.

In the zoom lens according to the first embodiment, it is preferable that the following conditional expression (1-3) is satisfied:

0.08<SB/S2<0.40 (1-3)

where SB denotes a distance along the optical axis from a most image side lens surface of the first cemented lens to a most object side lens surface of the second cemented lens, and S2 denotes a distance along the optical axis from a most object side lens surface to a most image side lens surface, of the second lens group.

The following conditional expression (1-3) defines a condition relating to an air interval between the first cemented lens and the second cemented lens in the second lens group. By satisfying the conditional expression (1-3), it is possible to correct well coma, Petzval sum, chromatic aberration and distortion and achieve excellent optical performance.

When the ratio SB/S2 exceeds the upper limit value of the conditional expression (1-3), it becomes difficult to maintain the height of the paraxial light rays low, and it becomes difficult to correct coma sufficiently. This is not desirable. Further, it becomes difficult to correct Petzval sum well, so that it is undesirable.

When the ratio SB/S2 falls below the lower limit value of the conditional expression (1-3), it becomes difficult to correct chromatic aberration as well as distortion well, so this is not desirable.

Incidentally, in order to secure the effect of the first embodiment, it is preferable to set the upper limit value of the conditional expression (1-3) to 0.30. In order to further secure the effect of the first embodiment, it is more preferable to set the upper limit value to 0.20. Further, in order to secure the effect of the first embodiment, it is preferable to set the lower limit value of the conditional expression (1-3) to 0.09. In order to further secure the effect of the first embodiment, it is more preferable to set the lower limit value to 0.11.

In the zoom lens system according to the first embodiment, the following conditional expression (1-4) is satisfied:

0.20<f2/TLw<0.35 (1-4)

where f2 denotes a focal length of the second lens group, and TLw denotes a distance along the optical axis from a most object side lens surface to the image plane upon focusing on infinity at the wide-angle end state.

The conditional expression (1-4) defines a focal length of the second lens group to a total optical length at the wide-angle end state (a distance along the optical axis from a most object side lens surface to the image plane upon focusing on infinity at the wide-angle end state). With satisfying the conditional expression (1-4), increase in an amount of movement of the second lens group upon zooming is prevented, and generation of shading is prevented, so that it is possible to correct well spherical aberration as well as coma and attain superb imaging performance.

When the ratio f2/TLw exceeds the upper limit value of the conditional expression (1-4), an amount of movement of the second lens group upon zooming is increased, and it is not possible to maintain an interval between the first lens group and the second lens group at the telephoto end state. This is not desirable. Alternatively, the total length is too short, so that an exit pupil displaces to the image plane side, thereby vignetting that is so-called shading being generated on the image plane. This is not desirable.

When the ratio f2/TLw falls below the lower limit value of the conditional expression (1-4), the focal length of the second lens group becomes too small, so it becomes difficult to correct spherical aberration as well as coma. This is not desirable.

Incidentally, in order to secure the effect of the first embodiment, it is preferable to set the upper limit value of the conditional expression (1-4) to 0.33. In order to further secure the effect of the first embodiment, it is more preferable to set the upper limit value to 0.31. Further, in order to secure the effect of the first embodiment, it is preferable to set the lower limit value of the conditional expression (1-4) to 0.22. In order to further secure the effect of the first embodiment, it is more preferable to set the lower limit value to 0.25.

Further, in the zoom lens system according to the first embodiment, it is preferable that the second lens group includes at least one negative lens satisfying the following conditional expression (1-5):

1.810<ndLi (1-5)

where ndLi denotes a refractive index of the negative lens at d-line (wavelength λ=587.6 nm).

The conditional expression (1-5) defines a refractive index at the d-line (λ=587.6 nm) of a lens having negative refractive power which is included at least one in the positive second lens group. With satisfying the conditional expression (1-5), it is possible to prevent increase in the aberrations of high order, correct well Petzval sum, and suppress deterioration in curvature of field at the wide angle end state, thereby it becoming possible to attain superb optical performance.

When the value of ndLi becomes below the lower limit value of the conditional expression (1-5), a curvature radius of a negative lens included in the second lens group becomes too small, and aberrations of high order are increased. This is not desirable. Further, correction of Petzval sum becomes difficult, and curvature of field at the wide angle end state, becomes deteriorated. This is not desirable.

Incidentally, in order to secure the effect of the first embodiment, it is preferable to set the lower limit value of the conditional expression (1-5) to 1.840. In order to further secure the effect of the first embodiment, it is more preferable to set the lower limit value to 1.870.

In the zoom lens system according to the first embodiment, it is preferable that the first cemented lens is composed of, in order from the object side, a cemented lens constructed by a positive lens cemented with a negative lens. With constructing the first cemented lens by the positive lens cemented with the negative lens, it is possible to correct aberrations such as spherical aberration as well as longitudinal chromatic aberration excellently, and to attain a downsized zoom lens system having high imaging performance.

In the zoom lens system according to the first embodiment, it is preferable that the second cemented lens is composed of, in order from the object side, a negative lens and a positive lens cemented together. With composing the second cemented lens by the negative lens and the positive lens, it is possible to correct excellently aberrations such as spherical aberration and longitudinal chromatic aberration, and attain a downsized zoom lens system having high imaging performance.

It is preferable that the zoom lens system according to the first embodiment includes an aperture stop, and the aperture stop is disposed at a more image plane side than a most image side lens surface of the first lens group. With such a configuration, the zoom lens system according to the first embodiment can correct superbly off-axis aberrations such as coma and achieve high imaging performance. Incidentally, it is more preferable that the aperture stop is disposed at an object side of the second lens group. With this configuration, the zoom lens system according to the first embodiment can correct more superbly off-axis aberrations such as coma and achieve high imaging performance.

In the zoom lens system according to the first embodiment, it is preferable that focusing from an infinitely distant object to a close distant object can be conducted by moving the entire first lens group, so that the zoom lens system according to the first embodiment, can be downsized.

In the zoom lens system according to the first embodiment, it is preferable that a parallel plane glass is disposed at the object side of the most object side lens surface of the first lens group.

With taking such a configuration, it is possible to protect the most image side lens surface of the first lens group from dust as well as contamination.

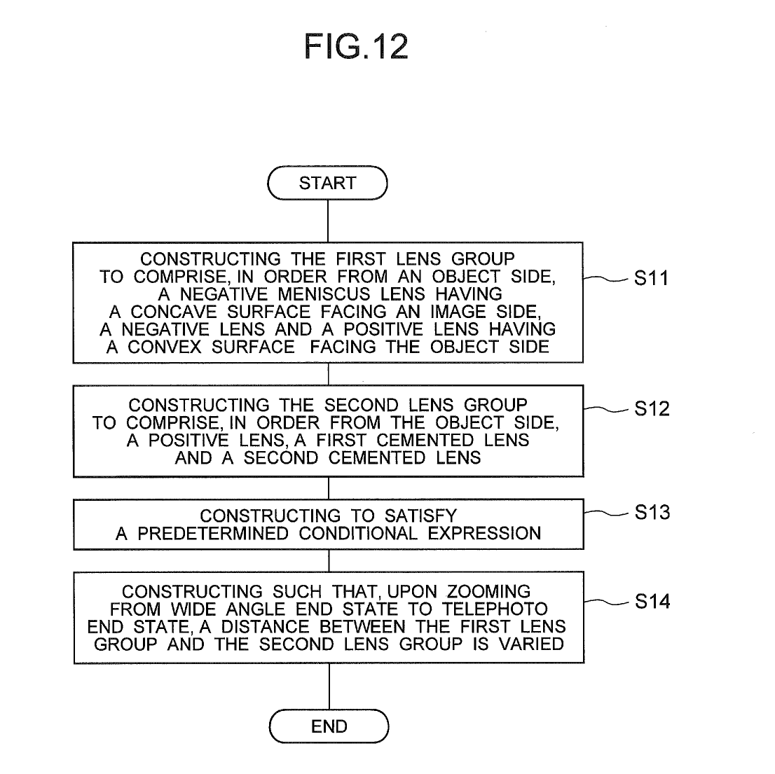

Next, a method for manufacturing the zoom lens system according to the first embodiment, will be explained with reference to FIG. 12.

A method for manufacturing a zoom lens shown in FIG. 12 is a method for manufacturing a zoom lens comprising, in order from the object side, a first lens group having negative refractive power and a second lens group having positive refractive power, the method comprising the following steps S11 through S14:

(Step S11)

Constructing the first lens group to comprise, in order from the object side, a negative meniscus lens having a concave surface facing an image plane side, a negative lens and a positive lens having a convex surface facing the object side.

(Step S12)

Constructing the second lens group to comprise, in order from the object side, a positive lens, a first cemented lens and a second cemented lens.

(Step S13)

Constructing the zoom lens such that the following conditional expression (1-1) is satisfied;

0.0≦(−f1)/|fL56|<0.65 (1-1)

where f1 denotes a focal length of the first lens group, and fL56 denotes a focal length of the first cemented lens.

(Step S14)

Disposing, in order from the object side, the first lens group and the second lens group in a lens barrel, and constructing such that a distance between the first lens group and the second lens group varies upon zooming from a wide-angle end state to a telephoto end state, by providing a known movement mechanism.

According to the method for manufacturing the zoom lens system of the present first embodiment, a downsized zoom lens system which can suppress variation in aberrations upon zooming and has high optical performance from the wide-angle end state to the telephoto end state, can be manufactured.

### Second Embodiment

The zoom lens system according to the second embodiment comprises, in order from an object side, a first lens group having negative refractive power and a second lens group having positive refractive power; upon zooming from a wide-angle end state to a telephoto end state, a distance between the first lens group and the second lens group varying; the first lens group comprising, in order from the object side, a negative meniscus lens having a concave surface facing an image plane side, a negative lens and a positive lens having a convex surface facing the object side; the second lens group comprising, in order from the object side, a positive lens, a first cemented lens and a second cemented lens.

By constructing the first lens group and the second lens group as above described, the zoom lens system according to the second embodiment, can be downsized while correcting aberrations excellently.

Further, each lens group can be composed by less number of lenses, and deterioration in imaging performance caused by position error upon assembling can be suppressed.

Further, the zoom lens system according to the second embodiment satisfies the following conditional expression (2-1):

−0.30<(r4R+r4F)/(r4R−r4F)<0.50 (2-1)

where r4F denotes a radius of curvature of the object side lens surface of the positive lens of the second lens group, and r4R denotes a radius of curvature of the image side lens surface of the positive lens of the second lens group.

The conditional expression (2-1) defines a shape factor of a single lens of positive refractive power disposed at the most object side in the second lens group. With satisfying the conditional expression (2-1), it is possible to suppress well off-axis aberration, and high optical performance can be attained.

When (r4R+r4F)/(r4R−r4F) is equal to or exceeds the upper limit value of the conditional expression (2-1), it is not possible to correct coma superbly, and therefore it is not desirable. Further, if it is intended to correct coma, an aspherical surface becomes necessary, which invites increase in cost.

When (r4R+r4F)/(r4R−r4F) is equal to or falls below the lower limit value of the conditional expression (2-1), it becomes not possible to correct superbly spherical aberration. This is not desirable.

Incidentally, in order to secure the effect of the second embodiment, it is preferable to set the upper limit value of the conditional expression (2-1) to 0.40. In order to further secure the effect of the second embodiment, it is more preferable to set the upper limit value to 0.30. Further, in order to secure the effect of the second embodiment, it is preferable to set the lower limit value of the conditional expression (2-1) to −0.20. In order to secure the effect of the second embodiment further, it is preferable to set the lower limit to −0.15.

By the above described configuration, according to the second embodiment, a downsized zoom lens system which can correct excellently various aberrations and has high optical performance can be realized.

Further, in the zoom lens system according to the second embodiment, it is preferable that the first cemented lens has negative refractive power.

With the first cemented lens having negative refractive power, as described above, aberrations such as spherical aberration or the like can be corrected well, and high optical performance can be attained.

Further, in the zoom lens system according to the second embodiment, it is preferable that the second cemented lens has positive refractive power. With the second cemented lens having positive refractive power, as described above, aberrations such as spherical aberration or the like can be corrected well, and high optical performance can be attained.

Further, it is preferable that the zoom lens system according to the second embodiment, satisfies the following conditional expression (2-2):

0.05<|fL78/fL56|<0.70 (2-2)

where fL78 denotes a focal length of the second cemented lens, and fL56 denotes a focal length of the first cemented lens.

The conditional expression (2-2) defines proper refractive powers of the first cemented lens and the second cemented lens for downsizing the lens system and securing high optical performance. With satisfying this conditional expression (2-2), it is possible to correct excellently spherical aberration as well as coma, and attain high optical performance.

When |fL78/fL56| is equal to or exceeds the upper limit value of the conditional expression (2-2), refractive power of the second cemented lens becomes large, and it becomes difficult to attain superb correction of various aberrations, such as, coma, curvature of field and astigmatism. Therefore, this is not desirable.

When |fL78/fL56| is equal to or falls below the lower limit value of the conditional expression (2-2), refractive power of the second cemented lens becomes small, and as a result the second lens group becomes large in size, thereby it becoming difficult to attain downsizing. This is not desirable. Moreover, refractive power of the positive lens of the second cemented lens, located at the object side of the first cemented lens, becomes large, and it becomes not possible to correct well spherical aberration as well as coma. Therefore, this is not desirable.

Incidentally, in order to secure the effect of the second embodiment, it is preferable to set the upper limit value of the conditional expression (2-2) to 0.65. In order to further secure the effect of the second embodiment, it is more preferable to set the upper limit value to 0.60. Further, in order to secure the effect of the second embodiment, it is preferable to set the lower limit value of the conditional expression (2-2) to 0.10. In order to achieve further effect, it is more preferable to set the lower limit value to set 0.15.

Further, it is preferable that the zoom lens system according to the second embodiment, satisfies the following conditional expression (2-3):

0.30<f2/S2<1.70 (2-3)

where f2 denotes a focal length of the second lens group, and S2 denotes a distance along the optical axis from a most object side lens surface to a most image side lens surface, of the second lens group.

The conditional expression (2-3) defines a proper range of a total thickness of the second lens group (the distance along the optical axis from the most object side lens surface to the most image side lens surface, of the second lens group) and the focal length of the second lens group. With satisfying this conditional expression (2-3), the zoom lens system, while being made compact in size, can correct well spherical aberration as well as coma, so that high optical performance can be attained.

When f2/S2 is equal to or exceeds the upper limit value of the conditional expression (2-3), the focal length of the second lens group becomes large, so that movement amount of the second lens group for obtaining zoom ratio is increased and it becomes not possible to maintain the distance between the first lens group and the second lens group at the telephoto end state. In order to secure the distance therebetween it is necessary to make the distance between the first lens group and the second lens group large, as a result downsizing of the zoom lens system becomes difficult. Furthermore, the focal length of the second lens group becomes large beyond necessity, so that the downsizing of the zoom lens system becomes difficult. In order to downsize the lens system, spherical aberration becomes large, so this is not desirable.

When f2/S2 is equal to or falls below the lower limit value of the conditional expression (2-3), the total thickness of the second lens group becomes too thin, so that superb corrections of spherical aberration as well as coma become difficult, so this is not desirable.

Incidentally, in order to secure the effect of the second embodiment, it is preferable to set the upper limit value of the conditional expression (2-3) to 1.60. In order to further secure the effect, it is more preferable to set the upper limit value to 1.50. In order to achieve further effect of the second embodiment, it is preferable to set the lower limit value of the conditional expression (2-3) to 0.50. In order to achieve further effect, it is preferable to set the lower limit value to set 0.80.

Further, in the zoom lens according to the second embodiment, it is preferable that the second lens group has at least one negative lens, which satisfies the following conditional expression (2-4):

1.810<ndLi (2-4)

where ndLi denotes a refractive index of the negative lens at d-line (λ=587.6 nm).

The conditional expression (2-4) defines refractive index at d-line (λ=587.6 nm) of the negative lens that is included at least one in the second lens group. With satisfying this conditional expression (2-4), radius of curvature by which this negative lens can have predetermined refractive power can be made larger, thereby aberration of high order can be reduced.

When ndLi is equal to or falls below the lower limit value of the conditional expression (2-4), the radius of curvature by which the negative lens has predetermined refractive power becomes too small, so that aberration of high order is increased. Moreover, it becomes difficult to correct Petzval sum, so that curvature of field at the wide angle end state becomes deteriorated. Therefore, this is not desirable.

Incidentally, in order to secure the effect of the second embodiment, it is preferable to set the lower limit value of the conditional expression (2-4) to 1.850. In order to achieve further effect of the second embodiment, it is preferable to set the lower limit value of the conditional expression (2-4) to set 1.900.

Further, in the zoom lens according to the second embodiment, it is preferable that the first cemented lens is composed of, in order from the object side, a positive lens and a negative lens cemented therewith. With constructing the first cemented lens composed of the positive lens and the negative lens cemented together, it is possible to correct well various aberrations such as spherical aberration as well as longitudinal chromatic aberration, and attain a downsized zoom lens system having high optical performance.

Further, in the zoom lens according to the second embodiment, it is preferable that the second cemented lens is composed of, in order from the object side, a negative lens and a positive lens cemented therewith. With constructing the second cemented lens being composed of the negative lens and the positive lens cemented together, it is possible to correct well various aberrations such as spherical aberration as well as longitudinal chromatic aberration, and attain a downsized zoom lens system having high optical performance.

It is preferable that the zoom lens system according to the second embodiment includes an aperture stop, and the aperture stop is disposed at a more image plane side than a most image side lens surface of the first lens group. With configuring as described above, the zoom lens system according to the second embodiment can correct superbly off-axis aberrations such as coma and achieve high imaging performance. Incidentally, it is more preferable that in the zoom lens system according to the second embodiment, the aperture stop is disposed at the object side of the second lens group. With such a configuration, the zoom lens system according to the second embodiment can correct more superbly off-axis aberrations such as coma and can achieve high imaging performance.

It is preferable that the zoom lens system according to the second embodiment includes a fixed aperture stop, and this fixed aperture stop is disposed at an image plane side of the first cemented lens. With taking such a configuration as described, the zoom lens system according to the second embodiment can correct superbly coma as well as curvature of field and achieve high imaging performance.

Further, it is preferable that in the zoom lens system according to the second embodiment, focusing from an infinitely distant object to a closely distant object is carried out by moving the entire first lens group, thereby it becoming possible to make the zoom lens system according to the second embodiment compact in size.

In the zoom lens system according to the second embodiment, it is preferable that a parallel plane glass is disposed at the object side of the most object side lens surface of the first lens group.

With taking such a configuration, it is possible to protect the most image side lens surface of the first lens group from dust as well as contamination.

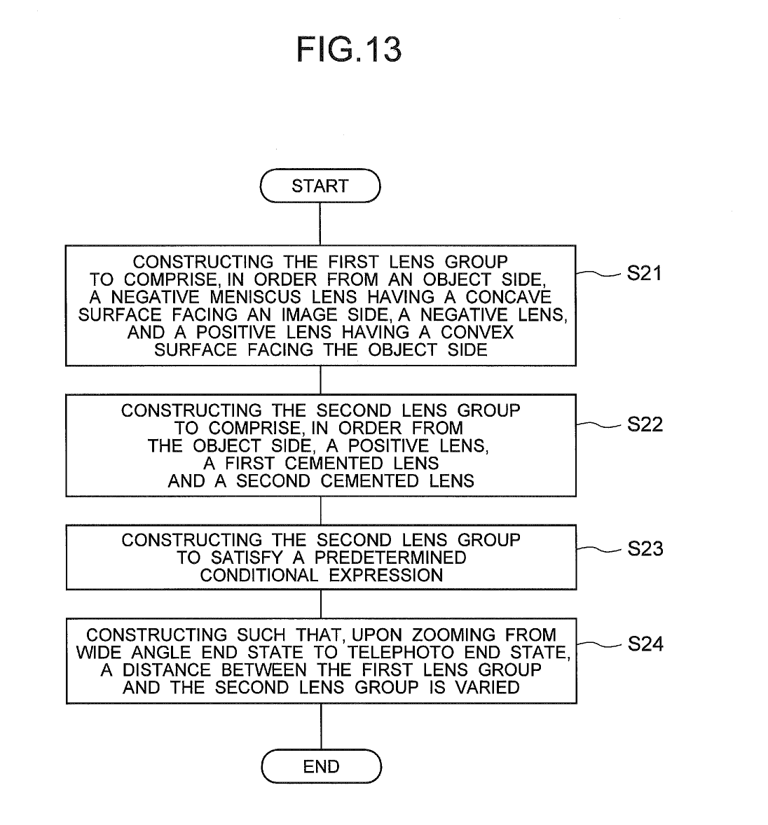

Next, a method for manufacturing the zoom lens system according to the second embodiment, will be explained with reference to FIG. 13.

The method for manufacturing a zoom lens shown in FIG. 13 is a method for manufacturing a zoom lens comprising, in order from the object side, a first lens group having negative refractive power and a second lens group having positive refractive power, the method comprising the following steps S21-S24:

(Step S21)

Constructing the first lens group to comprise, in order from the object side, a negative meniscus lens having a concave surface facing an image plane side, a negative lens and a positive lens having a convex surface facing the object side.

(Step S22)

Constructing the second lens group to comprise, in order from the object side, a positive lens, a first cemented lens and a second cemented lens.

(Step S23)

Constructing the second lens group to satisfy the following conditional expression (2-1);

−0.30<(r4R+r4F)/(r4R−r4F)<0.50 (2-1)

where r4F denotes a radius of curvature of the object side lens surface of the positive lens of the second lens group, and r4R denotes a radius of curvature of the image side lens surface of the positive lens of the second lens group.

(Step S24)

Disposing, in order from the object side, the first lens group and the second lens group in a lens barrel, and constructing such that an interval between the first lens group and the second lens group varies upon zooming from a wide-angle end state to a telephoto end state, by providing a known movement mechanism.

According to the method for manufacturing the zoom lens system according to the present second embodiment, it is possible to manufacture a downsized zoom lens system which can suppress variation in aberrations upon zooming and has high imaging performance from the wide-angle end state to the telephoto end state.

### Third Embodiment

The zoom lens according to the third embodiment comprises, in order from an object side, a first lens group having negative refractive power and a second lens group having positive refractive power; upon zooming from a wide-angle end state to a telephoto end state, a distance between the first lens group and the second lens group varying; the first lens group comprising, in order from the object side, a negative meniscus lens having a concave surface facing an image plane side, a negative lens and a positive lens having a convex surface facing the object side; the second lens group comprising, in order from the object side, a positive lens, a first cemented lens and a second cemented lens.

The zoom lens system according to the third embodiment, can be downsized while correcting aberrations excellently by constructing the first lens group and the second lens group as above described.

Further, each lens group can be composed by less number of lenses, and deterioration in imaging performance caused by positioning error upon assembling can be suppressed.

Further, the zoom lens according to the third embodiment satisfies the following conditional expression (3-1):

1.40<f2/fw<1.85 (3-1)

where f2 denotes a focal length of the second lens group, and fw denotes a focal length of the zoom lens system at the wide-angle end state.

The conditional expression (3-1) defines a proper range of the focal length of the positive second lens group by the focal length in the wide angle end state. With satisfying the conditional expression (3-1), it is possible to prevent generation of so-called shading and secure sufficient zoom ratio. Further it is possible to correct well spherical aberration and coma, and attain high optical performance.

When f2/fw is equal to or exceeds the upper limit value of the conditional expression (3-1), an amount of movement of the second lens group upon zooming is increased, and it is not possible to maintain a distance between the first lens group and the second lens group at the telephoto end state.

This is not desirable. Alternatively, the total length is too short, so that an exit pupil displaces to the image plane side, thereby vignetting that is so-called shading being generated at the image plane. This is not desirable.

When f2/fw is equal to or falls below the lower limit value of the conditional expression (3-1), the focal length at the wide angle end state becomes too long, so that it is not possible to secure sufficient zoom ratio and widen an angle of view of the lens system. This is not desirable. Moreover, the focal length of the second lens group is too small, and it is difficult to correct spherical aberration as well as coma sufficiently.

Incidentally, in order to secure the effect of the third embodiment, it is preferable to set the upper limit value of the conditional expression (3-1) to 1.75. In order to further secure the effect of the third embodiment, it is more preferable to set the upper limit value to 1.65. Further, in order to secure the effect of the third embodiment, it is preferable to set the lower limit value of the conditional expression (3-1) to 1.42. In order to secure the effect of the third embodiment further, it is preferable to set the lower limit value to 1.44.

By the above described configuration, according to the third embodiment, a downsized zoom lens system which can correct excellently various aberrations and has high optical performance can be realized.

Further, in the zoom lens system according to the third embodiment, it is preferable that the first cemented lens has negative refractive power. With the first cemented lens having negative refractive power, as described above, it is possible to correct well various aberrations such as spherical aberration or the like, and attain high optical performance.

Further, in the zoom lens system according to the third embodiment, it is preferable that the second cemented lens has positive refractive power.

With the second cemented lens having positive refractive power, as described above, it is possible to correct well various aberrations such as spherical aberration or the like, and attain high imaging performance.

Further, it is preferable that the zoom lens according to the third embodiment satisfies the following conditional expression (3-2):

0.15<S2/TLt<0.35 (3-2)

where S2 denotes a distance along the optical axis from a most object side lens surface to a most image side lens surface, of the second lens group, and TLt denotes a distance along the optical axis from a most object side lens surface to the image plane upon focusing on infinity at the telephoto-end state.

The conditional expression (3-2) defines a proper balance of the total length at the telephoto end state (a distance along the optical axis from a most object side lens surface upon focusing on infinity at the telephoto end state to the image plane) and the thickness of the second lens group (the distance along the optical axis from the most object side lens surface to the most image side lens surface, of the second lens group). With satisfying the conditional expression (3-2), it is possible to prevent generation of so-called shading and correct well spherical aberration and coma, and attain high optical performance.

When S2/TLt is equal to or exceeds the upper limit value of the conditional expression (3-2), the total length is too short, so an exit pupil displaces to the image plane side, thereby vignetting that is so-called shading being generated at the image plane. This is not desirable.

When S2/TLt is equal to or falls below the lower limit value of the conditional expression (3-2), the total thickness of the second lens group becomes too short, so that it becomes difficult to correct spherical aberration and coma. This is not desirable.

Incidentally, in order to secure the effect of the third embodiment, it is preferable to set the upper limit value of the conditional expression (3-2) to 0.30. In order to further secure the effect of the third embodiment, it is more preferable to set the upper limit value to 0.25. Further, in order to secure the effect of the third embodiment, it is preferable to set the lower limit value of the conditional expression (3-2) to 0.17. In order to secure the effect of the third embodiment further, it is preferable to set the lower limit value to 0.19.

It is preferable that the zoom lens system according to the third embodiment includes an aperture stop, and the aperture stop is disposed at a more image plane side than a most image side lens surface of the first lens group. With configuring as described above, the zoom lens system according to the third embodiment can correct superbly off-axis aberrations such as coma and achieve high imaging performance. Incidentally, it is more preferable that in the zoom lens system according to the third embodiment, the aperture stop is disposed at the object side of the second lens group. With such a configuration, the zoom lens system according to the third embodiment can correct more superbly off-axis aberrations such as coma and can achieve high imaging performance.

Further, it is preferable that the zoom lens according to the third embodiment satisfies the following conditional expression (3-3):

0.65<SA/r6R≦1.40 (3-3)

where SA denotes a distance along the optical axis from the aperture stop to a most image side lens surface of the first cemented lens, and r6R denotes a radius of curvature of the image side lens surface of the first cemented lens.

The conditional expression (3-3) defines a preferable balance of the distance from the aperture stop to the image side lens surface of the first cemented lens and the radius of curvature of the image side lens surface of the first cemented lens. With satisfying the conditional expression (3-3), lowering of the brightness as well as displacement of an exit pupil toward the image side are prevented and it is possible to maintain height of paraxial light rays to be low, thereby it being possible to correct off-axis coma excellently and attain high imaging performance.

Although it is preferable that, in order to conduct the corrections of spherical aberration as well as upper coma in a balanced manner, the image side lens surface of the first cemented lens in the second lens group is shaped to have a concave surface at the image side, the smaller the radius of curvature of the lens image side lens surface is, the larger the deflection angle is, so that the larger the distance from the stop to the image side lens surface is the larger the tendency of outward coma is.

When SA/r6R is equal to or exceeds the upper limit value of the conditional expression (3-3), the distance between the first lens group and the second lens group becomes large, and the brightness becomes lowered. This is not desirable. Further, the exit pupil is displaced toward the image side. This is not desirable.

When SA/r6R is equal to or falls below the upper limit value of the conditional expression (3-3), it becomes difficult to maintain the height of the paraxial light rays low, so it becomes difficult to correct well off-axis coma. This is not preferable.

Incidentally, in order to secure the effect of the third embodiment, it is preferable to set the upper limit value of the conditional expression (3-3) to 1.30. In order to further secure the effect of the third embodiment, it is more preferable to set the upper limit value to 1.20. Further, in order to achieve further the effect of the third embodiment, it is preferable to set the lower limit value of the conditional expression (3-3) to 0.75. In order to achieve further the effect of the third embodiment, it is preferable to set the lower limit value to 0.85.

Further, it is preferable that the zoom lens according to the third embodiment satisfies the following conditional expression (3-4):

0.00≦f2/|fL56|<0.70 (3-4)

where f2 denotes a focal length of the second lens group, and fL56 denotes a focal length of the first cemented lens.

The conditional expression (3-4) defines a proper balance of the focal length of the second lens group and the focal length of the first cemented lens in the second lens group. With satisfying the conditional expression (3-4), it is possible to prevent increase in movement amount upon zooming of the second lens group, and suppress variation in coma upon zooming. Further, it is possible to correct well off-axis aberration, spherical aberration and coma and attain high imaging performance.

When f2/|fL56| is equal to or exceeds the upper limit value of the conditional expression (3-4), movement amount of the second lens group upon zooming is increased, so that it is not possible to maintain the distance between the first lens group and the second lens group. This is not preferable. Moreover, variation in coma upon zooming is increased, and it becomes difficult to correct off-axis aberration. This is not preferable.

When f2/|fL56| exceeds the lower limit value of the conditional expression (3-4), spherical aberration and coma can be excellently corrected.

Incidentally, in order to secure the effect of the third embodiment, it is preferable to set the upper limit value of the conditional expression (3-4) to 0.50. In order to further secure the effect of the third embodiment, it is more preferable to set the upper limit value to 0.30. Further, in order to achieve further the effect of the third embodiment, it is preferable to set the lower limit value to 0.02. In order to achieve further the effect of the third embodiment, it is preferable to set the lower limit value to 0.05.

Further, it is preferable that the second lens group includes at least one negative lens satisfying the following conditional expression (3-5):

1.810<ndLi (3-5)

where ndLi denotes a refractive index of the negative lens at d-line (λ=587.6 nm).

The conditional expression (3-5) defines a refractive index of at least one lens having negative refractive power which is included in the positive second lens group with respect to the d-line (λ=587.6 nm). With satisfying the conditional expression (3-5), it is possible to prevent increase in the aberrations of high order, correct well Petzval sum, and suppress deterioration in curvature of field at the wide angle end state, thereby superb imaging performance being attained.

When the value of ndLi becomes below the lower limit value of the conditional expression (3-5), a curvature radius of the negative lens included in the second lens group becomes too small, and aberrations of high order is increased. This is not desirable. Further, correction of Petzval sum becomes difficult, and curvature of field at the wide angle end state, becomes deteriorated. This is not desirable.

Incidentally, in order to secure the effect of the third embodiment, it is preferable to set the lower limit of the conditional expression (3-5) to 1.840. In order to further secure the effect of the third embodiment, it is more preferable to set the lower limit value to 1.870.

In the zoom lens system according to the third embodiment, it is preferable that the first cemented lens is composed of, in order from the object side, a cemented lens constructed by a positive lens cemented with a negative lens. With constructing the first cemented lens by the positive lens cemented with the negative lens, aberrations such as spherical aberration as well as longitudinal chromatic aberration can be excellently corrected, and a downsized zoom lens system having high imaging performance can be attained.

In the zoom lens system according to the third embodiment, it is preferable that the second cemented lens is composed of, in order from the object side, a negative lens and a positive lens. With composing the second cemented lens by the negative lens and the positive lens, it is possible to correct excellently aberrations such as spherical aberration and longitudinal chromatic aberration, and a downsized zoom lens system having high imaging performance can be attained.

In the zoom lens system according to the third embodiment, it is preferable that focusing from an infinitely distant object to a close distant object is conducted by moving the entire first lens group, so that the zoom lens system according to the third embodiment, can be downsized.

In the zoom lens system according to the third embodiment, it is preferable that a parallel plane glass is disposed at the object side of the most object side lens surface of the first lens group. With taking such a configuration, it is possible to protect the most image side lens surface of the first lens group from dust as well as contamination.

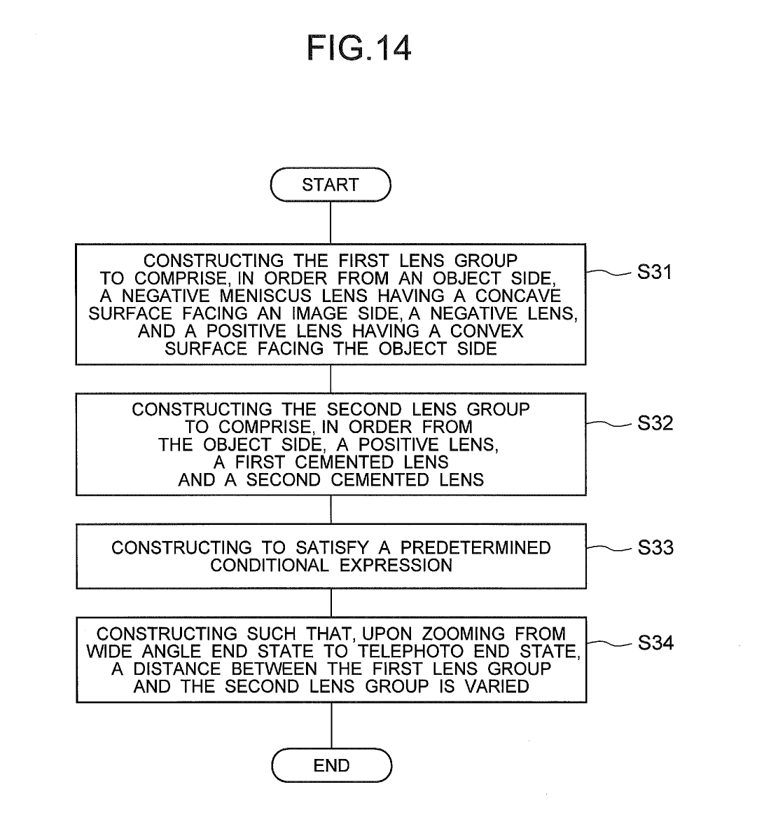

Next, a method for manufacturing the zoom lens system according to the third embodiment, will be explained with reference to FIG. 14.

A method for manufacturing a zoom lens shown in FIG. 14 is a method for manufacturing a zoom lens comprising, in order from the object side, a first lens group having negative refractive power and a second lens group having positive refractive power, the method comprising the following steps S31-S34:

(Step S31)

Constructing the first lens group to comprise, in order from the object side, a negative meniscus lens having a concave surface facing an image plane side, a negative lens and a positive lens having a convex surface facing the object side.

(Step S32)

Constructing the second lens group to comprise, in order from the object side, a positive lens, a first cemented lens and a second cemented lens.

(Step S33)

Constructing the zoom lens to satisfy the following conditional expression (3-1);

1.40<f2/fw<1.85 (3-1)

where f2 denotes a focal length of the second lens group, and fw denotes a focal length of the zoom lens system at the wide-angle end state.

(Step S34)

Disposing, in order from the object side, the first lens group and the second lens group in a lens barrel, and constructing such that a distance between the first lens group and the second lens group varies upon zooming from a wide-angle end state to a telephoto end state, by providing a known movement mechanism.

According to the method for manufacturing the zoom lens system of the present third embodiment, a downsized zoom lens system which can suppress variation in aberrations upon zooming and has high optical performance from the wide-angle end state to the telephoto end state, can be manufactured.

### Fourth Embodiment

The zoom lens according to the fourth embodiment comprises, in order from an object side, a first lens group having negative refractive power and a second lens group having positive refractive power; upon zooming from a wide-angle end state to a telephoto end state, a distance between the first lens group and the second lens group varying; the first lens group comprising, in order from the object side, a negative meniscus lens having a concave surface facing an image plane side, a negative lens and a positive lens having a convex surface facing the object side; the second lens group comprising, in order from the object side, a positive lens, a first cemented lens and a second cemented lens.

The zoom lens system according to the fourth embodiment, can be downsized while correcting aberrations excellently by constructing the first lens group as above described. Further, the first lens group can be composed by less number of lenses, and deterioration in imaging performance caused by positioning error upon assembling can be suppressed.

The zoom lens system according to the fourth embodiment, can be downsized while correcting aberrations excellently by constructing the first lens group having negative refractive power as above described. Further, the first lens group having negative refractive power can be composed by less number of lenses, and assembling error can be suppressed.

Further, the zoom lens according to the fourth embodiment satisfies the following conditional expression (4-1):

0.15<S2/TLw<0.28 (4-1)

where S2 denotes a distance along the optical axis from a most object side lens surface to a most image side lens surface, of the second lens group, and TLw denotes a distance along the optical axis from a most object side lens surface upon focusing on infinity at the wide angle end state to the image plane.

The conditional expression (4-1) defines a proper balance of the total length at the wide angle end state (a distance along the optical axis from a most object side lens surface upon focusing on infinity at the wide angle end state to the image plane) and the thickness of the second lens group (the distance along the optical axis from the most object side lens surface to the most image side lens surface, of the second lens group). With satisfying the conditional expression (4-1), it is possible to prevent generation of so-called shading and correct well spherical aberration and coma, and attain high optical performance.

When S2/TLw is equal to or exceeds the upper limit value of the conditional expression (4-1), the total length is too short and vignetting that is so-called shading is generated at the image plane. This is not desirable.

When S2/TLw is equal to or falls below the lower limit value of the conditional expression (4-1), the thickness of the second lens group becomes too short, so that it becomes difficult to correct spherical aberration and coma. This is not desirable.

Incidentally, in order to secure the effect of the fourth embodiment, it is preferable to set the upper limit value of the conditional expression (4-1) to 0.26. In order to further secure the effect of the fourth embodiment, it is more preferable to set the upper limit value to 0.24. Further, in order to secure the effect of the fourth embodiment, it is preferable to set the lower limit value of the conditional expression (4-1) to 0.17. In order to secure the effect of the fourth embodiment further, it is preferable to set the lower limit value to 0.19.

With the above described configuration, according to the fourth embodiment, it is possible to realize a downsized zoom lens system which can correct various aberrations excellently.

In the zoom lens system according to the fourth embodiment, it is preferable that the first cemented lens has negative refractive power. With the first cemented lens having negative refractive power, aberrations such as spherical aberration can be excellently corrected, and high imaging performance can be attained.

In the zoom lens system according to the fourth embodiment, it is preferable that the second cemented lens has positive refractive power. With the second cemented lens having positive refractive power, it is possible to correct excellently aberrations such as spherical aberration and attain high imaging performance.

Further, it is preferable that the zoom lens according to the fourth embodiment satisfies the following conditional expression (4-2):

0.85<f2/(fw×ft)^{1/2}<1.10 (4-2)

where f2 denotes a focal length of the second lens group, fw denotes a focal length of the zoom lens system at the wide-angle end state, and ft denotes a focal length of the zoom lens system at the telephoto end state.

The conditional expression (4-2) is a conditional expression defining a proper range of the focal length of the second lens group having positive refractive power by the intermediate focal length of the whole system. With satisfying the conditional expression (4-2), it is possible to prevent increase in movement amount of the second lens group upon zooming and generation of so-called shading. Further, it is possible to correct well spherical aberration and coma, and attain high optical performance.

When f2/(fw×ft)^{1/2} is equal to or exceeds the upper limit value of the conditional expression (4-2), movement amount of the second lens group upon zooming is increased, so that the distance between the first lens group and the second lens group at the telephoto end state can not be maintained. This is not desirable. Further, the total length becomes too short and the exit pupil is displaced at the image side, thereby vignetting that is so-called shading being generated at the image plane. This is not desirable.

When f2/(fw×ft)^{1/2} is equal to or falls below the lower limit value of the conditional expression (4-2), the focal length of the second lens group becomes too small, so that it becomes difficult to correct spherical aberration and coma sufficiently. This is not desirable.

Incidentally, in order to secure the effect of the fourth embodiment, it is preferable to set the upper limit value of the conditional expression (4-2) to 1.07. In order to further secure the effect of the fourth embodiment, it is more preferable to set the upper limit value to 1.04. Further, in order to secure the effect of the fourth embodiment, it is preferable to set the lower limit value of the conditional expression (4-2) to 0.90. Furthermore, in order to secure the effect of the fourth embodiment, it is preferable to set the lower limit value to 0.95.

Further, it is preferable that the zoom lens system according to the fourth embodiment satisfies the following conditional expression (4-3):

0.50<fL1/f1<1.00 (4-3)

where fL1 denotes a focal length of the negative meniscus lens of the first lens group, and f1 denotes a focal length of the first lens group.

The conditional expression (4-3) defines the focal length of the negative meniscus lens of the first lens group with using the focal length of the first lens group in order to make the entire length of the lens system short and downsize the system.

With satisfying the conditional expression (4-3), it becomes possible to correct off-axis aberration such as lower coma and lateral chromatic aberration excellently and prevent an amount of peripheral light rays from decreasing, so that high imaging performance can be achieved.

When fL1/f1 is equal to or falls below the lower limit value of the conditional expression (4-3), the refractive power of the negative meniscus lens of the first lens group becomes large, so that it becomes difficult to correct lateral chromatic aberration. This is not desirable.

When fL1/f1 is equal to or exceeds the upper limit value of the conditional expression (4-3), the refractive power of the first lens group becomes small, so that it becomes difficult to correct off-axis aberration such as lower coma and an amount of peripheral light rays is decreased. This is not desirable.

Incidentally, in order to secure the effect of the fourth embodiment, it is preferable to set the upper limit value of the conditional expression (4-3) to 0.95. In order to further secure the effect of the fourth embodiment, it is more preferable to set the upper limit value to 0.90. Further, in order to secure the effect of the fourth embodiment, it is preferable to set the lower limit value of the conditional expression (4-3) to 0.60. Furthermore, in order to secure the effect of the fourth embodiment, it is preferable to set the lower limit value to 0.65.

Further, it is preferable that the zoom lens system according to the fourth embodiment satisfies the following conditional expression (4-4):

0.10<S1/TLw<0.20 (4-4)

where S1 denotes a distance along the optical axis from a most object side lens surface to a most image side lens surface of the first lens group, and TLw denotes a distance along the optical axis from a most object side lens surface to the image plane upon focusing on infinity at the wide-angle end state.

The conditional expression (4-4) defines a proper balance of the total length at the wide angle end state (a distance along the optical axis from a most object side lens surface upon focusing on infinity at the wide angle end state to the image plane) and the thickness of the first lens group (the distance along the optical axis from the most object side lens surface to the most image side lens surface, of the first lens group). With satisfying the conditional expression (4-4), it is possible to, while downsizing the system, prevent generation of so-called shading and correct well spherical aberration, distortion and Petzval sum, thereby being able to attain high optical performance.

When S1/TLw is equal to or exceeds the upper limit value of the conditional expression (4-4), the total length is too short, so that an exit pupil displaces to the image plane side, thereby vignetting that is so-called shading is generated at the image plane. This is not desirable.

When S1/TLw is equal to or falls below the lower limit value of the conditional expression (4-4), the total length becomes too large, and the lens system becomes large in size. If downsizing is intended, it becomes not possible to correct spherical aberration superbly. This is not desirable. Alternatively, the thickness of the first lens group becomes too thin, and it becomes difficult to correct distortion and Petzval sum. This is not desirable.

Incidentally, in order to secure the effect of the fourth embodiment, it is preferable to set the upper limit value of the conditional expression (4-4) to 0.18. In order to further secure the effect of the fourth embodiment, it is more preferable to set the upper limit value to 0.16. Further, in order to secure the effect of the fourth embodiment, it is preferable to set the lower limit value of the conditional expression (4-4) to 0.11. In order to secure the effect of the fourth embodiment further, it is preferable to set the lower limit value of the conditional expression (4-4) to 0.12.

Further, it is preferable that, in the zoom lens system according to the fourth embodiment, the second lens group includes at least one negative lens that satisfies the following conditional expression (4-5):

1.810<ndLi (4-5)

where ndLi denotes a refractive index of the negative lens at d-line (wavelength λ=587.6 nm).

The conditional expression (4-5) defines a refractive index at the d-line (λ=587.6 nm) of at least one lens having negative refractive power which is included in the positive second lens group. With satisfying the conditional expression (4-5), it is possible to prevent increase in the aberrations of high order and correct well Petzval sum. Thus, deterioration in curvature of field at the wide angle end state can be suppressed, so superb imaging performance can be attained.

When the value of ndLi becomes below the lower limit value of the conditional expression (4-5), a curvature radius of the negative lens included in the second lens group becomes too small, and aberrations of high order is increased. This is not desirable. Further, correction of Petzval sum becomes difficult, and curvature of field at the wide angle end state, becomes deteriorated. This is not desirable.

Incidentally, in order to secure the effect of the fourth embodiment, it is preferable to set the lower limit of the conditional expression (4-5) to 1.860. In order to further secure the effect of the fourth embodiment, it is more preferable to set the lower limit value to 1.900.

In the zoom lens system according to the third embodiment, it is preferable that the first cemented lens consists of, in order from the object side, a cemented lens constructed by a positive lens cemented with a negative lens. With constructing the first cemented lens by the positive lens cemented with the negative lens, aberrations such as spherical aberration as well as longitudinal chromatic aberration can be excellently corrected, and a downsized zoom lens system having high imaging performance can be attained.

In the zoom lens system according to the fourth embodiment, it is preferable that the second cemented lens is composed of, in order from the object side, a negative lens and a positive lens cemented together. With composing the second cemented lens by the negative lens and the positive lens cemented together, it is possible to correct excellently aberrations such as spherical aberration and longitudinal chromatic aberration, and a downsized zoom lens system having high imaging performance can be attained.

It is preferable that the zoom lens system according to the fourth embodiment includes an aperture stop, and the aperture stop is disposed at a more image plane side than a most image side lens surface of the first lens group. With configuring as described above, the zoom lens system according to the fourth embodiment can correct superbly off-axis aberrations such as coma and achieve high imaging performance. Incidentally, it is preferable that in the zoom lens system according to the fourth embodiment, the aperture stop is disposed at the object side of the second lens group. With such a configuration, the zoom lens system according to the fourth embodiment can correct superbly off-axis aberrations such as coma and can achieve high imaging performance.

Further, it is preferable that in the zoom lens system according to the fourth embodiment, focusing from the wide angle end state to the telephoto end state is carried out by moving the entire first lens group, thereby the zoom lens system according to the fourth embodiment being made compact in size.

In the zoom lens system according to the fourth embodiment, it is preferable that a parallel plane glass is disposed at the object side of the most object side lens surface of the first lens group. With taking such a configuration, it is possible to protect the most image side lens surface of the first lens group from dust as well as contamination.

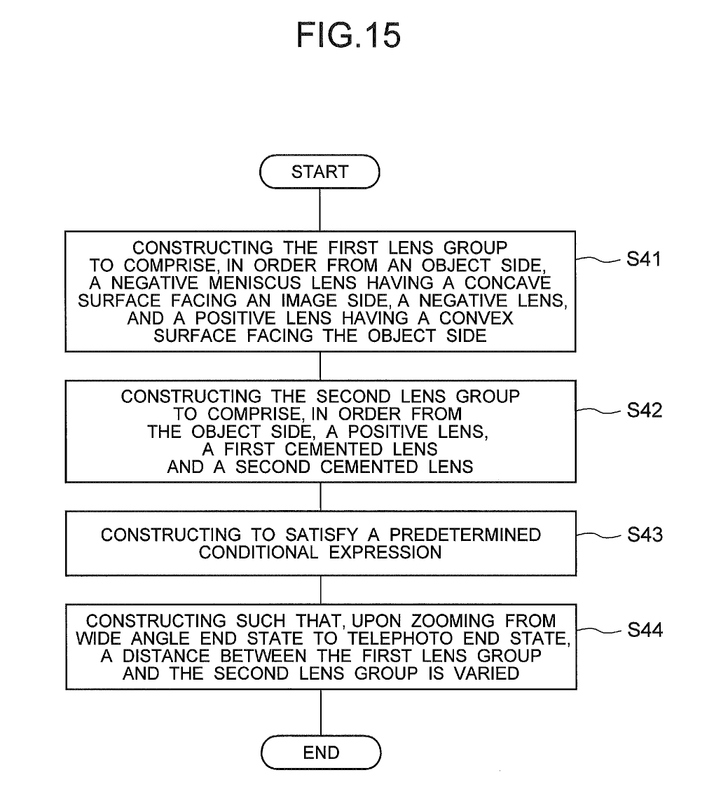

Next, a method for manufacturing the zoom lens system according to the fourth embodiment, will be explained with reference to FIG. 15.

The method for manufacturing a zoom lens system shown in FIG. 15 is a method for manufacturing a zoom lens system comprising, in order from the object side, a first lens group having negative refractive power and a second lens group having positive refractive power, the method comprising the following steps S41-S44:

(Step S41)

Constructing the first lens group to comprise, in order from the object side, a negative meniscus lens having a concave surface facing an image plane side, a negative lens and a positive lens having a convex surface facing the object side.

(Step S42)

Constructing the second lens group to comprise, in order from the object side, a positive lens, a first cemented lens and a second cemented lens.

(Step S43)

Constructing the zoom lens such that the following conditional expression (4-1) is satisfied;

0.15<S2/TLw<0.28 (4-1)

where S2 denotes a distance along the optical axis from a most object side lens surface to a most image side lens surface, of the second lens group, and TLw denotes a distance along the optical axis from a most object side lens surface to the image plane upon focusing on infinity at the wide-angle end state.

(Step S44)

Disposing, in order from the object side, the first lens group and the second lens group in a lens barrel, and constructing such that a distance between the first lens group and the second lens group varies upon zooming from a wide-angle end state to a telephoto end state, by providing a known movement mechanism.

According to the method for manufacturing the zoom lens system of the present fourth embodiment, it is possible to manufacture a downsized zoom lens system which can suppress variation in aberrations upon zooming and has high optical performance from the wide-angle end state to the telephoto end state.

### Fifth Embodiment

The zoom lens system according to the fifth embodiment comprises, in order from an object side, a first lens group having negative refractive power and a second lens group having positive refractive power; upon zooming from a wide-angle end state to a telephoto end state, a distance between the first lens group and the second lens group varying; the first lens group comprising, in order from the object side, a negative meniscus lens having a concave surface facing an image plane side, a negative lens and a positive lens having a convex surface facing the object side; the second lens group comprising, in order from the object side, a positive lens, a first cemented lens and a second cemented lens.

The zoom lens system according to the fifth embodiment, can be downsized while correcting aberrations excellently by constructing the first lens group and the second lens group as above described. Further, each lens group can be composed by less number of lenses, and deterioration in imaging performance caused by positioning error upon assembling can be suppressed.

In the zoom lens system comprising a first lens group having negative refractive power and a second lens group having positive refractive power, though it being possible to make each lens group configuration relatively simple, since height of incident angle differ largely between a wide angle end state and a telephoto end state, aberration correction in the first lens group becomes important. The large sized first lens group directly affects entire size of a camera, so the first lens group as thin as possible is desired. In order not to make the first lens group larger in thickness, and in order to correct aberrations excellently, it is very effective to take a configuration that the first lens group comprises, in order from an object side, a negative meniscus lens having a concave surface facing an image plane side, a negative lens and a positive lens having a convex surface facing the object side.

Further, the zoom lens according to the fifth embodiment satisfies the following conditional expressions (5-1) and (5-2):

0.50<S1/fw<0.88 (5-1)

0.00<(r2F+r1R)/(r2F−r1R)<2.00 (5-2)

where S1 denotes a distance along the optical axis from a most object side lens surface to a most image side lens surface, of the first lens group, fw denotes a focal length of the zoom lens system at the wide-angle end state, r1R denotes a radius of curvature of the image side lens surface of the negative meniscus lens of the first lens group, and r2F denotes a radius of curvature of the object side lens surface of the negative lens of the first lens group.

The conditional expression (5-1) defines the total thickness of the first lens group (the distance along the optical axis from the most object side lens surface to the most image side lens surface, of the first lens group) by the focal length of the zoom lens system at the wide-angle end state in order to downsize the zoom lens system. With satisfying the conditional expression (5-1), spherical aberration, coma and distortion can be corrected well, while downsizing the zoom lens system, and variation in curvature of field can be suppressed, so that superb imaging performance can be achieved.

When S1/fw is equal to or exceeds the upper limit value of the conditional expression (5-1), the total length and the diameter of the zoom lens system become large, so downsizing becomes difficult. If further downsizing of the zoom lens system is intended, it becomes difficult to correct spherical aberration well. This is not desirable. And further, variation in curvature of field is undesirably increased.

When S1/fw is equal to or falls below the lower limit value of the conditional expression (5-1), it becomes difficult to correct sufficiently off-axis coma as well as curvature of field, so this is not desirable.

Incidentally, in order to secure the effect of the fifth embodiment, it is preferable to set the upper limit value of the conditional expression (5-1) to 0.85. In order to further secure the effect of the fifth embodiment, it is more preferable to set the upper limit value to 0.80. In order to secure the effect of the fifth embodiment, it is preferable to set the lower limit value of conditional expression (5-1) to 0.60. Further, in order to secure the effect of the fifth embodiment, it is preferable to set the lower limit value to 0.70.

The conditional expression (5-2) defines a shape factor of a so-called air lens formed between a negative meniscus lens disposed at the most object side in the first lens group and a negative lens disposed at the image side of the negative meniscus lens, to a proper range. Incidentally, in the case where aspherical surfaces are formed on the image side lens surface of that negative meniscus lens and on the object side lens surface of the negative lens, the value of the conditional expression (5-2) is calculated using paraxial curvature radius. With satisfying the conditional expression (5-2), it is possible to make an F-number small, correct well distortion and maintain sufficient amount of marginal light rays at the wide angle end state, so high imaging performance can be attained.

When (r2F+r1R)/(r2F−r1R) is equal to or exceeds the upper limit value of the conditional expression (5-2), it becomes difficult to correct lateral chromatic aberration superbly, and therefore it is not desirable. Further, f-number of the zoom lens system becomes larger, so it is not desirable.

When (r2F+r1R)/(r2F−r1R) is equal to or falls below the lower limit value of the conditional expression (5-2), it becomes not possible to correct distortion sufficiently, so this is not desirable. Alternatively, it becomes difficult to maintain an amount of peripheral light rays at the wide angle end state. This is not desirable.

Incidentally, in order to secure the effect of the fifth embodiment, it is preferable to set the upper limit value of the conditional expression (5-2) to 1.50. In order to further secure the effect of the fifth embodiment, it is more preferable to set the upper limit value to 1.00. Further, in order to secure the effect of the fifth embodiment, it is preferable to set the lower limit value of the conditional expression (5-2) to 0.30. In order to secure the effect of the fifth embodiment further, it is preferable to set the lower limit value to 0.50.

By the above described configuration, according to the fifth embodiment, a downsized zoom lens system which can correct excellently various aberrations and has high imaging performance can be realized.

Further, in the zoom lens system according to the fifth embodiment, it is preferable that the first cemented lens has negative refractive power. With the first cemented lens having negative refractive power, as described above, aberrations such as spherical aberration or the like can be corrected well, and high optical performance can be attained.

Further, in the zoom lens system according to the fifth embodiment, it is preferable that the second cemented lens has positive refractive power.

With the second cemented lens having positive refractive power, as described above, aberrations such as spherical aberration or the like can be corrected well, and high optical performance can be attained.

Further, it is preferable that the zoom lens system according to the fifth embodiment satisfies the following conditional expression (5-3):

0.50<fL1/f1<1.00 (5-3)

where fL1 denotes a focal length of the negative meniscus lens of the first lens group, and f1 denotes a focal length of the first lens group.

The conditional expression (5-3) defines the focal length of the negative meniscus lens disposed at the most object side in the first lens group with the focal length of the first lens group. With satisfying the conditional expression (5-3), it becomes possible to effect downsizing and suppress variation in aberrations, and further it becomes possible to correct curvature of field, lateral chromatic aberration and spherical aberration excellently, thereby attaining high imaging performance.

When fL1/f1 is equal to or exceeds the upper limit value of the conditional expression (5-3), the focal length of the first lens group becomes small, and the refractive power of each lens of the first lens group becomes large, so that variation in aberrations caused by zooming becomes large, and it becomes difficult to correct sufficiently curvature of field as well as lateral chromatic aberration. This is not preferable.

On the other hand, when fL1/f1 is equal to or falls below the lower limit value of the conditional expression (5-3), movement amount of the first lens group upon zooming becomes large, and the entire length of the zoom lens system according to the fifth embodiment becomes large. This is undesirable. Alternatively, it becomes difficult to secure sufficient angle of view, so that it is not possible to secure zoom ratio. This is undesirable. Moreover, it becomes difficult to correct distortion well, so that this is not desirable.

Incidentally, in order to secure the effect of the fifth embodiment, it is preferable to set the upper limit value of the conditional expression (5-3) to 0.95. In order to further secure the effect of the fifth embodiment, it is more preferable to set the upper limit value to 0.90. Further, in order to secure the effect of the fifth embodiment, it is preferable to set the lower limit value of the conditional expression (5-3) to 0.55. Furthermore, in order to secure the effect of the fifth embodiment, it is preferable to set the lower limit value to 0.60.

Further, it is preferable that the zoom lens according to the fifth embodiment satisfies the following conditional expression (5-4):

−1.00≦(r1R−r1F)/(r1R+r1F)<−0.30 (5-4)

where r1F denotes a radius of curvature of the object side lens surface of the negative meniscus lens of the first lens group, and r1R denotes a radius of curvature of the image side lens surface of the negative meniscus lens of the first lens group.

The conditional expression (5-4) defines invertedly a shape factor of the negative meniscus lens disposed at the most object side of the first lens group. Incidentally, in the case where each surface of that negative meniscus lens is an aspherical surface, the values of the conditional expression (5-4) are calculated using paraxial radius of curvature. With satisfying the conditional expression (5-4), it is possible to correct well lateral chromatic aberration and distortion, and it is possible to make f-number small and attain high imaging performance.

When (r1R−r1F)/(r1R+r1F) of the conditional expression (5-4) is equal to or exceeds the upper limit value of the conditional expression (5-4), it becomes difficult to correct lateral chromatic aberration. This is not desirable. Moreover, the f-number of the zoom lens system becomes larger undesirably.

When (r1R−r1F)/(r1R+r1F) of the conditional expression (5-4) is equal to or falls below the lower limit value of the conditional expression (5-4), it becomes not possible to correct distortion sufficiently. This is not desirable.

Incidentally, in order to secure the effect of the fifth embodiment, it is preferable to set the upper limit value of the conditional expression (5-4) to −0.35. In order to further secure the effect of the fifth embodiment, it is more preferable to set the upper limit value to −0.40. Further, in order to secure the effect of the fifth embodiment, it is preferable to set the lower limit value of the conditional expression (5-4) to −0.85. In order to secure the effect of the fifth embodiment further, it is preferable to set the lower limit value to −0.75.

Further, it is preferable that the zoom lens according to the fifth embodiment satisfies the following conditional expression (5-5):

2.05<ndL1+0.009×νdL1 (5-5)

where ndL1 denotes a refractive index of the negative meniscus lens of the first lens group at d-line (wavelength λ=587.6 nm) and νdL1 denotes an Abbe number of the negative meniscus lens of the first lens group at d-line (λ=587.6 nm).

The conditional expression (5-5) defines a refractive index at the d-line (λ=587.6 nm) and an Abbe number of the negative meniscus lens included in the first lens group. With satisfying the conditional expression (5-5), increase in the aberrations of high order and curvature of field at the wide angle end state, can be prevented, so that high imaging performance can be attained.

When ndL1+0.009×νdL1 becomes below the lower limit value of the conditional expression (5-5), a curvature radius becomes excessively small, and aberrations of high order are increased. This is not desirable. Further, curvature of field at the wide angle end state, becomes deteriorated. This is not desirable.

Incidentally, in order to secure the effect of the fifth embodiment, it is preferable to set the lower limit value of the conditional expression (5-5) to 2.10. In order to further secure the effect of the fifth embodiment, it is more preferable to set the lower limit value to 2.15.

In the zoom lens system according to the fifth embodiment, it is preferable that the first cemented lens is composed of, in order from the object side, a cemented lens constructed by a positive lens cemented with a negative lens. With constructing the first cemented lens by the positive lens cemented with the negative lens, it is possible to correct aberrations such as spherical aberration as well as longitudinal chromatic aberration excellently, and attain a downsized zoom lens system having high imaging performance.

In the zoom lens system according to the fifth embodiment, it is preferable that the second cemented lens is composed of, in order from the object side, a negative lens and a positive lens cemented together. With composing the second cemented lens by the negative lens and the positive lens cemented together, it is possible to correct excellently aberrations such as spherical aberration and longitudinal chromatic aberration, and attain a downsized zoom lens system having high imaging performance.

It is preferable that the zoom lens system according to the fifth embodiment includes an aperture stop, and the aperture stop is disposed at a more image plane side than a most image side lens surface of the first lens group. With such a configuration, the zoom lens system according to the fifth embodiment can correct superbly off-axis aberrations such as coma and achieve high imaging performance. Incidentally, it is more preferable that the aperture stop is disposed at the object side of the second lens group. With such a configuration, the zoom lens system according to the fifth embodiment can correct superbly off-axis aberrations such as coma and can achieve high imaging performance.

Further, it is preferable that in the zoom lens system according to the fifth embodiment, focusing from an infinitely distant object to a close distant object is carried out by moving the entire first lens group, thereby the zoom lens system according to the fifth embodiment being made compact in size.

In the zoom lens system according to the fifth embodiment, it is preferable that a parallel plane glass is disposed at the object side of the most object side lens surface of the first lens group.

With taking such a configuration, it is possible to protect the most image side lens surface of the first lens group from dust as well as contamination.

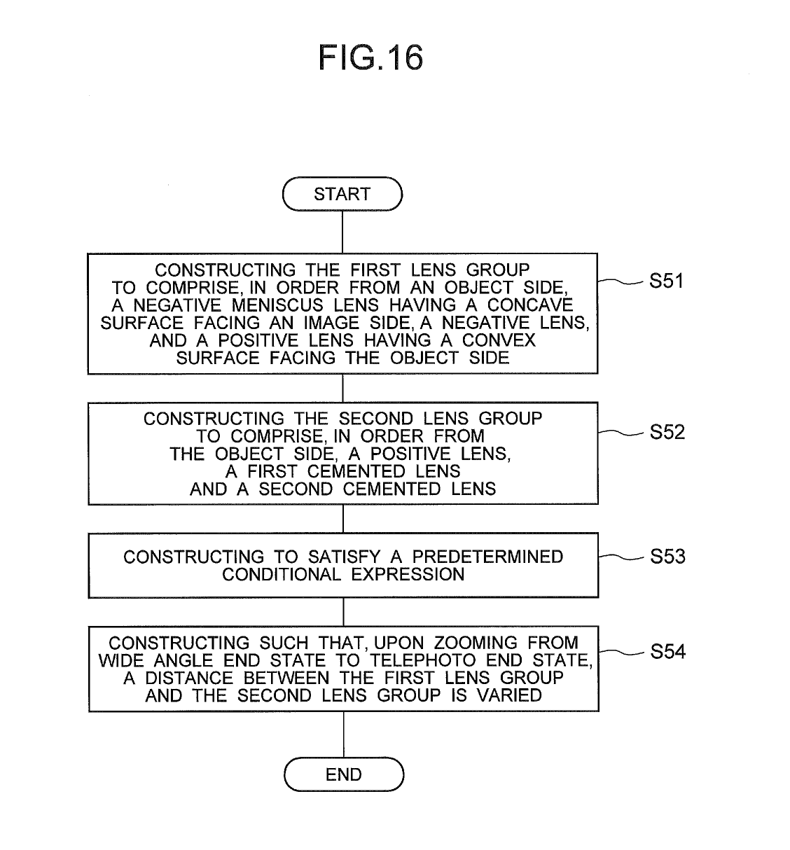

Next, a method for manufacturing the zoom lens system according to the fifth embodiment, will be explained with reference to FIG. 16.

The method for manufacturing the zoom lens system shown in FIG. 16 is a method for manufacturing a zoom lens system comprising, in order from the object side, a first lens group having negative refractive power and a second lens group having positive refractive power, the method comprising the following steps S51-S54:

(Step S51)

Constructing the first lens group to comprise, in order from the object side, a negative meniscus lens having a concave surface facing an image plane side, a negative lens and a positive lens having a convex surface facing the object side.

(Step S52)

Constructing the second lens group to comprise, in order from the object side, a positive lens, a first cemented lens and a second cemented lens.

(Step S53)

Constructing the zoom lens system such that the following conditional expressions (5-1) and (5-2) are satisfied;

0.50<S1/fw<0.88 (5-1)

0.00<(r2F+r1R)/(r2F−r1R)<2.00 (5-2)

where S1 denotes a distance along the optical axis from a most object side lens surface to a most image side lens surface, of the first lens group, fw denotes a focal length of the zoom lens system at the wide-angle end state, r1R denotes a radius of curvature of the image side lens surface of the negative meniscus lens of the first lens group, and r2F denotes a radius of curvature of the object side lens surface of the negative lens of the first lens group.

(Step S54)

Disposing, in order from the object side, the first lens group and the second lens group in a lens barrel, and constructing the zoom lens system such that a distance between the first lens group and the second lens group is varied upon zooming from a wide-angle end state to a telephoto end state, by providing a known movement mechanism.

According to the method for manufacturing the zoom lens system of the present fifth embodiment, it is possible to manufacture a downsized zoom lens system which can suppress variation in aberrations upon zooming and has high imaging performance from the wide-angle end state to the telephoto end state.

### Sixth Embodiment

The zoom lens system according to the sixth embodiment comprises, in order from an object side, a first lens group having negative refractive power and a second lens group having positive refractive power; upon zooming from a wide-angle end state to a telephoto end state, a distance between the first lens group and the second lens group being varied; the first lens group comprising, in order from the object side, a negative meniscus lens having a concave surface facing an image plane side, a negative lens and a positive lens having a convex surface facing the object side; the second lens group comprising, in order from the object side, a positive lens, a first cemented lens and a second cemented lens.

The zoom lens system according to the sixth embodiment, can be downsized while correcting aberrations excellently by constructing the first lens group and the second lens group as above described. Further, each lens group can be composed by less number of lenses, and deterioration in imaging performance caused by positioning error upon assembling can be suppressed.

In the zoom lens system according to the sixth embodiment, the first lens group having negative refractive power is configured as above, thereby aberrations being corrected well and downsizing of the system becoming possible. Further, the first lens group can be composed by less number of lenses, and manufacturing error can be suppressed.

Further, the zoom lens according to the sixth embodiment satisfies the following conditional expressions (6-1) and (6-2):

0.20<S1/(fw×ft)^{1/2}<0.70 (6-1)

0.50<S2/(fw×ft)^{1/2}<1.00 (6-2)

where S1 denotes a distance along the optical axis from a most object side lens surface to a most image side surface, of the first lens group, S2 denotes a distance along the optical axis from a most object side lens surface to a most image side lens surface, of the second lens group, fw denotes a focal length of the zoom lens system at the wide-angle end state, and ft denotes a focal length of the zoom lens system at the telephoto end state.

The conditional expression (6-1) defines, in order to downsize the zoom lens system, the total thickness of the first lens group (the distance along the optical axis from the most object side lens surface to the most image side lens surface of the first lens group) by the intermediate focal length of the entire zoom lens system. With satisfying the conditional expression (6-1), it is possible to correct excellently spherical aberration as well as coma, while downsizing the zoom lens system, and superb imaging performance can be achieved.

When S1/(fw×ft)^{1/2} is equal to or exceeds the upper limit value of the conditional expression (6-1), the total thickness and the diameter of the first lens group become large, so the optical system is apt to become larger. If downsizing is intended, it becomes difficult to correct spherical aberration well, so it is not desirable. Further, it is not desirable either, since variation in curvature of field is increased.

When S1/(fw×ft)^{1/2} is equal to or falls below the lower limit value of the conditional expression (6-1), it becomes difficult to correct sufficiently off-axis coma as well as distortion, so it is not desirable.

Incidentally, in order to secure the effect of the sixth embodiment, it is preferable to set the upper limit value of the conditional expression (6-1) to 0.65. In order to further secure the effect of the sixth embodiment, it is more preferable to set the upper limit value to 0.60. In order to further secure the effect of the sixth embodiment, it is preferable to set the lower limit value to 0.30. Furthermore, in order to secure the effect of the sixth embodiment, it is preferable to set the lower limit value to 0.40.

The conditional expression (6-2) defines, in order to downsize the zoom lens system, the total thickness of the second lens group (the distance along the optical axis from the most object side lens surface to the most image side lens surface, of the second lens group) by the intermediate focal length of the entire zoom lens system. With satisfying the conditional expression (6-2), spherical aberration as well as coma can be corrected well, while downsizing the zoom lens system, and superb imaging performance can be achieved.

When S2/(fw×ft)^{1/2} is equal to or exceeds the upper limit value of the conditional expression (6-2), the total thickness of the second lens group becomes large, and if the total thickness of the first lens group is made thin in order to effect downsizing, it is not possible to correct excellently chromatic aberration and distortion.

When S2/(fw×ft)^{1/2} is equal to or falls below the lower limit value of the conditional expression (6-2), it becomes difficult to correct sufficiently spherical aberration as well as coma, so it is not desirable.

Incidentally, in order to secure the effect of the sixth embodiment, it is preferable to set the upper limit of the conditional expression (6-2) to 0.95. In order to further secure the effect of the sixth embodiment, it is more preferable to set the upper limit value to 0.85. In order to further secure the effect of the sixth embodiment, it is preferable to set the lower limit value of the conditional expression (6-2) to 0.55. Moreover, In order to secure the effect of the sixth embodiment, it is preferable to set the lower limit value to 0.60.

With the above described configuration, according to the sixth embodiment, it is possible to realize a zoom lens system that is compact in size, correct well various aberrations and has high imaging performance.

In the zoom lens system according to the sixth embodiment, it is preferable that the first cemented lens has negative refractive power. With the first cemented lens having negative refractive power, it is possible to correct aberrations such as spherical aberration excellently, and attain high imaging performance.

In the zoom lens system according to the sixth embodiment, it is preferable that the second cemented lens has positive refractive power. With the second cemented lens having positive refractive power, it is possible to correct aberrations such as spherical aberration excellently, and attain high imaging performance.

Further, it is preferable that the zoom lens according to the sixth embodiment satisfies the following conditional expression (6-3):

1.00<(−f1)/S1<3.00 (6-3)

where f1 denotes a focal length of the first lens group, and S1 denotes a distance along the optical axis from a most object side lens surface to a most image side lens surface of the first lens group.

The conditional expression (6-3) defines a proper range of the focal length of the first lens group having negative refractive power by the total thickness of the first lens group (the distance along the optical axis from the most object side lens surface to the most image side lens surface of the first lens group). With satisfying the conditional expression (6-3), it is possible to downsize the zoom lens system and correct well distortion, spherical aberration and coma and obtain a well balanced lateral chromatic aberration, so high imaging performance can be achieved.

When (−f1)/S1 is equal to or exceeds the upper limit value of the conditional expression (6-3), the total thickness of the first lens group becomes too small, so that negative distortion at the wide angle end state is increased, and balanced lateral chromatic aberration can not be attained. Therefore, it is not desirable.

When (−f1)/S1 is equal to or falls below the lower limit value of the conditional expression (6-3), the total thickness of the first lens group becomes large, so that it becomes necessary to make the thickness of the second lens group small so as to effect downsizing. Therefore, it becomes difficult to correct superbly spherical aberration as well as coma. It is not desirable.

Incidentally, in order to secure the effect of the sixth embodiment, it is preferable to set the upper limit value of the conditional expression (6-3) to 2.80. In order to further secure the effect of the sixth embodiment, it is more preferable to set the upper limit value to 2.50. Further, in order to achieve further the effect of the sixth embodiment, it is preferable to set the lower limit value of the conditional expression (6-3) to 1.30. In order to achieve further the effect of the sixth embodiment, it is preferable to set the lower limit value to 1.60.

Further, it is preferable that the zoom lens system according to the sixth embodiment satisfies the following conditional expression (6-4):

0.20<fL1/fL2<0.50 (6-4)

where fL1 denotes a focal length of the negative meniscus lens of the first lens group, and fL2 denotes a focal length of the negative lens of the first lens group.

The conditional expression (6-4) defines a proper power balance between the negative lenses for securing superb imaging performance, while downsizing the first lens group. With satisfying the conditional expression (6-4), it is possible to attain a downsized zoom lens system correcting well off-axis aberrations such as lateral chromatic aberration as well as lower coma, preventing marginal light rays from decreasing and achieving high imaging performance.

When fL1/fL2 is equal to or exceeds the upper limit value of the conditional expression (6-4), the negative meniscus lens of the first lens group has small refractive power, and it becomes difficult to correct off-axis aberrations such as coma or the like. Furthermore, amount of marginal light is decreased, so it is not desirable.

When fL1/fL2 is equal to or falls below the lower limit value of the conditional expression (6-4), the negative meniscus lens of the first lens group has large negative refractive power, and it becomes difficult to correct lateral chromatic aberration, so it is not desirable.

Incidentally, in order to secure the effect of the sixth embodiment, it is preferable to set the upper limit value of the conditional expression (6-4) to 0.45. In order to further secure the effect of the sixth embodiment, it is more preferable to set the upper limit value to 0.40. Further, in order to achieve further the effect of the sixth embodiment, it is preferable to set the lower limit value to 0.22. In order to achieve further the effect of the sixth embodiment, it is preferable to set the lower limit value of the conditional expression (6-4) to 0.24.

Further, it is preferable that the zoom lens system according to the sixth embodiment satisfies the following conditional expression (6-5):

−2.00<(r2R+r2F)/(r2R−r2F)≦0.00 (6-5)

where r2F denotes a radius of curvature of the object side lens surface of the negative lens of the first lens group, and r2R denotes a radius of curvature of the image side lens surface of the negative lens of the first lens group.

The conditional expression (6-5) defines a shape factor of the negative lens disposed in the first lens group. Incidentally, in the case where each surface of the negative lens is an aspherical surface, the value of the conditional expression (6-5) is calculated using paraxial radius of curvature. With satisfying the conditional expression (6-5), while downsizing, it is possible to correct distortion excellently. Further, it is possible to maintain proper Petzval sum and achieve high imaging performance.

When (r2R+r2F)/(r2R−r2F) is equal to or exceeds the upper limit value of the conditional expression (6-5), it is difficult to correct distortion superbly, and therefore it is not desirable.

When (r2R+r2F)/(r2R−r2F) is equal to or falls below the lower limit value of the conditional expression (6-5), refractive power of the negative lens is too large and it is difficult to maintain proper Petzval sum. Therefore, it is not desirable. Alternatively, if a distance between the negative lens and the positive lens disposed at the image side of the negative lens is not made larger, it is not possible to maintain superb imaging performance, so that the zoom lens becomes large in size.

Incidentally, in order to secure the effect of the sixth embodiment, it is preferable to set the upper limit value of the conditional expression (6-5) to −0.05. In order to further secure the effect, it is more preferable to set the upper limit value to −0.08. Further, in order to secure further the effect of the sixth embodiment, it is preferable to set the lower limit value of the conditional expression to −1.70. In order to secure further the effect of the sixth embodiment, it is preferable to set the lower limit value to −1.30.

Further, it is preferable that the zoom lens system according to the sixth embodiment satisfies the following conditional expressions (6-6) and (6-7):

ndL2<1.62 (6-6)

62.00<νdL2 (6-7)

where ndL2 denotes a refractive index of the negative lens of the first lens group at d-line (wavelength λ=587.6 nm), and νdL2 denotes an Abbe number of the negative lens of the first lens group at d-line (λ=587.6 nm).

The conditional expression (6-6) defines a refractive index of the negative lens of the first lens group at d-line (λ=587.6 nm). With satisfying the conditional expression (6-6), it is possible to correct curvature of field excellently.

When ndL2 is equal to or exceeds the upper limit value of the conditional expression (6-6), curvature of field become worse, and therefore it is not desirable.

Incidentally, in order to secure the effect of the sixth embodiment, it is preferable to set the upper limit value of the conditional expression (6-6) to 1.61. In order to further secure the effect of the sixth embodiment, it is more preferable to set the upper limit value of the conditional expression (6-6) to 1.60.

The conditional expression (6-7) defines a proper range of Abbe number of the negative lens of the first lens group at d-line (λ=587.6 nm). With satisfying the range of the conditional expression (6-7), it is possible to correct chromatic aberration excellently.

When νdL2 is equal to or falls below the lower limit value of the conditional expression (6-7), it becomes difficult to correct chromatic aberration sufficiently, so this is not desirable.

Incidentally, in order to secure the effect of the sixth embodiment, it is preferable to set the lower limit value of the conditional expression (6-7) to 64.00. In order to further secure the effect of the sixth embodiment, it is more preferable to set the lower limit value of the conditional expression (6-7) to 66.00.

With the lower limit value being 72.00, Petzval sum becomes high, and the sixth embodiment becomes most effective.

In the zoom lens system according to the sixth embodiment, it is preferable that the first cemented lens is composed of, in order from the object side, a positive lens cemented with a negative lens. With constructing the first cemented lens by the positive lens cemented with the negative lens, aberrations such as spherical aberration as well as longitudinal chromatic aberration can excellently corrected, and a downsized zoom lens system having high imaging performance can be attained.

In the zoom lens system according to the sixth embodiment, it is preferable that the second cemented lens is composed of, in order from the object side, a negative lens and a positive lens cemented together. With composing the second cemented lens by the negative lens and the positive lens cemented together, it is possible to correct excellently aberrations such as spherical aberration and longitudinal chromatic aberration, and a downsized zoom lens system having high imaging performance can be attained.

It is preferable that the zoom lens system according to the sixth embodiment includes an aperture stop, and the aperture stop is disposed at a more image plane side than a most image side lens surface of the first lens group. With such a configuration, the zoom lens system according to the sixth embodiment can correct superbly off-axis aberrations such as coma and achieve high imaging performance. Incidentally, it is preferable that the aperture stop is disposed at the object side of the second lens group. With such a configuration, the zoom lens system according to the sixth embodiment can correct superbly off-axis aberrations such as coma and can achieve high imaging performance.

Further, it is preferable that in the zoom lens system according to the sixth embodiment, focusing from an infinitely distant object to a close distant object is carried out by moving the entire first lens group, thereby the zoom lens system according to the sixth embodiment being able to be made compact in size.

In the zoom lens system according to the sixth embodiment, it is preferable that a parallel plane glass is disposed at the object side of the most object side lens surface of the first lens group.

With taking such a configuration, it is possible to protect the most image side lens surface of the first lens group from dust as well as contamination.

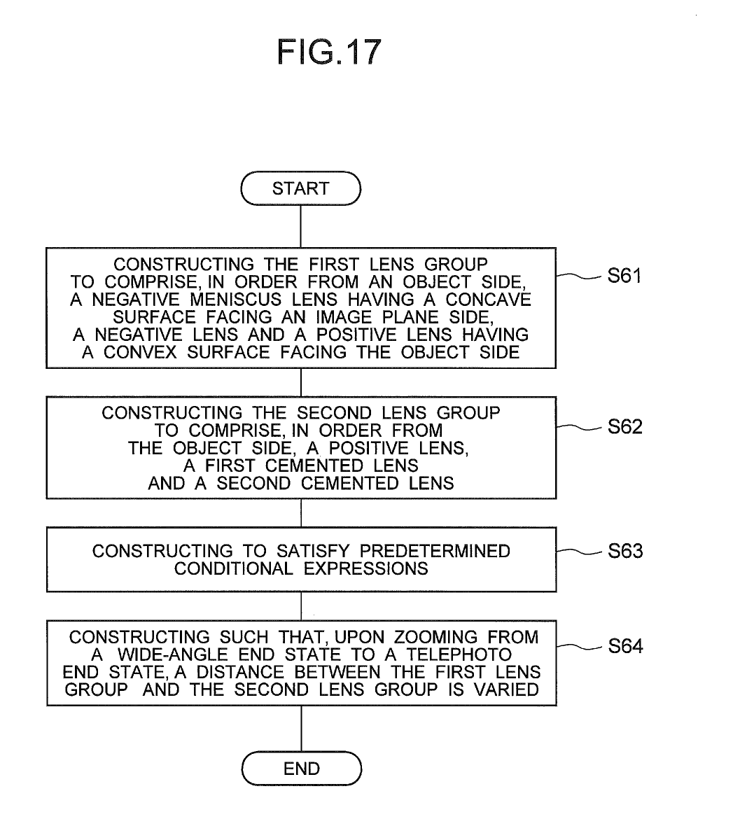

Next, a method for manufacturing the zoom lens system according to the sixth embodiment, will be explained with reference to FIG. 17.

A method for manufacturing the zoom lens system shown in FIG. 17 is a method for manufacturing a zoom lens system comprising, in order from the object side, a first lens group having negative refractive power and a second lens group having positive refractive power, the method comprising the following steps S61-S64:

(Step S61)

Constructing the first lens group to comprise, in order from the object side, a negative meniscus lens having a concave surface facing an image plane side, a negative lens and a positive lens having a convex surface facing the object side.

(Step S62)

Constructing the second lens group to comprise, in order from the object side, a positive lens, a first cemented lens and a second cemented lens.

(Step S63)

Constructing the zoom lens system such that the following conditional expressions (6-1) and (6-2) are satisfied;

0.20<S1/(fw×ft)^{1/2}<0.70 (6-1)

0.50<S2/(fw×ft)^{1/2}<1.00 (6-2)

where S1 denotes a distance along the optical axis from a most object side lens surface to a most image side surface, of the first lens group, S2 denotes a distance along the optical axis from a most object side lens surface to a most image side lens surface, of the second lens group, fw denotes a focal length of the zoom lens system at the wide-angle end state, and ft denotes a focal length of the zoom lens system at the telephoto end state.

(Step S64)

Disposing, in order from the object side, the first lens group and the second lens group in a lens barrel, and constructing the zoom lens system such that a distance between the first lens group and the second lens group is varied upon zooming from a wide-angle end state to a telephoto end state, by providing a known movement mechanism.

According to the method for manufacturing the zoom lens system of the present sixth embodiment, it is possible to manufacture a downsized zoom lens system which can suppress variation in aberrations upon zooming and has high imaging performance from the wide-angle end state to the telephoto end state.

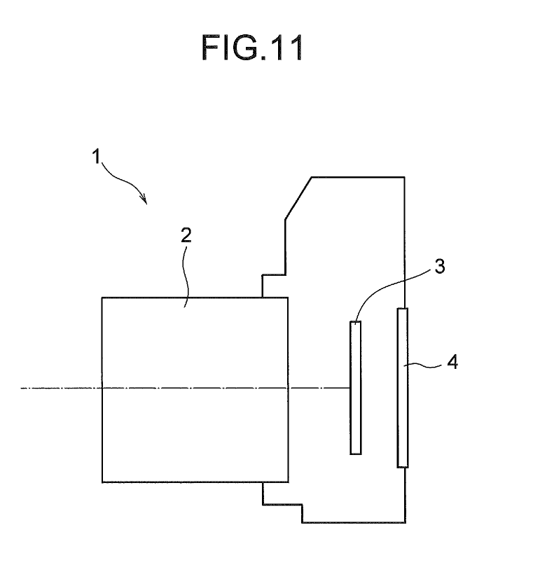

Then, a camera, which is equipped with the zoom lens system relating to the first example that is common to the first to the sixth embodiments of the present application, is explained, with reference to FIG. 11.

A camera 1 is a lens interchangeable type so-called mirror-less camera equipped with the zoom lens system according to the first Example of the present application, that system will be described herein later as an imaging lens 2, as shown in FIG. 11.

In the camera 1, light emitted from an unillustrated object (an object to be imaged) is converged by the imaging lens 2, and forms an image of the object to be imaged on an imaging plane of an imaging part 3 through an LPF (optical low pass filter) in the imaging lens 2. The image of the object to be imaged is photo-electronically converted through a photo-electronic conversion element provided in the imaging part 3 to form an object image. This object image is displayed on an EVF (electronic view finder) 4. Thus, a photographer can observe the object image through EVF 4.

When the photographer presses an unillustrated release button, the object image photo-electronically converted through the imaging part 3 is stored in an unillustrated memory. Thus, the photographer can take a picture of the object to be imaged by the camera 1.

The zoom lens system according to the first embodiment mounted on the camera 1 as the imaging lens 2, is a zoom lens system which, while being compact in size, can correct various aberrations excellently and achieve high imaging performance. Accordingly, the camera 1 can realize downsizing and high optical performance. Incidentally, even if the camera is so composed that the zoom lens system according to the second to fifth examples is mounted on the camera as the imaging lens 2, the same effect can be attained as the camera 1. Moreover, although the present embodiment was explained herein above for the mirror-less camera as an example, the same effect as the above camera 1 is attained even in the case where the zoom lens system according to each example as described, is mounted on a single lens reflex-type camera whose camera body is provided with a quick return mirror and in which an object to be imaged is observed through a finder optical system.

Hereinafter, the zoom lens systems of the numerical examples according to the 1st to 6th embodiments of the present application will be explained with reference to the accompanying drawings. Meanwhile, the zoom lens systems of the examples 1-5 are common to all the first to the sixth embodiments.

### First Example

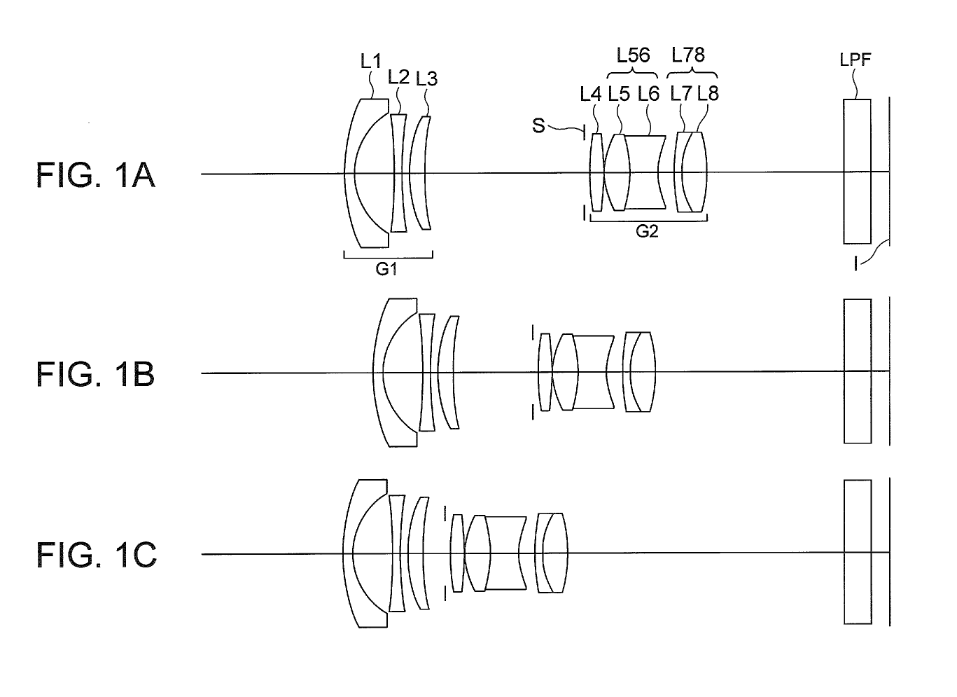

FIGS. 1A, 1B and 1C are sectional views showing a lens configuration of a zoom lens system according to a first example in which FIG. 1A shows in a wide-angle end state, FIG. 1B shows in an intermediate focal length state and FIG. 1C shows in a telephoto end state.

A zoom lens system according to the present example is composed of, in order from an object side, a first lens group G1 having negative refractive power and a second lens group G2 having positive refractive power.

The first lens group G1 consists of, in order from the object side, a negative meniscus lens L1 having a convex surface facing an object side, a double concave negative lens L2, and a positive meniscus lens L3 having a convex surface facing the object side.

The second lens group G2 consists of, in order from the object side, a double convex positive lens L4, a negative cemented lens L56 constructed by a double convex positive lens L5 cemented with a double concave negative lens L6, and a positive cemented lens L78 constructed by a negative meniscus lens L7 having a concave surface facing the image side cemented with a double convex positive lens L8.

In the zoom lens system of the present example, an aperture stop S is disposed between the first lens group G1 and the second lens group G2. Between the second lens group G2 and the image plane I a low-pass filter LPF is disposed. The low-pass filter LPF is for cutting a space frequency that exceeds a resolution limit of a solid state imaging device such as CCD disposed on the image plane.

The zoom lens system according to the present example carries out zooming from the wide angle end state to the telephoto end state by moving the first lens group G1 and the second lens group G2 in the direction of the optical axis such that a distance between the first lens group G1 and the second lens group G2 is varied. At this time, the aperture stop S is moved in the direction of the optical axis together with the second lens group G2, and the position of the low-pass filter LPF in the direction of the optical axis is fixed.

In the zoom lens system according to the present example, the entire first lens group G1 as a focusing lens group is moved in the direction of the optical axis to carry out focusing from an infinitely distant object to a closely distant object.

Various values associated with the zoom lens system according to the present example are listed in Table 1 below.

In Table 1, “f” denotes a focal length, and “BF” denotes a back focal length (a distance from the most object side surface to the image plane I along the optical axis). In [Surface Data], “m” is the order of the optical surface counted from the object side, “r” denotes a radius of curvature, “d” denotes a distance to the next surface (an interval between an n-th surface (n is an integer) and an (n+1)-th surface), “nd” denotes refractive index at d-line (λ=587.6 nm), and “νd” denotes Abbe number at d-line (λ=587.6 nm). “OP” shows an object surface, and “I”

shows the image plane. Incidentally, r=∞ denotes a plane surface. An aspherical surface is expressed by attaching “*” to the surface number. In the column of the radius of curvature “r” of the aspherical surface, paraxial radius of curvature is shown.

In [Aspherical Data], regarding the aspherical surface shown in the [Surface Data], aspherical surface coefficients and a conic coefficient in the case where the shape of the aspherical surface is exhibited by the following conditional expression are shown.

$$X ( y ) = {y}^{2} / [ r \times [ 1 + {( 1 - κ \times {y}^{2} / {r}^{2} )}^{1 / 2} ] ] + A 4 \times {y}^{4} + A 6 \times {y}^{6} + A 8 \times {y}^{8} + A 10 \times {y}^{10}$$

where “y” denotes a vertical height in the direction perpendicular to the optical axis, “X(y)” denotes a sag amount which is a distance along the optical axis from the tangent surface at the vertex of the aspherical surface to the aspherical surface at the vertical height y from the optical axis, “κ” denotes a conical coefficient, “A4”, “A6”, “A8” and “A10” denote aspherical coefficients and “r” denotes a radius of curvature of a reference sphere (a paraxial radius of curvature). [E−n] (n is integer) shows “×10⁻ⁿ”, and for example, “1.234E-05” shows “1.234×10⁻⁵”. An aspherical coefficient A2 of 2nd order is 0 and omitted.

In [various data], FNO denotes an F number, “2ω” denotes an angle of view (unit “degree”), TL denotes a total lens length (a distance along the optical axis from the first surface to the image plane I), ATL denotes an air converted value of the entire lens length of the zoom lens system, ABF denotes an air converted value of the back focal distance, and “dn” denotes a variable distance between the n-th surface and the (n+1)-th surface. Incidentally, W shows the wide angle end state, M shows the intermediate focal length state, and T shows the telephoto end state.

In [Lens Group Data], ST shows a start surface of each lens group, that is, a most object side lens surface in each lens group.

In [Values for Conditional Expressions], values for each conditional expressions are shown. It is noted here that “mm” is generally used for the unit of length such as the focal length “f”, the radius of curvature “r” and other unit for expressing length. However, since similar optical performance can be obtained by an optical system proportionally enlarged or reduced its dimension, the unit is not necessarily to be limited to “mm”, and any other suitable unit can be used. The explanation of reference symbols in Table 1 as described above, is the same in Tables of the other Examples described hereinafter.

TABLE 1
First Example
[Surface Data]

| m | r | d | nd | νd |
|---|---|---|---|---|
| OP | ∞ | | | |
| 1 | 21.1989 | 1.10 | 1.85135 | 40.10 |
| *2 | 7.5975 | 4.41 | 1.00000 | |
| 3 | −52.6643 | 0.80 | 1.49782 | 82.57 |
| 4 | 42.3237 | 0.84 | 1.00000 | |
| 5 | 15.6071 | 1.68 | 1.84666 | 23.78 |
| 6 | 32.7790 | d6 | 1.00000 | |
| 7 | ∞ | 0.65 | 1.00000 | Aperture stop S |
| 8 | 37.1408 | 1.47 | 1.65844 | 50.84 |
| 9 | −29.0801 | 0.10 | 1.00000 | |
| 10 | 9.6037 | 2.76 | 1.59319 | 67.90 |
| 11 | −14.5302 | 3.16 | 1.74400 | 44.81 |
| 12 | 9.7023 | 1.83 | 1.00000 | |
| 13 | 31.5814 | 0.80 | 1.90265 | 35.73 |
| 14 | 9.1997 | 2.75 | 1.58913 | 61.22 |
| 15 | −15.6188 | d15 | 1.00000 | |
| 16 | ∞ | 2.79 | 1.51680 | 63.88 |
| 17 | ∞ | 2.11 | 1.00000 | |
| I | ∞ | | | |

[Aspherical Surface Data]

| m | κ | A4 | A6 | A8 | A10 |
|---|---|---|---|---|---|
| 2 | 0.7566 | −3.95310E−07 | −6.33270E−08 | 1.17320E−09 | −1.39090E−10 |

[Various Data]
Zoom Ratio 2.35

| | W | M | T |
|---|---|---|---|
| f | 11.35 | 17.00 | 26.71 |
| FNO | 3.64 | 4.38 | 5.77 |
| 2ω | 73.6° | 51.2° | 33.4° |
| Y | 8.00 | 8.00 | 8.00 |
| TL | 59.8037 | 56.6351 | 59.8037 |
| ATL | 58.8531 | 55.6845 | 58.8531 |
| BF | 20.0378 | 25.5878 | 35.1214 |
| ABF | 19.0872 | 24.6372 | 34.1708 |
| d6 | 17.4158 | 8.6974 | 2.3323 |
| d15 | 15.1378 | 20.6878 | 30.2214 |

[Lens Group Data]

| | ST | f |
|---|---|---|
| G1 | 1 | −17.41 |
| G2 | 8 | 17.10 |

[Values for Conditional Expression]

(1-1) (−f1)/|fL56| = 0.151
(1-2) SL56/f2 = 0.346
(1-3) SB/S2 = 0.142
(1-4) f2/TLw = 0.286
(1-5) ndLi = 1.903 (L7)
(2-1) (r4R + r4F)/(r4R − r4F) = −0.122
(2-2) |fL78/fL56| = 0.267
(2-3) f2/S2 = 1.329
(2-4) ndLi = 1.903 (L7)
(3-1) f2/fw = 1.507
(3-2) S2/TLt = 0.215
(3-3) SA/r6R = 0.973
(3-4) f2/|fL56| = 0.149
(3-5) ndLi = 1.903 (L7)
(4-1) S2/TLw = 0.215
(4-2) f2/(fw × ft)^{1/2} = 0.982
(4-3) fL1/f1 = 0.830
(4-4) S1/TLw = 0.148
(4-5) ndLi = 1.903 (L7)
(5-1) S1/fw = 0.778
(5-2) (r2F + r1R)/(r2F − r1R) = 0.748
(5-3) fL1/f1 = 0.830
(5-4) (r1R − r1F)/(r1R + r1F) = −0.472
(5-5) ndL1 + 0.009 × νdL1 = 2.212
(6-1) S1/(fw × ft)^{1/2} = 0.507
(6-2) S2/(fw × ft)^{1/2} = 0.739
(6-3) (−f1)/S1 = 1.972
(6-4) fL1/fL2 = 0.307
(6-5) (r2R + r2F)/(r2R − r2F) = −0.109
(6-6) ndL2 = 1.498
(6-7) νdL2 = 82.57

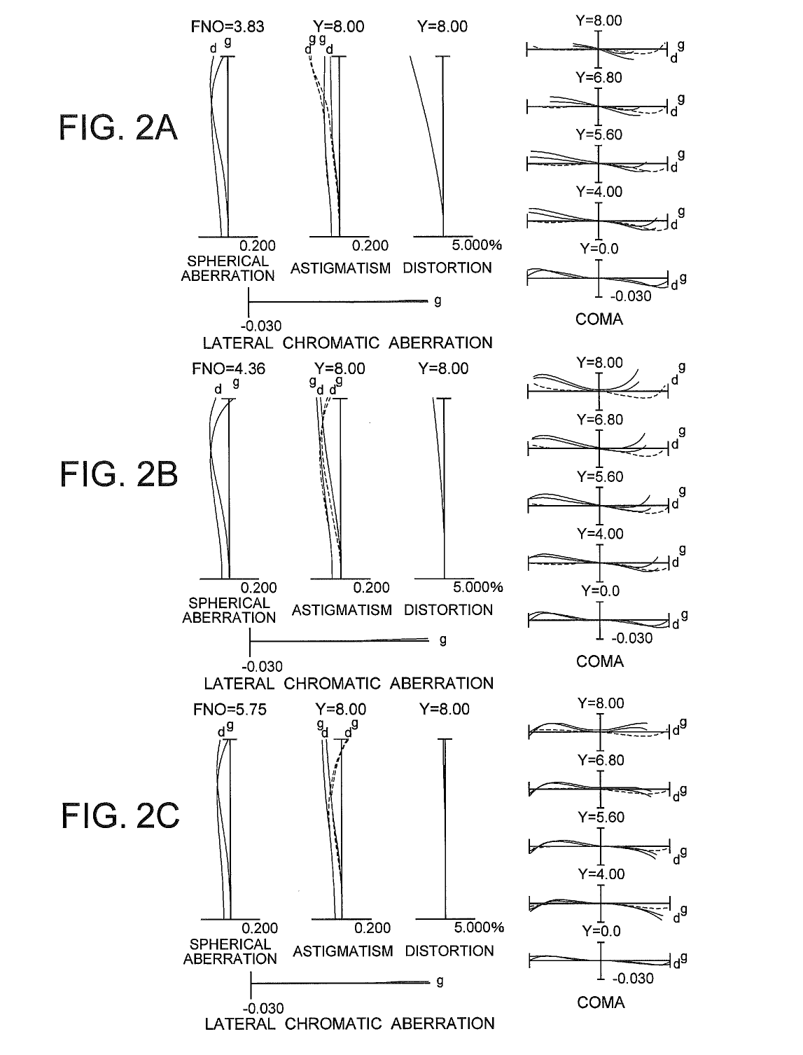

FIGS. 2A, 2B and 2C are graphs showing various aberrations of the zoom lens system according to the first Example upon focusing on infinity, in which FIG. 2A is in the wide-angle end state, FIG. 2B is in the intermediate focal length state and FIG. 2C is in the telephoto end state.

In respective graphs showing aberrations, FNO denotes an f-number, and Y denotes an image height. In graph showing the spherical aberration, an f number corresponding to the maximum aperture diameter is shown, in graphs showing astigmatism and distortion, value of the maximum image height is shown, and in graph showing coma value of each image height is shown. In graphs, d denotes an aberration curve at d-line (wavelength λ=587.6 nm), and g denotes an aberration curve at g-line (wavelength λ=435.8 nm). In graphs showing astigmatism, a solid line indicates a sagittal image plane, and a broken line indicates a meridional image plane. The explanations of reference symbols are the same in the other Examples.

As is apparent from various graphs, the zoom lens according to the present example corrects excellently various aberrations from the wide angle end state to the telephoto end state and has superb optical performance.

### Second Example

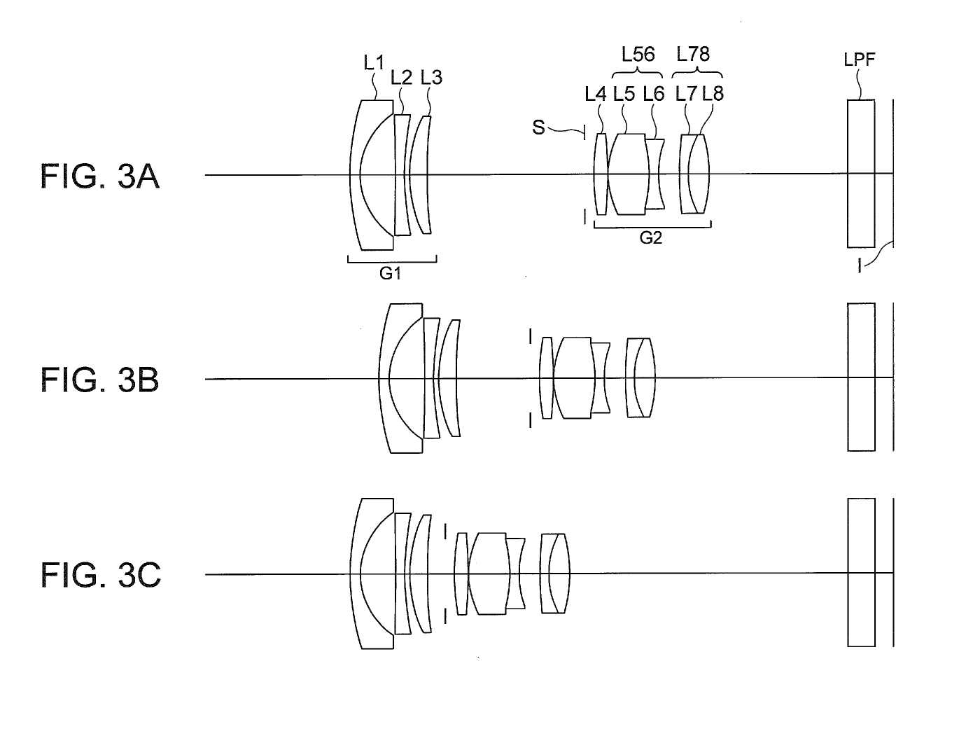

FIGS. 3A, 3B and 3C are sectional views showing a lens configuration of a zoom lens system according to a second example in which FIG. 3A shows in a wide-angle end state, FIG. 3B shows in an intermediate focal length state and FIG. 3C shows in a telephoto end state.

A zoom lens system according to the present example is composed of, in order from an object side, a first lens group G1 having negative refractive power and a second lens group G2 having positive refractive power.

The first lens group G1 consists of, in order from the object side, a negative meniscus lens L1 having a convex surface facing an object side, a double concave negative lens L2, and a positive meniscus lens L3 having a convex surface facing the object side.

The second lens group G2 consists of, in order from the object side, a double convex positive lens L4, a negative cemented lens L56 constructed by a double convex positive lens L5 cemented with a double concave negative lens L6 and a positive cemented lens L78 constructed by a negative meniscus lens L7 having a concave surface facing the image side cemented with a double convex positive lens L8.

In the zoom lens system of the present example, an aperture stop S is disposed between the first lens group G1 and the second lens group G2. Between the second lens group G2 and the image plane I a low-pass filter LPF is disposed.

The zoom lens system according to the present example carries out zooming from the wide angle end state to the telephoto end state by moving the first lens group G1 and the second lens group G2 in the direction of the optical axis such that a distance between the first lens group G1 and the second lens group G2 is varied. At this time, the aperture stop S is moved in the direction of the optical axis together with the second lens group G2, and the position of the low-pass filter LPF in the direction of the optical axis is fixed.

In the zoom lens system according to the present example, the whole first lens group G1 as a focusing lens group is moved in the direction of the optical axis to carry out focusing from an infinitely distant object to a closely distant object.

Various values associated with the zoom lens system according to the present example are listed in Table 2 below.

TABLE 2
Second Example
[Surface Data]

| m | r | d | nd | νd |
|---|---|---|---|---|
| OP | ∞ | | | |
| 1 | 27.6355 | 1.10 | 1.85135 | 40.10 |
| *2 | 7.6407 | 3.86 | 1.00000 | |
| 3 | −150.2962 | 1.00 | 1.59319 | 67.90 |
| 4 | 31.0526 | 0.55 | 1.00000 | |
| 5 | 15.2311 | 1.93 | 1.78472 | 25.64 |
| 6 | 55.6807 | d6 | 1.00000 | |
| 7 | ∞ | 1.00 | 1.00000 | Aperture stop S |
| 8 | 27.1591 | 1.47 | 1.69680 | 55.52 |
| 9 | −42.3201 | 0.10 | 1.00000 | |
| 10 | 9.7355 | 4.49 | 1.59319 | 67.90 |
| 11 | −14.9453 | 1.00 | 1.79952 | 42.09 |
| 12 | 9.9794 | 2.29 | 1.00000 | |
| 13 | 34.1656 | 1.00 | 1.95400 | 33.46 |
| 14 | 9.1459 | 2.31 | 1.65844 | 50.84 |
| 15 | −16.2105 | d15 | 1.00000 | |
| 16 | ∞ | 2.79 | 1.51680 | 63.88 |
| 17 | ∞ | 2.11 | 1.00000 | |
| I | ∞ | | | |

[Aspherical Surface Data]

| m | κ | A4 | A6 | A8 | A10 |
|---|---|---|---|---|---|
| 2 | 0.7876 | −2.07080E−05 | −6.78850E−07 | 6.59940E−09 | −3.36460E−10 |

[Various Data]
Zoom Ratio 2.35

| | W | M | T |
|---|---|---|---|
| f | 11.35 | 17.30 | 26.70 |
| FNO | 3.65 | 4.39 | 5.77 |
| 2ω | 75.1° | 51.6° | 34.3° |
| Y | 8.20 | 8.20 | 8.20 |
| TL | 59.6000 | 56.3856 | 59.6000 |
| ATL | 58.6494 | 55.4350 | 58.6494 |
| BF | 20.2437 | 26.1597 | 35.5059 |
| ABF | 19.2931 | 25.2091 | 34.5553 |
| d6 | 17.2621 | 8.1318 | 2.0000 |
| d15 | 15.3437 | 21.2597 | 30.6059 |

[Lens Group Data]

| | ST | f |
|---|---|---|
| G1 | 1 | −17.41 |
| G2 | 8 | 17.31 |

[Values for Conditional Expression]

(1-1) (−f1)/|fL56| = 0.255
(1-2) SL56/f2 = 0.317
(1-3) SB/S2 = 0.181
(1-4) f2/TLw = 0.290
(1-5) ndLi = 1.954 (L7)
(2-1) (r4R + r4F)/(r4R − r4F) = 0.218
(2-2) |fL78/fL56| = 0.404
(2-3) f2/S2 = 1.368
(2-4) ndLi = 1.954 (L7)
(3-1) f2/fw = 1.525
(3-2) S2/TLt = 0.212
(3-3) SA/r6R = 0.964
(3-4) f2/|fL56| = 0.254
(3-5) ndLi = 1.954 (L7)
(4-1) S2/TLw = 0.212
(4-2) f2/(fw × ft)^{1/2} = 0.994
(4-3) fL1/f1 = 0.731
(4-4) S1/TLw = 0.142
(4-5) ndLi = 1.954 (L7)
(5-1) S1/fw = 0.743
(5-2) (r2F + r1R)/(r2F − r1R) = 0.903
(5-3) fL1/f1 = 0.731
(5-4) (r1R − r1F)/(r1R + r1F) = −0.567
(5-5) ndL1 + 0.009 × νdL1 = 2.212
(6-1) Si/(fw × ft)^{1/2} = 0.485
(6-2) S2/(fw × ft)^{1/2} = 0.727
(6-3) (−f1)/S1 = 2.063
(6-4) fL1/fL2 = 0.294
(6-5) (r2R + r2F)/(r2R − r2F) = −0.658
(6-6) ndL2 = 1.593
(6-7) νdL2 = 67.90

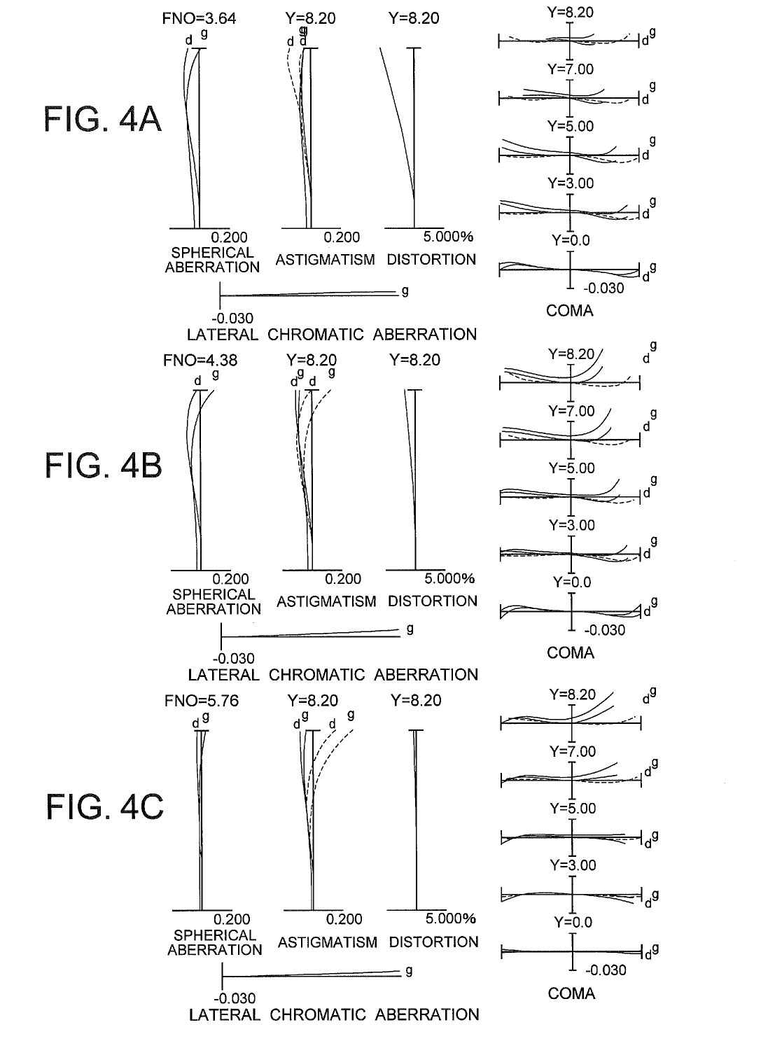

FIGS. 4A, 4B and 4C are graphs showing various aberrations of the zoom lens system according to the second Example upon focusing on infinity, in which FIG. 4A is in the wide-angle end state, FIG. 4B is in the intermediate focal length state and FIG. 4C is in the telephoto end state.

As is apparent from various graphs, the zoom lens according to the present example corrects excellently various aberrations from the wide angle end state to the telephoto end state and has superb optical performance.

### Third Example

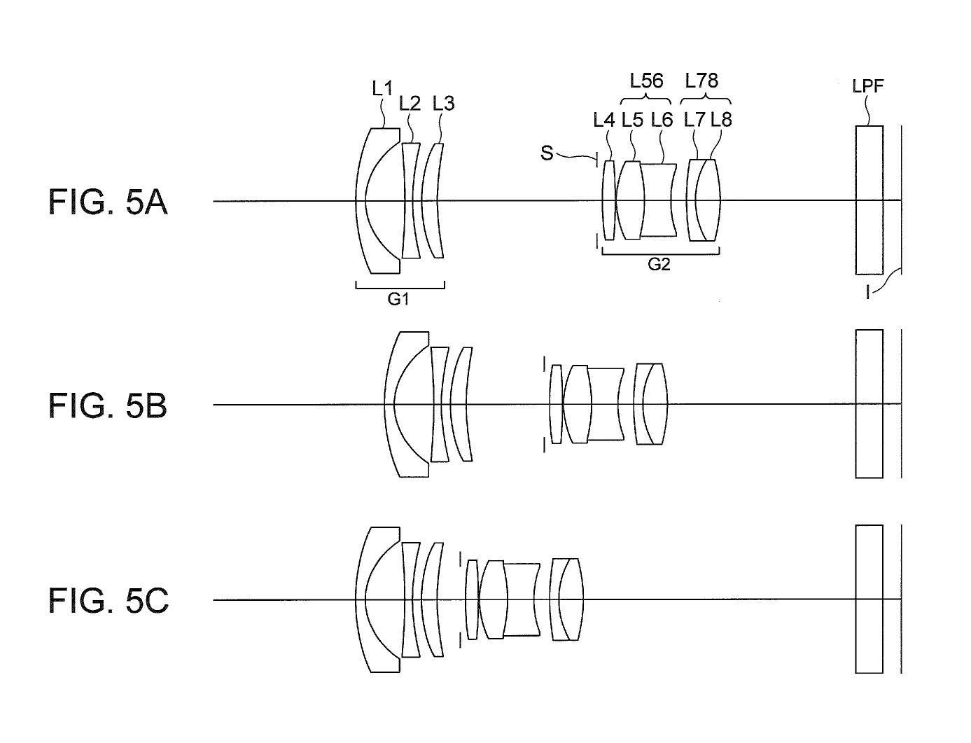

FIGS. 5A, 5B and 5C are sectional views showing a lens configuration of a zoom lens system according to a third example in which FIG. 5A shows in a wide-angle end state, FIG. 5B shows in an intermediate focal length state and FIG. 5C shows in a telephoto end state.

A zoom lens system according to the present example is composed of, in order from an object side, a first lens group G1 having negative refractive power and a second lens group G2 having positive refractive power.

The first lens group G1 consists of, in order from the object side, a negative meniscus lens L1 having a convex surface facing an object side, a double concave negative lens L2, and a positive meniscus lens L3 having a convex surface facing the object side.

The second lens group G2 consists of, in order from the object side, a double convex positive lens L4, a negative cemented lens L56 constructed by a double convex positive lens L5 cemented with a double concave negative lens L6, and a positive cemented lens L78 constructed by a negative meniscus lens L7 having a concave surface facing the image side cemented with a double convex positive lens L8.

In the zoom lens system of the present example, an aperture stop S is disposed between the first lens group G1 and the second lens group G2. Between the second lens group G2 and the image plane I a low-pass filter LPF is disposed.

The zoom lens system according to the present example carries out zooming from the wide angle end state to the telephoto end state by moving the first lens group G1 and the second lens group G2 in the direction of the optical axis such that a distance between the first lens group G1 and the second lens group G2 is varied. At this time, the aperture stop S is moved in the direction of the optical axis together with the second lens group, and the position of the low-pass filter LPF in the direction of the optical axis is fixed.

In the zoom lens system according to the present example, the entire first lens group G1 as a focusing lens group is moved in the direction of the optical axis to carry out focusing from an infinitely distant object to a closely distant object.

Various values associated with the zoom lens system according to the present example are listed in Table 3 below.

TABLE 3
Third Example
[Surface Data]

| m | r | d | nd | νd |
|---|---|---|---|---|
| OP | ∞ | | | |
| 1 | 20.9555 | 1.10 | 1.85135 | 40.14 |
| *2 | 7.6934 | 4.31 | 1.00000 | |
| 3 | −73.1411 | 0.84 | 1.49782 | 82.56 |
| 4 | 25.3734 | 1.02 | 1.00000 | |
| 5 | 15.7101 | 1.69 | 2.00069 | 25.47 |
| 6 | 31.1165 | d6 | 1.00000 | |
| 7 | ∞ | 0.65 | 1.00000 | (Aperture Stop S) |
| 8 | 40.2590 | 1.43 | 1.69680 | 55.52 |
| 9 | −31.7401 | 0.10 | 1.00000 | |
| 10 | 9.8087 | 3.12 | 1.59319 | 67.94 |
| 11 | −14.5256 | 2.80 | 1.74400 | 44.82 |
| 12 | 10.5639 | 1.73 | 1.00000 | |
| 13 | 27.6157 | 1.00 | 1.95000 | 29.39 |
| 14 | 8.6732 | 2.76 | 1.58267 | 46.46 |
| 15 | −15.6920 | d15 | 1.00000 | |
| 16 | ∞ | 2.79 | 1.51680 | 63.88 |
| 17 | ∞ | 2.11 | 1.00000 | |
| I | ∞ | | | |

[Aspherical Surface Data]

| m | κ | A4 | A6 | A8 | A10 |
|---|---|---|---|---|---|
| 2 | 0.1520 | 1.66840E−04 | 1.76430E−06 | −9.16880E−09 | 3.34540E−10 |

[Various Data]
Zoom Ratio 2.35

| | W | M | T |
|---|---|---|---|
| f | 11.35 | 17.30 | 26.70 |
| FNO | 3.64 | 4.57 | 5.80 |
| 2ω | 75.0° | 51.5° | 34.2° |
| Y | 8.20 | 8.20 | 8.20 |
| TL | 59.8881 | 56.7244 | 59.8834 |
| ATL | 58.9375 | 55.7738 | 58.9328 |
| BF | 19.9000 | 25.7174 | 34.9080 |
| ABF | 18.9494 | 24.7668 | 33.9574 |
| d6 | 17.4426 | 8.4614 | 2.4299 |
| d15 | 15.0000 | 20.8174 | 30.0080 |

[Lens Group Data]

| | ST | f |
|---|---|---|
| G1 | 1 | −17.41 |
| G2 | 8 | 17.02 |

[Values for Conditional Expression]

(1-1) (−f1)/|fL56| = 0.086
(1-2) SL56/f2 = 0.348
(1-3) SB/S2 = 0.134
(1-4) f2/TLw = 0.284
(1-5) ndLi = 1.950 (L7)
(2-1) (r4R + r4F)/(r4R − r4F) = −0.118
(2-2) |fL78/fL56| = 0.167
(2-3) f2/S2 = 1.315
(2-4) ndLi = 1.950 (L7)
(3-1) f2/fw = 1.500
(3-2) S2/TLt = 0.216
(3-3) SA/r6R = 1.075
(3-4) f2/|fL56| = 0.084
(3-5) ndLi = 1.950 (L7)
(4-1) S2/TLw = 0.216
(4-2) f2/(fw × ft)^{1/2} = 0.978
(4-3) fL1/f1 = 0.853
(4-4) S1/TLw = 0.150
(4-5) ndLi = 1.950 (L7)
(5-1) S1/fw = 0.789
(5-2) (r2F + r1R)/(r2F − r1R) = 0.810
(5-3) fL1/f1 = 0.853
(5-4) (r1R − r1F)/(r1R + r1F) = −0.463
(5-5) ndL1 + 0.009 × νdL1 = 2.213
(6-1) S1/(fw × ft)^{1/2} = 0.514
(6-2) S2/(fw × ft)^{1/2} = 0.743
(6-3) (−f1)/S1 = 1.944
(6-4) fL1/fL2 = 0.393
(6-5) (r2R + r2F)/(r2R − r2F) = −0.485
(6-6) ndL2 = 1.498
(6-7) νdL2 = 82.57

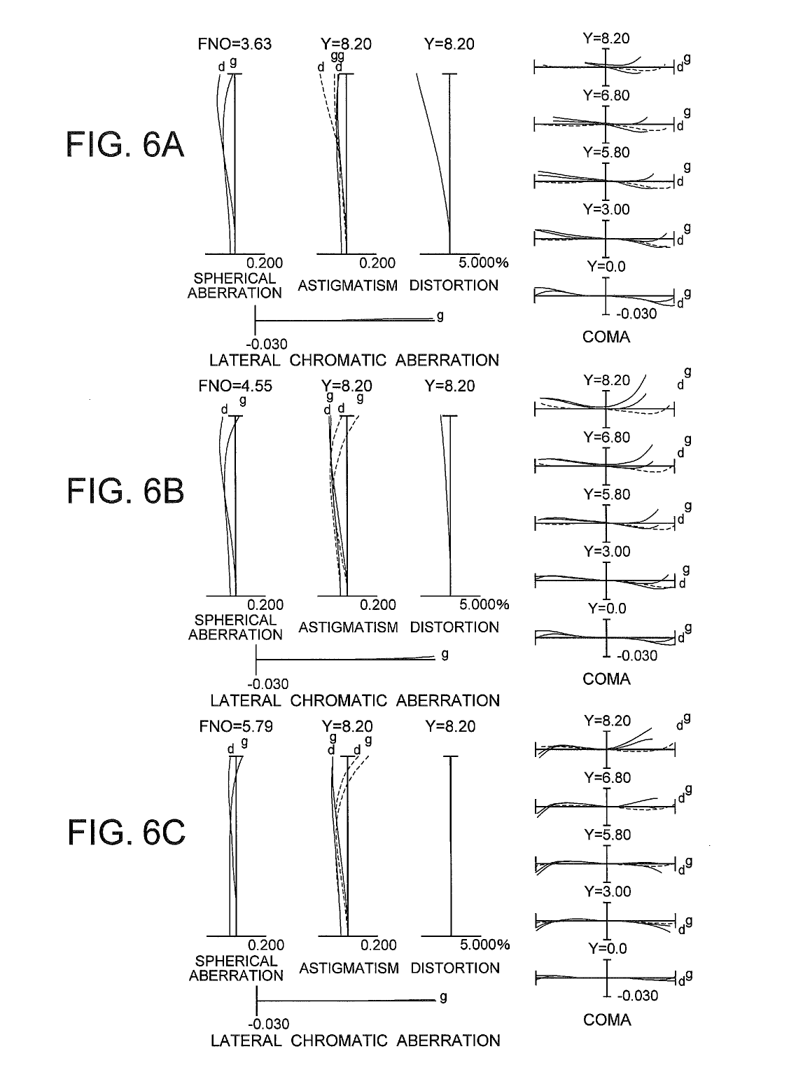

FIGS. 6A, 6B and 6C are graphs showing various aberrations of the zoom lens system according to the third Example upon focusing on infinity, in which FIG. 6A is in the wide-angle end state, FIG. 6B is in the intermediate focal length state and FIG. 6C is in the telephoto end state.

As is apparent from various graphs, the zoom lens according to the present example corrects excellently various aberrations from the wide angle end state to the telephoto end state and has superb optical performance.

### Fourth Example

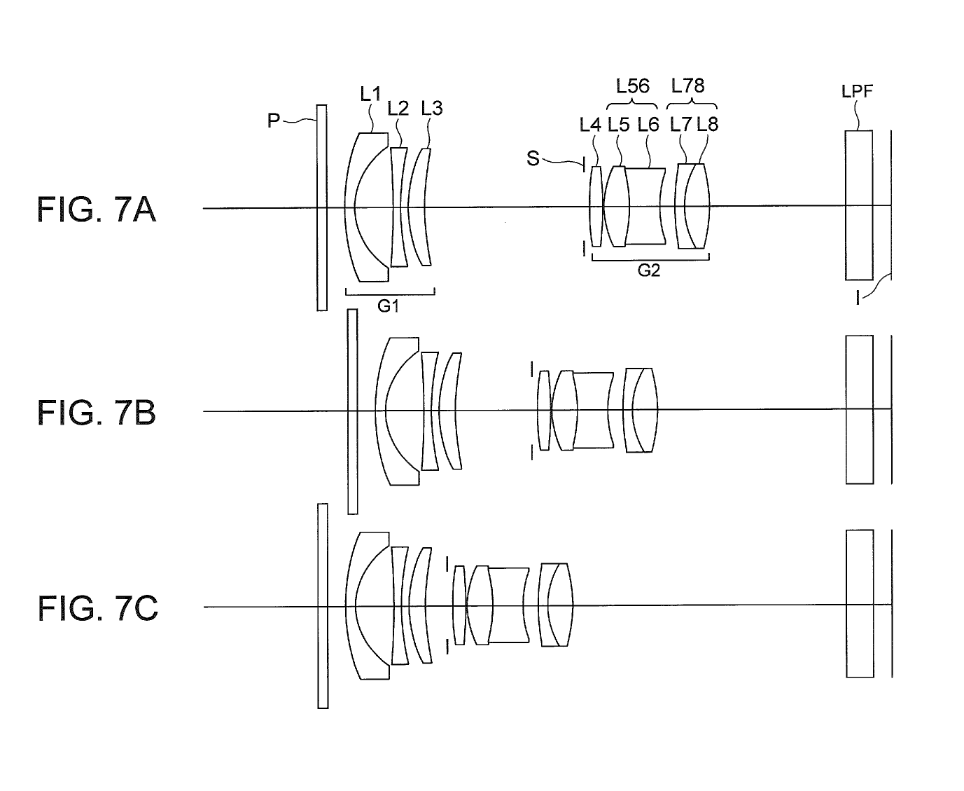

FIGS. 7A, 7B and 7C are sectional views showing a lens configuration of a zoom lens system according to a fourth example in which FIG. 7A shows in a wide-angle end state, FIG. 7B shows in an intermediate focal length state and FIG. 7C shows in a telephoto end state.

A zoom lens system according to the present example is composed of, in order from an object side, a first lens group G1 having negative refractive power and a second lens group G2 having positive refractive power.

The first lens group G1 consists of, in order from the object side, a negative meniscus lens L1 having a convex surface facing an object side, a double concave negative lens L2, and a positive meniscus lens L3 having a convex surface facing the object side.

The second lens group G2 consists of, in order from the object side, a double convex positive lens L4, a negative cemented lens L56 constructed by a double convex positive lens L5 cemented with a double concave negative lens L6, and a positive cemented lens L78 constructed by a negative meniscus lens L7 having a concave surface facing the image side cemented with a double convex positive lens L8.

In the zoom lens system according to the present example, a parallel plane plate P is disposed at the object side of the first lens group G1. By this parallel plane plate P, it is possible to protect the most object side lens surface in the first lens group G1. An aperture stop S is disposed between the first lens group G1 and the second lens group G2. A low-pass filter LPF is disposed between the second lens group G2 and the image plane I.

The zoom lens system according to the present example carries out zooming from the wide angle end state to the telephoto end state by moving the first lens group G1 and the second lens group G2 in the direction of the optical axis such that a distance between the first lens group G1 and the second lens group G2 is varied. At this time, the plain parallel plate P is moved in the direction of the optical axis together with the first lens group G1, and the aperture stop S is moved in the direction of the optical axis together with the second lens group G2, and the position of the low-pass filter LPF in the direction of the optical axis is fixed.

In the zoom lens system according to the present example, the whole first lens group G1 as a focusing lens group is moved in the direction of the optical axis to carry out focusing from an infinitely distant object to a closely distant object.

Various values associated with the zoom lens system according to the present example are listed in Table 4 below.

TABLE 4
Fourth Example
[Surface Data]

| m | r | d | nd | νd |
|---|---|---|---|---|
| OP | ∞ | | | |
| 1 | ∞ | 1.00 | 1.51680 | 63.88 |
| 2 | ∞ | 2.00 | 1.00000 | |
| 3 | 22.1410 | 1.10 | 1.85135 | 40.14 |
| *4 | 7.6618 | 4.23 | 1.00000 | |
| 5 | −97.7669 | 0.80 | 1.49782 | 82.57 |
| 6 | 29.9606 | 0.84 | 1.00000 | |
| 7 | 14.8029 | 1.77 | 1.84666 | 23.80 |
| 8 | 30.8037 | d8 | 1.00000 | |
| 9 | ∞ | 0.65 | 1.00000 | Aperture Stop S |
| 10 | 35.5510 | 1.46 | 1.63854 | 55.34 |
| 11 | −30.6717 | 0.10 | 1.00000 | |
| 12 | 9.6339 | 2.77 | 1.59319 | 67.90 |
| 13 | −15.0148 | 3.28 | 1.74400 | 44.80 |
| 14 | 9.8040 | 1.78 | 1.00000 | |
| 15 | 28.6661 | 1.00 | 1.90366 | 31.27 |
| 16 | 8.5586 | 2.77 | 1.61772 | 49.78 |
| 17 | −17.3121 | d17 | 1.00000 | |
| 18 | ∞ | 2.79 | 1.51680 | 63.88 |
| 19 | ∞ | 2.11 | 1.00000 | |
| I | ∞ | | | |

[Aspherical Surface Data]

| m | κ | A4 | A6 | A8 | A10 |
|---|---|---|---|---|---|
| 4 | 0.7721 | −7.96219E−06 | 8.08394E−08 | −3.39865E−09 | −1.43235E−10 |

[Various Data]
Zoom Ratio 2.35

| | W | M | T |
|---|---|---|---|
| f | 11.35 | 17.40 | 26.71 |
| FNO | 3.63 | 4.56 | 5.77 |
| 2ω | 75.0° | 51.4° | 34.2° |
| Y | 8.19 | 8.19 | 8.19 |
| TL | 59.9000 | 56.7320 | 59.9056 |
| ATL | 58.9494 | 55.7821 | 58.9493 |
| BF | 19.9000 | 25.8271 | 34.9480 |
| ABF | 18.9494 | 24.8765 | 33.9974 |
| d8 | 17.4708 | 8.37574 | 2.42841 |
| d17 | 15.0000 | 20.92712 | 30.04804 |

[Lens Group Data]

| | ST | f |
|---|---|---|
| G1 | 3 | −17.41 |
| G2 | 10 | 17.05 |

[Values for Conditional Expression]

(1-1) (−f1)/|fL56| = 0.133
(1-2) SL56/f2 = 0.355
(1-3) SB/S2 = 0.135
(1-4) f2/TLw = 0.285
(1-5) ndLi = 1.903 (L7)
(2-1) (r4R + r4F)/(r4R − r4F) = −0.074
(2-2) |fL78/fL56| = 0.226
(2-3) f2/S2 = 1.297
(2-4) ndLi = 1.904 (L7)
(3-1) f2/fw = 1.503
(3-2) S2/TLt = 0.220
(3-3) SA/r6R = 0.977
(3-4) f2/|fL56| = 0.131
(3-5) ndLi = 1.904 (L7)
(4-1) S2/TLw = 0.220
(4-2) f2/(fw × ft)^{1/2} = 0.980
(4-3) fL1/f1 = 0.819
(4-4) S1/TLw = 0.146
(4-5) ndLi = 1.904 (L7)
(5-1) S1/fw = 0.769
(5-2) (r2F + r1R)/(r2F − r1R) = 0.855
(5-3) fL1/f1 = 0.819
(5-4) (r1R − r1F)/(r1R + r1F) = −0.486
(5-5) ndL1 + 0.009 × νdL1 = 2.213
(6-1) S1/(fw × ft)^{1/2} = 0.501
(6-2) S2/(fw × ft)^{1/2} = 0.755
(6-3) (−f1)/S1 = 1.995
(6-4) fL1/fL2 = 0.310
(6-5) (r2R + r2F)/(r2R − r2F) = −0.531
(6-6) ndL2 = 1.498
(6-7) νdL2 = 82.57

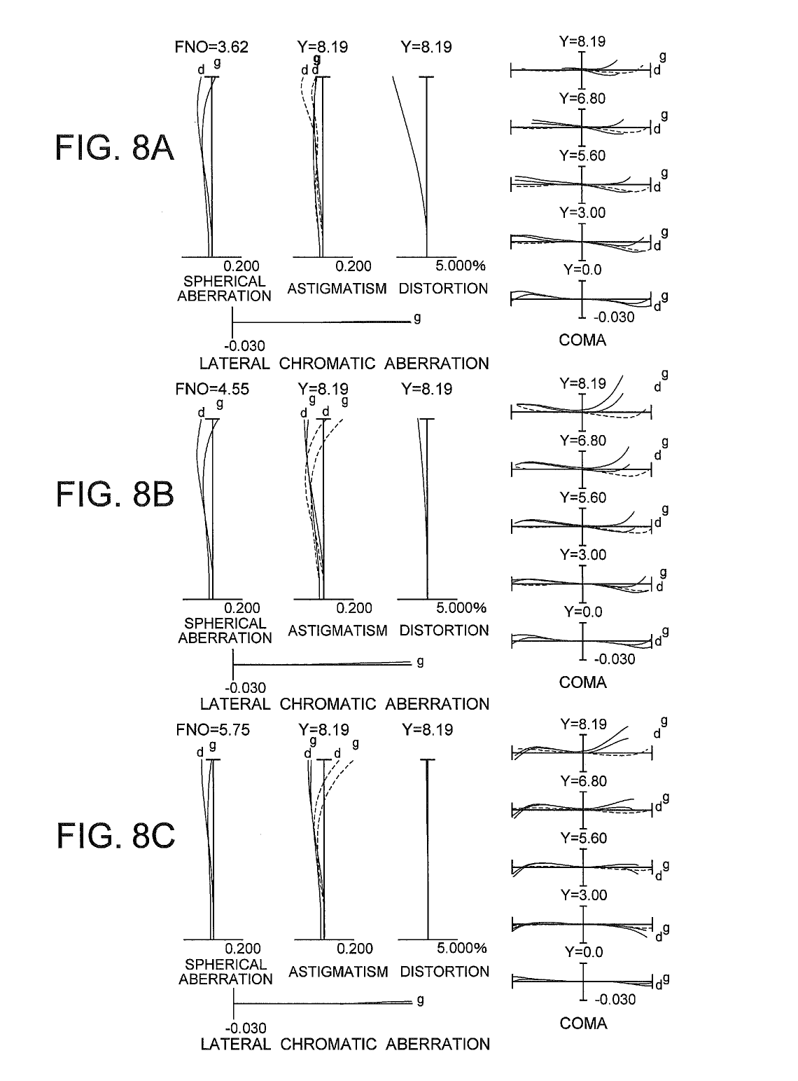

FIGS. 8A, 8B and 8C are graphs showing various aberrations of the zoom lens system according to the fourth Example upon focusing on infinity, in which FIG. 8A is in the wide-angle end state, FIG. 8B is in the intermediate focal length state and FIG. 8C is in the telephoto end state.

As is apparent from various graphs, the zoom lens system according to the present example corrects excellently various aberrations from the wide angle end state to the telephoto end state and has superb optical performance.

### Fifth Example

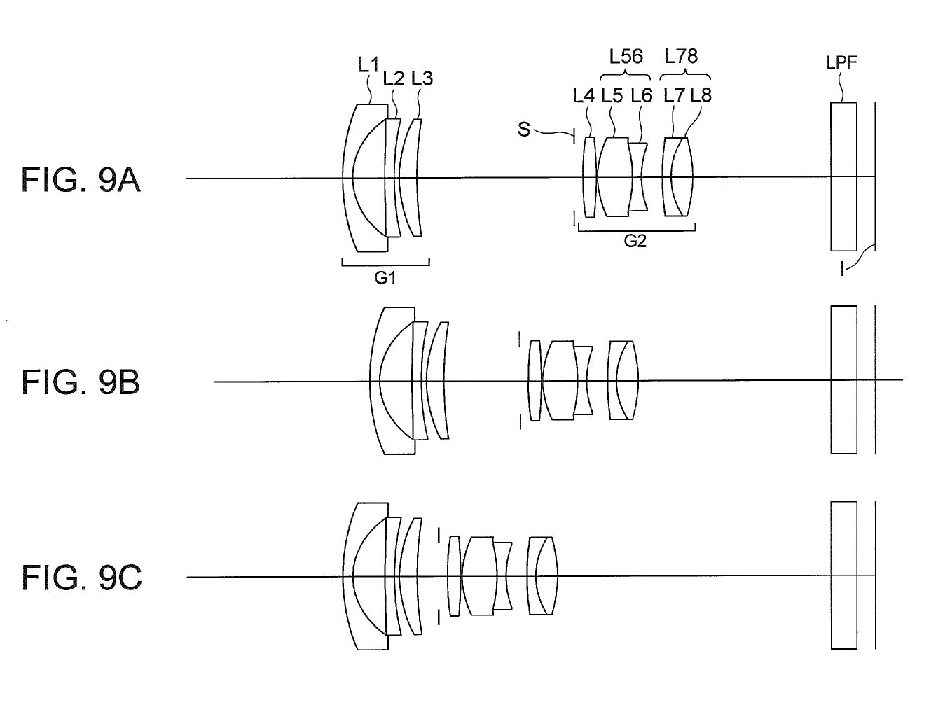

FIGS. 9A, 9B and 9C are sectional views showing a lens configuration of a zoom lens system according to a fifth example in which FIG. 9A shows in a wide-angle end state, FIG. 9B shows in an intermediate focal length state and FIG. 9C shows in a telephoto end state.

A zoom lens system according to the present example is composed of, in order from an object side, a first lens group G1 having negative refractive power and a second lens group G2 having positive refractive power.

The first lens group G1 consists of, in order from the object side, a negative meniscus lens L1 having a convex surface facing an object side, a negative meniscus lens L2 having a convex surface facing an object side, and a positive meniscus lens L3 having a convex surface facing the object side.

The second lens group G2 consists of, in order from the object side, a double convex positive lens L4, a negative cemented lens L56 constructed by a double convex positive lens L5 cemented with a double concave negative lens L6, and a positive cemented lens L78 constructed by a negative meniscus lens L7 having a concave surface facing the image side cemented with a double convex positive lens L8.

In the zoom lens system of the present example, an aperture stop S is disposed between the first lens group G1 and the second lens group G2. Between the second lens group G2 and the image plane I a low-pass filter LPF is disposed.

The zoom lens system according to the present example carries out zooming from the wide angle end state to the telephoto end state by moving the first lens group G1 and the second lens group G2 in the direction of the optical axis such that a distance between the first lens group G1 and the second lens group G2 is varied. At this time, the aperture stop S is moved in the direction of the optical axis together with the second lens group G2, and the position of the low-pass filter LPF in the direction of the optical axis is fixed.

In the zoom lens system according to the present example, the whole first lens group G1 as a focusing lens group is moved in the direction of the optical axis to carry out focusing from an infinitely distant object to a closely distant object.

Various values associated with the zoom lens system according to the present example are listed in Table 5 below.

TABLE 5
Fifth Example
[Surface Data]

| m | r | d | nd | νd |
|---|---|---|---|---|
| OP | ∞ | | | |
| 1 | 21.8349 | 1.10 | 1.85135 | 40.10 |
| *2 | 6.9683 | 3.58 | 1.00000 | |
| 3 | 232.0289 | 1.00 | 1.75700 | 47.73 |
| 4 | 29.0118 | 0.60 | 1.00000 | |
| 5 | 13.9434 | 1.92 | 1.84666 | 23.78 |
| 6 | 38.9245 | d6 | 1.00000 | |
| 7 | ∞ | 1.00 | 1.00000 | Aperture Stop S |
| 8 | 33.9295 | 1.47 | 1.67790 | 55.35 |
| 9 | −31.2393 | 0.10 | 1.00000 | |
| 10 | 8.7609 | 3.86 | 1.59319 | 67.90 |
| 11 | −15.0893 | 1.00 | 1.79952 | 42.09 |
| 12 | 9.7880 | 2.30 | 1.00000 | |
| 13 | 34.5787 | 1.00 | 1.90366 | 31.27 |
| 14 | 8.1693 | 2.33 | 1.61266 | 44.46 |
| 15 | −14.8870 | d15 | 1.00000 | |
| 16 | ∞ | 2.79 | 1.51680 | 63.88 |
| 17 | ∞ | 2.11 | 1.00000 | |
| I | ∞ | | | |

[Aspherical Surface Data]

| m | κ | A4 | A6 | A8 | A10 |
|---|---|---|---|---|---|
| 2 | −0.8415 | 5.64840E−04 | −1.28470E−06 | 3.29740E−08 | 5.58720E−11 |

[Various Data]
Zoom Ratio 2.35

| | W | M | T |
|---|---|---|---|
| f | 11.35 | 17.30 | 26.71 |
| FNO | 3.59 | 4.40 | 5.78 |
| 2ω | 73.0° | 51.0° | 34.1° |
| Y | 8.20 | 8.20 | 8.20 |
| TL | 58.4836 | 55.3260 | 58.4795 |
| ATL | 57.5330 | 54.3754 | 57.5289 |
| BF | 20.1001 | 25.9034 | 35.0772 |
| ABF | 19.1495 | 24.3528 | 34.1266 |
| d6 | 17.1169 | 8.1560 | 2.1357 |
| d15 | 15.2001 | 21.0034 | 30.1772 |

[Lens Group Data]

| | ST | f |
|---|---|---|
| G1 | 1 | −17.41 |
| G2 | 8 | 16.98 |

[Values for Conditional Expression]

(1-1) (−f1)/|fL56| = 0.164
(1-2) SL56/f2 = 0.286
(1-3) SB/S2 = 0.190
(1-4) f2/TLw = 0.290
(1-5) ndLi = 1.904 (L7)
(2-1) (r4R + r4F)/(r4R − r4F) = −0.041
(2-2) |fL78/fL56| = 0.294
(2-3) f2/S2 = 1.407
(2-4) ndLi = 1.904 (L7)
(3-1) f2/fw = 1.496
(3-2) S2/TLt = 0.206
(3-3) SA/r6R = 1.122
(3-4) f2/|fL56| = 0.160
(3-5) ndLi = 1.904 (L7)
(4-1) S2/TLw = 0.206
(4-2) f2/(fw × ft)^{1/2} = 0.975
(4-3) fL1/f1 = 0.715
(4-4) S1/TLw = 0.140
(4-5) ndLi = 1.904 (L7)
(5-1) S1/fw = 0.722
(5-2) (r2F + r1R)/(r2F − r1R) = 1.062
(5-3) fL1/f1 = 0.715
(5-4) (r1R − r1F)/(r1R + r1F) = −0.516
(5-5) ndL1 + 0.009 × νdL1 = 2.213
(6-1) S1/(fw × ft)^{1/2} = 0.471
(6-2) S2/(fw × ft)^{1/2} = 0.693
(6-3) (−f1)/S1 = 2.123
(6-4) fL1/fL2 = 0.284
(6-5) (r2R + r2F)/(r2R − r2F) = −1.286
(6-6) ndL2 = 1.757
(6-7) νdL2 = 47.73

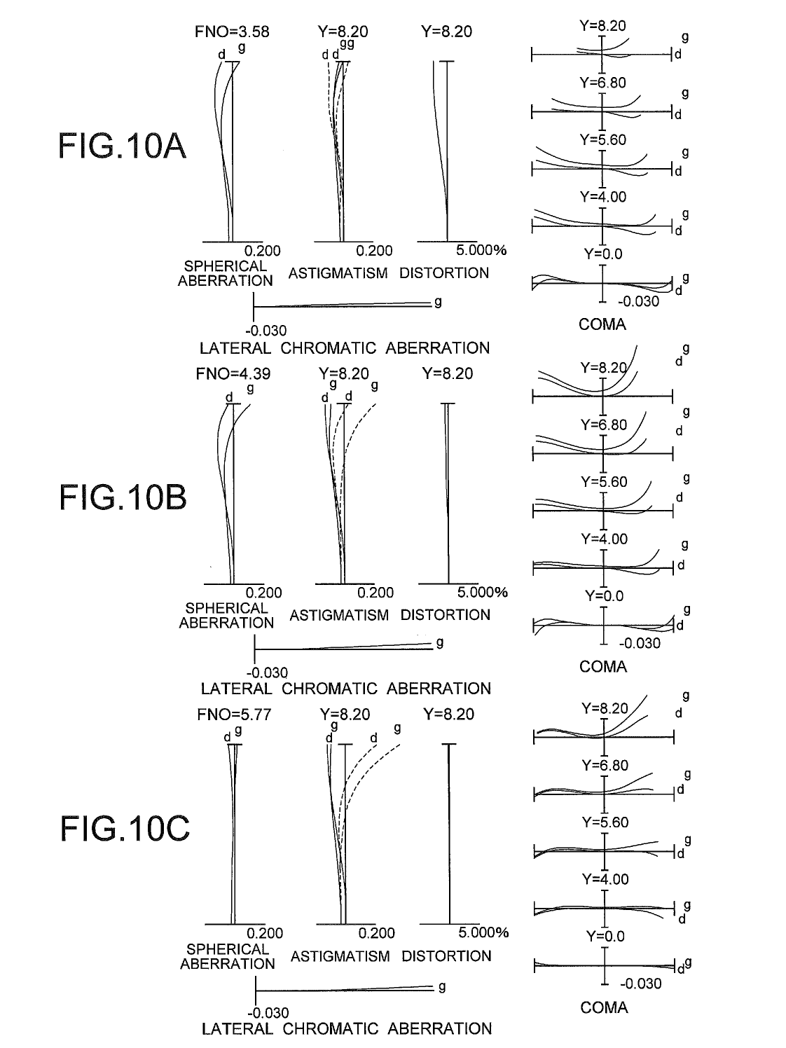

FIGS. 10A, 10B and 10C are graphs showing various aberrations of the zoom lens system according to the fifth Example upon focusing on infinity, in which FIG. 10A is in the wide-angle end state, FIG. 10B is in the intermediate focal length state and FIG. 10C is in the telephoto end state.

As is apparent from various graphs, the zoom lens according to the present example corrects excellently various aberrations from the wide angle end state to the telephoto end state and has superb optical performance.

The above described Examples each only shows a specific example for the purpose of better understanding of the present application. Accordingly, the present application is not limited to the specific details and representative examples. Incidentally, the following description can suitably be applied within limits that do not deteriorate optical performance.

As numerical examples of the zoom lens systems according to the first to the sixth embodiments of the present application, although zoom lens systems having a two-lens-group configuration have been shown, the present application can be applied to other lens configurations such as a three-lens-group configuration, a four-lens-group configuration. Specifically, a lens configuration in which a lens or a lens group is added to the most object side, or the most image side of the zoom lens system according to the first to the sixth embodiments of the present application, is possible. Incidentally, a lens group is defined as a portion including at least one lens separated by air spaces varying upon zooming.

In a zoom lens system according to the first to the sixth embodiments of the present application, in order to vary focusing from infinitely distant object to a close object, a portion of a lens group, a single lens group as a whole, or a plurality of lens groups can be moved along the optical axis as a focusing lens group. It is particularly preferable that at least a portion of the first lens group is moved as the focusing lens group. In this case, the focusing lens group can be used for auto focus, and suitable for being driven by a motor such as an ultrasonic motor.

Moreover, in a zoom lens system according to the first to the sixth embodiments of the present application, a lens group as a whole or a portion of a lens group can be moved as a vibration reduction lens group to include a component in a direction perpendicular to the optical axis, or rotatably moved (swayed) in a plane including the optical axis, thereby correcting an image blur caused by a camera shake. In particular, in a zoom lens system according to the first to the sixth embodiments of the present application, at least a portion of the second lens group is preferably made as the vibration reduction lens group.

In a zoom lens system according to the first to the sixth embodiments of the present application, any lens surface can be a spherical surface, a plane surface, or an aspherical surface. When a lens surface is a spherical surface or a plane surface, lens processing, assembling and adjustment become easy, and deterioration in optical performance caused by lens processing, assembling and adjustment errors can be prevented, so that it is preferable. Moreover, even if the image plane is shifted, deterioration in optical performance is little, so that it is preferable. When a lens surface is an aspherical surface, the aspherical surface can be fabricated by a fine grinding process, a glass molding process that a glass material is formed into an aspherical shape by a mold, or a compound type process that a resin material is formed into an aspherical shape on a glass lens surface. A lens surface can be a diffractive optical surface, and a lens can be a graded-index type lens (GRIN lens) or a plastic lens.

In a zoom lens system according to the first to the sixth embodiments of the present application, it is preferable that an aperture stop is disposed between the first lens group and the second lens group. The function of the aperture stop can be substituted by a lens frame without disposing a member as an aperture stop.

Moreover, the lens surface of the lenses composing according to the first to the sixth embodiments of the present application can be applied with an anti-reflection coating having a high transmittance in a broad wavelength range. With this contrivance, it is feasible to attain the high contrast and the high optical performance by reducing a flare and ghost images.

The zoom lens system according to the fourth example is an example in which a parallel plane glass is disposed at the object side of the most object side lens surface of the first lens group. However, a zoom lens system according to the first to the sixth embodiments of the present application is not limited to such an example, and the zoom lens system according to the first to the sixth embodiments can have a structure in which a parallel plain plate or a lens having substantially no refractive power is disposed at the object side of the first lens group or at the most object side in the first lens group.

With such a configuration, it is possible to protect the most object side lens surface of the first lens group from dust or contamination.

Further, in the zoom lens system according to the first to sixth embodiments, it is preferable that a smallest distance from an image side lens surface of a lens component disposed at the most image side to the image plane (a back focal length) is in the range of 10.0-30.00 mm.

Further, in the zoom lens system according to the first to sixth embodiments, it is preferable that an image height is in the range of 5.0 to 12.5 mm, and it is more preferable that the image height is in the range of 5.0 to 9.5 mm.

As described above, the present application can provide a downsized zoom lens system that can correct various aberrations excellently and has high imaging performance, an optical apparatus equipped with the zoom lens system and a method for manufacturing the zoom lens system.

1. A zoom lens system comprising, in order from an object side, a first lens group having negative refractive power and a second lens group having positive refractive power;
upon zooming from a wide-angle end state to a telephoto end state, a distance between the first lens group and the second lens group varying;
the first lens group has, in order from the object side, a negative meniscus lens having a concave surface facing an image plane side, a negative lens and a positive lens having a convex surface facing the object side;
the second lens group has, in order from the object side, a positive lens, a first cemented lens and a second cemented lens; and
the following conditional expression being satisfied:
0.00≦(−f1)/|fL56|<0.65
where f1 denotes a focal length of the first lens group, and fL56 denotes a focal length of the first cemented lens.

2. The zoom lens system according to claim 1, wherein the first cemented lens has negative refractive power.

3. The zoom lens system according to claim 1, wherein the second cemented lens has positive refractive power.

4. The zoom lens system according to claim 1, wherein the following conditional expression is satisfied:
0.20<SL56/f2<0.40
where SL56 denotes a distance along the optical axis from a most object side lens surface to a most image side lens surface, of the first cemented lens, and f2 denotes a focal length of the second lens group.

5. The zoom lens system according to claim 1, wherein the following conditional expression is satisfied:
0.08<SB/S2<0.40
where SB denotes a distance along the optical axis from a most image side lens surface of the first cemented lens to a most object side lens surface of the second cemented lens, and S2 denotes a distance along the optical axis from a most object side lens surface to a most image side lens surface, of the second lens group.

6. The zoom lens system according to claim 1, wherein the following conditional expression is satisfied:
0.20<f2/TLw<0.35
where f2 denotes a focal length of the second lens group, and TLw denotes a distance along the optical axis from a most object side lens surface to the image plane upon focusing on infinity at the wide-angle end state.

7. The zoom lens system according to claim 1, wherein the second lens group includes at least one negative lens satisfying the following conditional expression:
1.810<ndLi
where ndLi denotes a refractive index of the negative lens at d-line (λ=587.6 nm).

8. The zoom lens system according to claim 1, wherein the first cemented lens consists of, in order from the object side, a positive lens and a negative lens.

9. The zoom lens system according to claim 1, wherein the second cemented lens consists of, in order from the object side, a negative lens and a positive lens.

10. The zoom lens system according to claim 1, wherein the zoom lens system includes an aperture stop, and the aperture stop is disposed at a more image plane side than a most image side lens surface of the first lens group.

11. The zoom lens system according to claim 1, wherein the following conditional expression is satisfied:
−0.30<(r4R+r4F)/(r4R−r4F)<0.50
where r4F denotes a radius of curvature of the object side lens surface of the positive lens of the second lens group and r4R denotes a radius of curvature of the image side lens surface of the positive lens of the second lens group.

12. The zoom lens system according to claim 1, wherein the following conditional expression is satisfied:
0.05<|fL78/fL56|<0.70
where fL78 denotes a focal length of the second cemented lens, and fL56 denotes a focal length of the first cemented lens.

13. The zoom lens system according to claim 1, wherein the following conditional expression is satisfied:
0.30<f2/S2<1.70
where f2 denotes a focal length of the second lens group, and S2 denotes a distance along the optical axis from a most object side lens surface to a most image side lens surface, of the second lens group.

14. The zoom lens system according to claim 1, wherein the following conditional expression is satisfied:
1.40<f2/fw<1.85
where f2 denotes a focal length of the second lens group, and fw denotes a focal length of the zoom lens system at the wide-angle end state.

15. The zoom lens system according to claim 1, wherein the following conditional expression is satisfied:
0.15<S2/TLt<0.35
where S2 denotes a distance along the optical axis from a most object side lens surface to a most image side lens surface, of the second lens group, and TLt denotes a distance along the optical axis from a most object side lens surface to the image plane upon focusing on infinity at the telephoto-end state.

16. The zoom lens system according to claim 1, wherein the following conditional expression is satisfied:
0.00≦f2/|fL56|<0.70
where f2 denotes a focal length of the second lens group, and fL56 denotes a focal length of the first cemented lens.

17. The zoom lens system according to claim 1, wherein the following conditional expression is satisfied:
0.15<S2/TLw<0.28
where S2 denotes a distance along the optical axis from a most object side lens surface to a most image side lens surface, of the second lens group, and TLw denotes a distance along the optical axis from a most object side lens surface to the image plane upon focusing on infinity at the wide-angle end state.

18. The zoom lens system according to claim 1, wherein the following conditional expression is satisfied:
0.85<f2/(fw×ft)^{1/2}<1.10
where f2 denotes a focal length of the second lens group, fw denotes a focal length of the zoom lens system at the wide-angle end state, and ft denotes a focal length of the zoom lens system at the telephoto end state.

19. The zoom lens system according to claim 1, wherein the following conditional expression is satisfied:
0.50<fL1/f1<1.00
where fL1 denotes a focal length of the negative meniscus lens of the first lens group, and f1 denotes a focal length of the first lens group.

20. The zoom lens system according to claim 1, wherein the following conditional expression is satisfied:
0.10<S1/TLw<0.20
where S1 denotes a distance along the optical axis from a most object side lens surface to a most image side lens surface, of the first lens group, and TLw denotes a distance along the optical axis from a most object side lens surface to the image plane upon focusing on infinity at the wide-angle end state.

21. The zoom lens system according to claim 1, wherein the following conditional expression is satisfied:
0.50<S1/fw<0.88
where S1 denotes a distance along the optical axis from a most object side lens surface to a most image side lens surface, of the first lens group, and fw denotes a focal length of the zoom lens system at the wide-angle end state.

22. The zoom lens system according to claim 1, wherein the following conditional expression is satisfied:
0.00<(r2F+r1R)/(r2F−r1R)<2.00
where r1R denotes a radius of curvature of the image side lens surface of the negative meniscus lens of the first lens group, and r2F denotes a radius of curvature of the object side lens surface of the negative lens of the first lens group.

23. The zoom lens system according to claim 1, wherein the following conditional expression is satisfied:
−1.00≦(r1R−r1F)/(r1R+r1F)<−0.30
where r1F denotes a radius of curvature of the object side lens surface of the negative meniscus lens of the first lens group, and r1R denotes a radius of curvature of the image side lens surface of the negative meniscus lens of the first lens group.

24. The zoom lens system according to claim 1, wherein the following conditional expression is satisfied:
0.20<S1/(fw×ft)^{1/2}<0.70
where S1 denotes a distance along the optical axis from a most object side lens surface to a most image side surface, of the first lens group, fw denotes a focal length of the zoom lens system at the wide-angle end state, and ft denotes a focal length of the zoom lens system at the telephoto end state.

25. The zoom lens system according to claim 1, wherein the following conditional expression is satisfied:
0.50<S2/(fw×ft)^{1/2}<1.00
where S2 denotes a distance along the optical axis from a most object side lens surface to a most image side lens surface, of the second lens group, fw denotes a focal length of the zoom lens system at the wide-angle end state, and ft denotes a focal length of the zoom lens system at the telephoto end state.

26. The zoom lens system according to claim 1, wherein the following conditional expression is satisfied:
1.00<(−f1)/S1<3.00
where f1 denotes a focal length of the first lens group, and S1 denotes a distance along the optical axis from a most object side lens surface to a most image side lens surface of the first lens group.

27. The zoom lens system according to claim 1, wherein the following conditional expression is satisfied:
0.20<fL1/fL2<0.50
where fL1 denotes a focal length of the negative meniscus lens of the first lens group, and fL2 denotes a focal length of the negative lens of the first lens group.

28. An optical apparatus equipped with the zoom lens system according to claim 1.

29. A zoom lens system comprising, in order from an object side, a first lens group having negative refractive power and a second lens group having positive refractive power;
upon zooming from a wide-angle end state to a telephoto end state, a distance between the first lens group and the second lens group varying;
the first lens group has, in order from the object side, a negative meniscus lens having a concave surface facing an image plane side, a negative lens and a positive lens having a convex surface facing the object side;
the second lens group has, in order from the object side, a positive lens, a first cemented lens and a second cemented lens; and
the following conditional expression being satisfied:
−0.30<(r4R+r4F)/(r4R−r4F)<0.50
where r4F denotes a radius of curvature of the object side lens surface of the positive lens of the second lens group, and r4R denotes a radius of curvature of the image side lens surface of the positive lens of the second lens group.

30. The zoom lens system according to claim 29, wherein the following conditional expression is satisfied:
0.05<|fL78/fL56|<0.70
where fL78 denotes a focal length of the second cemented lens, and fL56 denotes a focal length of the first cemented lens.

31. The zoom lens system according to claim 29, wherein the following conditional expression is satisfied:
0.30<f2/S2<1.70
where f2 denotes a focal length of the second lens group, and S2 denotes a distance along the optical axis from a most object side lens surface to a most image side lens surface, of the second lens group.

32. The zoom lens system according to claim 29, wherein the zoom lens system includes a fixed stop and the fixed stop is disposed at an image plane side of the first cemented lens.

33. An optical apparatus equipped with the zoom lens system according to claim 29.

34. A zoom lens system comprising, in order from an object side, a first lens group having negative refractive power and a second lens group having positive refractive power;
upon zooming from a wide-angle end state to a telephoto end state, a distance between the first lens group and the second lens group varying;
the first lens group having, in order from the object side, a negative meniscus lens having a concave surface facing an image plane side, a negative lens and a positive lens having a convex surface facing the object side;
the second lens group having, in order from the object side, a positive lens, a first cemented lens and a second cemented lens; and
the following conditional expression being satisfied:
1.40<f2/fw<1.85
where f2 denotes a focal length of the second lens group and fw denotes a focal length of the zoom lens system at the wide-angle end state.

35. The zoom lens system according to claim 34, wherein the following conditional expression is satisfied:
0.15<S2/TLt<0.35
where S2 denotes a distance along the optical axis from a most object side lens surface to a most image side lens surface, of the second lens group, and TLt denotes a distance along the optical axis from a most object side lens surface to the image plane upon focusing on infinity at the telephoto-end state.

36. The zoom lens system according to claim 34, wherein the following conditional expression is satisfied:
0.65<SA/r6R≦1.40
where SA denotes a distance along the optical axis from the aperture stop to a most image side lens surface of the first cemented lens and r6R denotes a radius of curvature of the image side lens surface of the first cemented lens.

37. The zoom lens system according to claim 34, wherein the following conditional expression is satisfied:
0.00≦f2/|fL56|<0.70
where f2 denotes a focal length of the second lens group, and fL56 denotes a focal length of the first cemented lens.

38. An optical apparatus equipped with the zoom lens system according to claim 34.

39. A zoom lens system comprising, in order from an object side, a first lens group having negative refractive power and a second lens group having positive refractive power;
upon zooming from a wide-angle end state to a telephoto end state, a distance between the first lens group and the second lens group varying;
the first lens group having, in order from the object side, a negative meniscus lens having a concave surface facing an image plane side, a negative lens and a positive lens having a convex surface facing the object side;
the second lens group having, in order from the object side, a positive lens, a first cemented lens and a second cemented lens; and
the following conditional expression being satisfied:
0.15<S2/TLw<0.28
where S2 denotes a distance along the optical axis from a most object side lens surface to a most image side lens surface, of the second lens group, and TLw denotes a distance along the optical axis from a most object side lens surface to the image plane upon focusing on infinity at the wide-angle end state.

40. The zoom lens system according to claim 39, wherein the following conditional expression is satisfied:
0.85<f2/(fw×ft)^{1/2}<1.10
where f2 denotes a focal length of the second lens group, fw denotes a focal length of the zoom lens system at the wide-angle end state, and ft denotes a focal length of the zoom lens system at the telephoto end state.

41. The zoom lens system according to claim 39, wherein the following conditional expression is satisfied:
0.50<fL1/f1<1.00
where fL1 denotes a focal length of the negative meniscus lens of the first lens group, and f1 denotes a focal length of the first lens group.

42. The zoom lens system according to claim 39, wherein the following conditional expression is satisfied:
0.10<S1/TLw<0.20
where S1 denotes a distance along the optical axis from a most object side lens surface to a most image side lens surface, of the first lens group, and TLw denotes a distance along the optical axis from a most object side lens surface to the image plane upon focusing on infinity at the wide-angle end state.

43. An optical apparatus equipped with the zoom lens system according to claim 39.

44. A zoom lens system comprising, in order from an object side, a first lens group having negative refractive power and a second lens group having positive refractive power;
upon zooming from a wide-angle end state to a telephoto end state, a distance between the first lens group and the second lens group varying;
the first lens group having, in order from the object side, a negative meniscus lens having a concave surface facing an image plane side, a negative lens and a positive lens having a convex surface facing the object side;
the second lens group having, in order from the object side, a positive lens, a first cemented lens and a second cemented lens; and
the following conditional expressions being satisfied:
0.50<S1/fw<0.88
0.00<(r2F+r1R)/(r2F−r1R)<2.00
where S1 denotes a distance along the optical axis from a most object side lens surface to a most image side lens surface, of the first lens group, fw denotes a focal length of the zoom lens system at the wide-angle end state, r1R denotes a radius of curvature of the image side lens surface of the negative meniscus lens of the first lens group, and r2F denotes a radius of curvature of the object side lens surface of the negative lens of the first lens group.

45. The zoom lens system according to claim 44, wherein the following conditional expression is satisfied:
−1.00≦(r1R−r1F)/(r1R+r1F)<−0.30
where r1F denotes a radius of curvature of the object side lens surface of the negative meniscus lens of the first lens group, and r1R denotes a radius of curvature of the image side lens surface of the negative meniscus lens of the first lens group.

46. The zoom lens system according to claim 44, wherein the following conditional expression is satisfied:
2.05<ndL1+0.009×νdL1
where ndL1 denotes a refractive index of the negative meniscus lens of the first lens group at d-line (λ=587.6 nm) and νdL1 denotes an Abbe number of the negative meniscus lens of the first lens group at d-line (λ=587.6 nm).

47. An optical apparatus equipped with the zoom lens system according to claim 44.

48. A zoom lens system comprising, in order from an object side, a first lens group having negative refractive power and a second lens group having positive refractive power;
upon zooming from a wide-angle end state to a telephoto end state, a distance between the first lens group and the second lens group varying;
the first lens group having, in order from the object side, a negative meniscus lens having a concave surface facing an image plane side, a negative lens and a positive lens having a convex surface facing the object side;
the second lens group having, in order from the object side, a positive lens, a first cemented lens and a second cemented lens; and
the following conditional expressions being satisfied:
0.20<S1/(fw×ft)^{1/2}<0.70
0.50<S2/(fw×ft)^{1/2}<1.00
where S1 denotes a distance along the optical axis from a most object side lens surface to a most image side surface, of the first lens group, S2 denotes a distance along the optical axis from a most object side lens surface to a most image side lens surface, of the second lens group, fw denotes a focal length of the zoom lens system at the wide-angle end state and ft denotes a focal length of the zoom lens system at the telephoto end state.

49. The zoom lens system according to claim 48, wherein the following conditional expression is satisfied:
1.00<(−f1)/S1<3.00
where f1 denotes a focal length of the first lens group and S1 denotes a distance along the optical axis from a most object side lens surface to a most image side lens surface, of the first lens group.

50. The zoom lens system according to claim 48, wherein the following conditional expression is satisfied:
0.20<fL1/fL2<0.50
where fL1 denotes a focal length of the negative meniscus lens of the first lens group, and fL2 denotes a focal length of the negative lens of the first lens group.

51. The zoom lens system according to claim 48, wherein the following conditional expression is satisfied:
−2.00<(r2R+r2F)/(r2R−r2F)≦0.00
where r2F denotes a radius of curvature of the object side lens surface of the negative lens of the first lens group, and r2R denotes a radius of curvature of the image side lens surface of the negative lens of the first lens group.

52. The zoom lens system according to claim 48, wherein the following conditional expressions are satisfied:
ndL2<1.62
62.00<νdL2
where ndL2 denotes a refractive index of the negative lens of the first lens group at d-line (λ=587.6 nm) and νdL2 denotes an Abbe number of the negative lens of the first lens group at d-line (λ=587.6 nm).

53. An optical apparatus equipped with the zoom lens system according to claim 48.

54. A method for manufacturing a zoom lens system including, in order from an object side, a first lens group having negative refractive power and a second lens group having positive refractive power, the method comprising steps of:
constructing such that the first lens group comprises, in order from the object side, a negative meniscus lens having a concave surface facing an image plane side, a negative lens and a positive lens having a convex surface facing the object side;
constructing such that the second lens group comprises, in order from the object side, a positive lens, a first cemented lens and a second cemented lens;
constructing such that the following conditional expression is satisfied;
0.00≦(−f1)/|fL56|<0.65
where f1 denotes a focal length of the first lens group, and fL56 denotes a focal length of the first cemented lens; and
constructing such that a distance between the first lens group and the second lens group varies upon zooming from a wide-angle end state to a telephoto end state.

55. The method for manufacturing a zoom lens system according to claim 54, wherein the following conditional expression is satisfied:
0.20<SL56/f2<0.40
where SL56 denotes a distance along the optical axis from a most object side lens surface to a most image side lens surface, of the first cemented lens, and f2 denotes a focal length of the second lens group.

56. The method for manufacturing a zoom lens system according to claim 54, wherein the following conditional expression is satisfied:
0.08<SB/S2<0.40
where SB denotes a distance along the optical axis from a most image side lens surface of the first cemented lens to a most object side lens surface of the second cemented lens, and S2 denotes a distance along the optical axis from a most object side lens surface to a most image side lens surface, of the second lens group.

57. The method for manufacturing a zoom lens system according to claim 54, wherein the following conditional expression is satisfied:
0.20<f2/TLw<0.35
where f2 denotes a focal length of the second lens group, and TLw denotes a distance along the optical axis from a most object side lens surface to the image plane upon focusing on infinity at the wide-angle end state.

58. The method for manufacturing a zoom lens system according to claim 54, wherein the following conditional expression is satisfied:
−0.30<(r4R+r4F)/(r4R−r4F)<0.50
where r4F denotes a radius of curvature of the object side lens surface of the positive lens of the second lens group, and r4R denotes a radius of curvature of the image side lens surface of the positive lens of the second lens group.

59. The method for manufacturing a zoom lens system according to claim 54, wherein the following conditional expression is satisfied:
1.40<f2/fw<1.85
where f2 denotes a focal length of the second lens group, and fw denotes a focal length of the zoom lens system at the wide-angle end state.

60. The method for manufacturing a zoom lens system according to claim 54, wherein the following conditional expression is satisfied:
0.15<S2/TLw<0.28
where S2 denotes a distance along the optical axis from a most object side lens surface to a most image side lens surface, of the second lens group, and TLw denotes a distance along the optical axis from a most object side lens surface to the image plane upon focusing on infinity at the wide-angle end state.

61. The method for manufacturing a zoom lens system according to claim 54, wherein the following conditional expression is satisfied:
0.50<S1/fw<0.88
where S1 denotes a distance along the optical axis from a most object side lens surface to a most image side lens surface, of the first lens group, and fw denotes a focal length of the zoom lens system at the wide-angle end state.

62. The method for manufacturing a zoom lens system according to claim 54, wherein the following conditional expression is satisfied:
0.00<(r2F+r1R)/(r2F−r1R)<2.00
where r1R denotes a radius of curvature of the image side lens surface of the negative meniscus lens of the first lens group, and r2F denotes a radius of curvature of the object side lens surface of the negative lens of the first lens group.

63. The method for manufacturing a zoom lens system according to claim 54, wherein the following conditional expression is satisfied:
0.20<S1/(fw×ft)^{1/2}<0.70
where S1 denotes a distance along the optical axis from a most object side lens surface to a most image side lens surface, of the first lens group, fw denotes a focal length of the zoom lens system at the wide-angle end state, and ft denotes a focal length of the zoom lens system at the telephoto end state.

64. The method for manufacturing a zoom lens system according to claim 54, wherein the following conditional expression is satisfied:
0.50<S2/(fw×ft)^{1/2}<1.00
where S2 denotes a distance along the optical axis from a most object side lens surface to a most image side lens surface, of the second lens group, fw denotes a focal length of the zoom lens system at the wide-angle end state, and ft denotes a focal length of the zoom lens system at the telephoto end state.

65. A method for manufacturing a zoom lens system including, in order from an object side, a first lens group having negative refractive power and a second lens group having positive refractive power, the method comprising the steps of:
constructing such that the first lens group comprises, in order from the object side, a negative meniscus lens having a concave surface facing an image plane side, a negative lens and a positive lens having a convex surface facing the object side;
constructing such that the second lens group comprises, in order from the object side, a positive lens, a first cemented lens and a second cemented lens;
constructing such that the following conditional expression is satisfied;
−0.30<(r4R+r4F)/(r4R−r4F)<0.50
where r4F denotes a radius of curvature of the object side lens surface of the positive lens of the second lens group, and r4R denotes a radius of curvature of the image side lens surface of the positive lens of the second lens group; and
constructing such that a distance between the first lens group and the second lens group varies upon zooming from a wide-angle end state to a telephoto end state.

66. The method for manufacturing a zoom lens system according to claim 65, wherein the following conditional expression is satisfied:
0.05<|fL78/fL56|<0.70
where fL78 denotes a focal length of the second cemented lens, and fL56 denotes a focal length of the first cemented lens.

67. The method for manufacturing a zoom lens system according to claim 65, wherein the following conditional expression is satisfied:
0.30<f2/S2<1.70
where f2 denotes a focal length of the second lens group, and S2 denotes a distance along the optical axis from a most object side lens surface to a most image side lens surface, of the second lens group.

68. A method for manufacturing a zoom lens system including, in order from an object side, a first lens group having negative refractive power and a second lens group having positive refractive power, the method comprising the steps of:
constructing such that the first lens group comprises, in order from the object side, a negative meniscus lens having a concave surface facing an image plane side, a negative lens and a positive lens having a convex surface facing the object side;
constructing such that the second lens group comprises, in order from the object side, a positive lens, a first cemented lens and a second cemented lens;
constructing such that the following conditional expression is satisfied;
1.40<f2/fw<1.85
where f2 denotes a focal length of the second lens group and fw denotes a focal length of the zoom lens system at a wide-angle end state; and
constructing such that a distance between the first lens group and the second lens group varies upon zooming from the wide-angle end state to a telephoto end state.

69. The method for manufacturing a zoom lens system according to claim 68, wherein the following conditional expression is satisfied:
0.15<S2/TLt<0.35
where S2 denotes a distance along the optical axis from a most object side lens surface to a most image side lens surface, of the second lens group, and TLt denotes a distance along the optical axis from a most object side lens surface to the image plane upon focusing on infinity at the telephoto-end state.

70. The method for manufacturing a zoom lens system according to claim 68, wherein the following conditional expression is satisfied:
0.00≦f2/|fL56|<0.70
where f2 denotes a focal length of the second lens group, and fL56 denotes a focal length of the first cemented lens.

71. A method for manufacturing a zoom lens system including, in order from an object side, a first lens group having negative refractive power and a second lens group having positive refractive power, the method comprising the steps of:
constructing such that the first lens group comprises, in order from the object side, a negative meniscus lens having a concave surface facing an image plane side, a negative lens and a positive lens having a convex surface facing the object side;
constructing such that the second lens group comprises, in order from the object side, a positive lens, a first cemented lens and a second cemented lens;
constructing such that the following conditional expression is satisfied;
0.15<S2/TLw<0.28
where S2 denotes a distance along the optical axis from a most object side lens surface to a most image side lens surface, of the second lens group, and TLw denotes a distance along the optical axis from a most object side lens surface to the image plane upon focusing on infinity at a wide-angle end state; and
constructing such that a distance between the first lens group and the second lens group varies upon zooming from the wide-angle end state to a telephoto end state.

72. The method for manufacturing a zoom lens system according to claim 71, wherein the following conditional expression is satisfied:
0.85<f2/(fw×ft)^{1/2}<1.10
where f2 denotes a focal length of the second lens group, fw denotes a focal length of the zoom lens system at the wide-angle end state, and ft denotes a focal length of the zoom lens system at the telephoto end state.

73. The method for manufacturing a zoom lens system according to claim 71, wherein the following conditional expression is satisfied:
0.50<fL1/f1<1.00
where fL1 denotes a focal length of the negative meniscus lens of the first lens group, and f1 denotes a focal length of the first lens group.

74. A method for manufacturing a zoom lens system including, in order from an object side, a first lens group having negative refractive power and a second lens group having positive refractive power, the method comprising the steps of:
constructing such that the first lens group comprises, in order from the object side, a negative meniscus lens having a concave surface facing an image plane side, a negative lens and a positive lens having a convex surface facing the object side;
constructing such that the second lens group comprises, in order from the object side, a positive lens, a first cemented lens and a second cemented lens;
constructing such that the following conditional expressions;
0.50<S1/fw<0.88
0.00<(r2F+r1R)/(r2F−r1R)<2.00
where S1 denotes a distance along the optical axis from a most object side lens surface to a most image side lens surface, of the first lens group, fw denotes a focal length of the zoom lens system at a wide-angle end state, r1R denotes a radius of curvature of the image side lens surface of the negative meniscus lens of the first lens group and r2F denotes a radius of curvature of the object side lens surface of the negative lens of the first lens group; and
constructing such that a distance between the first lens group and the second lens group varies upon zooming from the wide-angle end state to a telephoto end state.

75. The method for manufacturing a zoom lens system according to claim 74, wherein the following conditional expression is satisfied:
−1.00≦(r1R−r1F)/(r1R+r1F)<−0.30
where r1F denotes a radius of curvature of the object side lens surface of the negative meniscus lens of the first lens group, and r1R denotes a radius of curvature of the image side lens surface of the negative meniscus lens of the first lens group.

76. A method for manufacturing a zoom lens system including, in order from an object side, a first lens group having negative refractive power and a second lens group having positive refractive power, the method comprising the steps of:
constructing such that the first lens group comprises, in order from the object side, a negative meniscus lens having a concave surface facing an image plane side, a negative lens and a positive lens having a convex surface facing the object side;
constructing such that the second lens group comprises, in order from the object side, a positive lens, a first cemented lens and a second cemented lens;
constructing such that the zoom lens system satisfies the following conditional expressions;
0.20<S1/(fw×ft)^{1/2}<0.70
0.50<S2/(fw×ft)^{1/2}<1.00
where S1 denotes a distance along the optical axis from a most object side lens surface to a most image side surface, of the first lens group, S2 denotes a distance along the optical axis from a most object side lens surface to a most image side lens surface, of the second lens group, fw denotes a focal length of the zoom lens system at a wide-angle end state, and ft denotes a focal length of the zoom lens system at a telephoto end state; and
constructing such that a distance between the first lens group and the second lens group varies upon zooming from the wide-angle end state to the telephoto end state.

77. The method for manufacturing a zoom lens system according to claim 76, wherein the following conditional expression is satisfied:
1.00<(−f1)/S1<3.00
where f1 denotes a focal length of the first lens group, and S1 denotes a distance along the optical axis from a most object side lens surface to a most image side lens surface, of the first lens group.

78. The method for manufacturing a zoom lens system according to claim 76, wherein the following conditional expression is satisfied:
0.20<fL1/fL2<0.50
where fL1 denotes a focal length of the negative meniscus lens of the first lens group, and fL2 denotes a focal length of the negative lens of the first lens group.
